(19) United States
(12) Patent Application Publication
(10) Pub. No.: US 2025/0178032 A1
(43) Pub. Date: Jun. 5, 2025

(54) CROSS-BELT SORTER SYSTEM

(71) Applicant: Lewco, Inc., Sandusky, OH (US)

(72) Inventors: Gerald T. Guerra, Sandusky, OH (US); Art Jensen, West Palm Beach, FL (US); Ryan Kenny, Richmond, VA (US)

(21) Appl. No.: 18/941,564

(22) Filed: Nov. 8, 2024

Related U.S. Application Data
(60) Provisional application No. 63/597,965, filed on Nov. 10, 2023.

(51) Int. Cl. B07C 3/08; B07C 3/12; B65G 41/00

(52) U.S. Cl. CPC B07C 3/082; B07C 3/12; B65G 41/001; B65G 2201/0235

(57) ABSTRACT

A sorter system is configured to sort objects disposed on a conveying surface to multiple locations. The system includes a frame, a plurality of carriages each having a motor, a belt, and a plurality of pulleys. The sorter system includes a power line extending through the frame and power pickups on one or more carriages to receive power from the power line and provide power to actuate the belts of two or more carriages. The sorter system also includes a control line extending through the frame and one or more master carriages configured to receive control signals from a sorter controller system to control actuation of the belts of two or more carriages. The carriages may include a belt drive system configured to reduce the widths of the carriages. The belt drive systems may drive the belts on-center to reduce the torque and energy required to actuate the belt.

### RELATED APPLICATION

This application claims priority to U.S. Provisional Patent Application No. 63/597,965, filed on Nov. 10, 2023, and entitled “CROSS-BELT SORTER SYSTEM,” the entirety of which is incorporated herein by reference.

### TECHNICAL FIELD

The present application relates generally to conveyor systems and, more particularly, to cross-belt conveyor systems having belts that are independently moveable in two directions perpendicular to a conveying surface.

### BACKGROUND OF THE INVENTION

Conveyor systems have been used in a variety of locations, such as warehouses and distribution centers, to more efficiently move or convey objects or packages, such as to prepare the objects or packages for sorting or shipment. The conveyor systems may have a conveying surface which directs the packages toward a destination, such as via belts, rollers, or gravity.

Sorter systems may be included in conveyor systems to direct packages into one of a plurality of locations or groups based upon an identity of the package, such as based upon the shipping destination of the package. Sorter systems include a conveying surface that is belt-, roller-, or gravity-fed to convey the packages along the conveying surface, one or more chutes extending from one or more sides of the conveying surface, and one or more mechanisms to divert the packages into the one or more chutes. The sorting systems may be implemented at the end of the conveyor system with multiple chutes extending from the conveying surface to sort the conveyed packages, such as by shipping location. However, the sorting systems may also be used as the start or in the middle of conveyor systems, such as to divert packages between two or more conveyor paths.

Conventionally, the sorter systems implement either a shoe sorter or a cross-belt (or over-under) sorter to move the packages conveyed along the conveying surface into a desired chute, such that the packages may be sorted and grouped together. Conventionally, the chutes are gravity fed, have a width between about 24 inches and about 76 inches, and may include a bin or container at the end of the chute for receiving the packages. The chutes may lead to sorting areas based upon a number of features, such as the package destination, such as by destination zip code.

Shoe sorters include one or more actuation elements, such as rods, sticks, or pucks, disposed at a height above the conveying surface which may be moved or actuated across the conveying surface to hit or otherwise move packages into one of the chutes. Generally, shoe sorters include chutes along only one side of the conveyor system, such as because with the conveying surface of the shoe sorter being a continuous horizontal loop that may continuously convey packages until directed into a chute by an actuation element. The actuation elements are disposed on the side of the conveying surface opposite the chutes and are laterally actuated toward the chutes when the packages pass the destination chute or receptacle, thereby moving the package to the destination chute or receptacle. The actuation elements may be fixed on the frame of the sorter and laterally or pivotably actuated across the conveying surface or the actuation elements may be disposed on the conveying surface and conveyed along the surface and moved across the conveying surface at the destination chute or receptacle. When the actuation elements are disposed on the conveying surface they are actuatable in only one direction while conveyed on the top of conveying surface and must be reset by a mechanism to move the actuation element back to the starting position. Due to the configuration of the sorter, chutes can be disposed only on one side of the conveying surface and packages cannot be placed on the conveying surface past the beginning of the sorter, thereby reducing the total number of chutes and the efficiency, versatility, and throughput of the system.

Other shoe sorters include chutes on both sides of the conveying surface and the actuation elements are disposed along the center of the conveying surface. Packages may be placed on either side of the actuation elements and the actuation elements may be actuated to either side of the conveying surface to move the package to the destination chute or receptacle. However, the actuation elements may only move packages into chutes on the same side of the actuation element as the chute so the packages must be pre-sorted onto the conveying surface on either side of the actuation elements, thereby reducing the efficiency and throughput of the system. Additionally, after actuation, the actuation elements must also be reset by a mechanism past the end of the conveyor to move the actuation elements back to the center of the conveying surface. Further, two-directional shoe sorters require larger widths to convey the package (e.g., requiring suitable space on both sides of the actuation elements), thereby increasing the footprint of the sorter system.

Further, the actuation elements of the shoe sorters generally extend a short distance above the conveying surface. Therefore, the actuation elements may have not effectively move smaller, lighter, or less dense and/or amorphous packages as the actuation elements may simply slide underneath the package. For example, the actuation elements may slide under a light, bag-type package on the conveying surface.

Cross-belt or over-under belt sorters include a plurality of carriages or carts formed into a loop which rotate along the conveying surface of the sorter. The carriages include a belt looped around the carriage and oriented orthogonally to the conveying direction of the conveying surface. Packages are placed across one or more carriages and, when the package passes the destination chute or receptacle, the belt of the carriage(s) are actuated in either direction toward the destination chute or receptacle. Conventionally, it is difficult, complicated, and expensive to supply power to the carts because they are moving along the sorter, such as including an inductive magnet system or power take-ups on the side of the carriage. Additionally, the carriages may be prone to mechanical failures due to the power source, complexity, and number of parts, and are difficult to repair due to their connection to the sorter. Further, the belts generally extend a length along the conveying surface corresponding to the widths of the chutes and move all packages placed thereon when actuated, so packages must be spaced apart along the length of the conveying surface, thereby reducing the efficiency and throughput of the system. Moreover, due to the configuration of electrical connections to each carriage required to actuate each belt, the carriages of conventional cross-belt sorters may be actuated only once per cycle and must be reset before actuating the belt again.

Accordingly, there is need for cross-belt sorter systems which permit packages to be conveyed along the conveyor system and properly moved to chutes or receptacles along the conveyor system without complicated power systems that are prone to failures and which permit packages to be placed on the conveying surface more efficiently.

### BRIEF DESCRIPTION OF THE DRAWINGS

To further clarify various aspects of embodiments of the present disclosure, a more particular description of the certain embodiments will be made by reference to various aspects of the appended drawings. It is appreciated that these drawings depict only typical embodiments of the present disclosure and are therefore not to be considered limiting of the scope of the disclosure. Moreover, while the figures can be drawn to scale for some embodiments, the figures are not necessarily drawn to scale for all embodiments. Embodiments and other features and advantages of the present disclosure will be described and explained with additional specificity and detail through the use of the accompanying drawings in which:

FIG. 1 illustrates a top perspective view of a sorter system according to one example;

FIG. 2 illustrates a top perspective view of the sorter system of FIG. 1 with a plurality of chutes;

FIG. 3 illustrates a top perspective view of a sorter system according to another example;

FIG. 4 illustrates a side view of the sorter system of FIG. 3;

FIG. 5 illustrates a top view of the sorter system of FIG. 3;

FIGS. 6A-6B illustrate top views of the sorter system of FIG. 3 with some carriages removed to illustrate inner portions of the sorter system;

FIGS. 7-8 illustrate to perspective views of the sorter system of FIG. 3 with some carriages removed to illustrate inner portions of the sorter system;

FIG. 9A illustrates a perspective view of an upstream end of the sorter system of FIG. 3;

FIG. 9B illustrates a perspective view of the upstream end of FIG. 9A with the carriages removed;

FIG. 10 illustrates a perspective view of a downstream end of the sorter system of FIG. 3;

FIGS. 11A-11E illustrate various views of a carriage for use with the sorter system of FIG. 3 according to one embodiment;

FIG. 12A illustrates a perspective view of a carriage frame for use with the carriage of FIGS. 11A-11D according to one embodiment;

FIG. 12B illustrates a front view of the carriage frame of FIG. 12A;

FIGS. 13A-13C illustrate various views of adjacent carriages according to one embodiment;

FIG. 14A illustrates a perspective view of a belt for use with the carriage of FIGS. 11A-11D;

FIG. 14B illustrates a cross-sectional view of the belt of FIG. 14A;

FIG. 15 illustrates a side view a belt drive system for use with the carriage of FIGS. 11A-11D;

FIG. 16 illustrates an opposite side view of the belt drive system of FIG. 15 with the drive controller removed;

FIG. 17 illustrates a perspective view of the belt drive system of FIG. 15;

FIG. 18 illustrates a perspective view of the belt drive system of FIG. 15 with the belt and the drive controller removed;

FIG. 19A illustrates a perspective view of a belt drive motor and a belt drive shaft for use with the belt drive system of FIG. 15;

FIG. 19B illustrates a side view of the belt drive motor and the belt drive shaft of FIG. 19A;

FIG. 19C illustrates an exploded perspective view of the belt drive motor and the belt drive shaft of FIG. 19A;

FIG. 20A illustrates a perspective view of a saddle for use with the carriage frame FIG. 12A;

FIG. 20B-20D illustrate various perspective views of the saddle of FIG. 20A coupled with the carriage frame of FIG. 12A;

FIGS. 21A-21B illustrates various views of the belt drive motor and the belt drive shaft of FIG. 19A disposed in the saddle of FIG. 20A;

FIG. 22A illustrates a bottom perspective view of the carriage frame of FIG. 12A coupled with the saddle of FIG. 20A;

FIG. 22B illustrates a bottom perspective view of the carriage frame and saddle of FIG. 20A coupled with the belt drive motor and the belt drive shaft of FIG. 19A;

FIG. 23 illustrates a perspective view of the belt drive motor and the belt drive shaft of FIG. 19A coupled with a drive connector;

FIGS. 24A-24C illustrate various views of a drive pulley for use with the belt drive system of FIG. 15;

FIGS. 25A-25C illustrate various views of the drive pulley of FIGS. 24A-24C coupled with the belt drive motor and the belt drive shaft of FIG. 19A;

FIG. 25D illustrates the drive pulley, the belt drive motor, and the belt drive shaft of FIGS. 25A-25C disposes within the belt of FIG. 14A;

FIGS. 26A-26B illustrate various views of a tensioning pulley for use with the belt drive system of FIG. 15;

FIGS. 27A-27B illustrate various views of a pulley shaft and drive bearings for use with the drive pulley of FIGS. 24A-24C according to one embodiment, the pulley shaft and drive bearings may also be used with the tensioning pulley of FIGS. 26A-26B;

FIG. 28 illustrates a perspective view of a carriage for use with the sorter system of FIG. 3 according to one embodiment;

FIGS. 29A-29B illustrate bottom views of three carriages for use with the sorter system of FIG. 3 according to one embodiment;

FIGS. 30A-30D illustrate various views of a carriage for use with the sorter system of FIG. 3 according to one embodiment;

FIG. 31 illustrates a power pickup for use with the carriage of FIGS. 30A-30D;

FIGS. 32A-32D illustrate various views of a carriage for use with the sorter system of FIG. 3 according to one embodiment;

FIGS. 33A-33D illustrate various views of a carriage for use with the sorter system of FIG. 3 according to one embodiment;

FIG. 34 illustrates a block diagram of a sorter system controller of FIG. 1 coupled with carriage drive controllers via a carriage drive controller of FIGS. 33A-33D;

FIGS. 35A-35B illustrate various views of a carriage for use with the sorter system of FIG. 3 according to one embodiment;

FIG. 36 illustrates a perspective view of the sorter of FIG. 3 coupled with an input conveyor, variable speed belts, and a vision detection system;

FIG. 37 illustrates a block diagram of a sorter system controller of FIG. 1 coupled with the vision detection system and the variable speed belts of FIG. 36 and the carriage controller systems of FIG. 33A-33D;

FIGS. 38A-38C illustrate various views of the sorter system of FIG. 36 without the input conveyor;

FIG. 39A illustrates a perspective view of the variable speed belts of FIG. 36;

FIG. 39B illustrates a perspective view of the variable speed belt and the vision detection system of FIG. 36; and

FIG. 40 illustrates a flow diagram of a method for generating controlling a position, location, and orientation of a package in a sorter system.

### DETAILED DESCRIPTION

The following description refers to the accompanying drawings, which illustrate specific embodiments of the present disclosure. Other embodiments having different structures and operation do not depart from the scope of the present disclosure.

The follow includes definitions of exemplary terms that may be used throughout the disclosure. Both singular and plural forms of all terms fall within each meaning.

“Computer” or “processor,” as used herein includes, but is not limited to, one or more programmed or programmable electronic device or coordinated devices that can store, retrieve, and process data and may be any processing unit, distributed processing configuration, or processor systems. Examples of processor include microprocessors, microcontrollers, central processing units (CPUs), graphics processing units (GPUs), tensor processing unit (TPU), floating point units (FPUs), reduced instruction set computing (RISC) processors, digital signal processors (DSPs), field programmable gate arrays (FPGAs), etc., in any combination. One or more cores of a single microprocessor and/or multiple microprocessor each having one or more cores can be used to perform the operation as being executed by a processor herein. The processor can also be a processor dedicated to the training of neural networks and other artificial intelligence (AI) systems. The processor may be associated with various other circuits that support operation in the processor, such as random access memory (RAM), read-only memory (ROM), programmable read-only memory (PROM), erasable programmable read-only memory (EPROM), clocks, decoders, memory controllers, or interrupt controllers, etc. These support circuits may be internal or external to the processor or its associated electronic packaging. The support circuits are in operative communication with the processor. The support circuits are not necessarily shown separate from the processor in block diagrams or drawings.

“Network interface” or “data interface,” as used herein includes, but is not limited to, any interface or protocol for transmitting and receiving data between electronic devices. The network or data interface can refer to a connection to a computer via a local network or through the internet and can also refer to a connection to a portable device—e.g., a mobile device or a USB thumb drive—via a wired or wireless connection. A network interface can be used to form networks of computers to facilitate distributed and/or remote computing (i.e., cloud-based computing). “Cloud-based computing” means computing that is implemented on a network of computing devices that are remotely connected to the device via a network interface.

“Signal,” as used herein includes, but is not limited to, one or more electric signals, including analog or digital signals, one or more computer instructions, a bit or bit stream, or the like.

“Logic,” synonymous with “circuit” as used herein, includes but is not limited to hardware, firmware, software and/or combinations of each to perform a function(s) or action(s). For example, based on a desired application or needs, logic may include a software-controlled microprocessor, discrete logic such as an application specific integrated circuit (ASIC), or other programmed logic device and/or controller. Logic may also be fully embodied as software.

“Software,” as used herein includes, but is not limited to, one or more computer readable and/or executable instructions that cause a computer, processor, logic, and/or other electronic device to perform functions, actions, and/or behave in a desired manner. The instruments may be embodied in various forms such as routines, algorithms, modules, or programs including separate applications or code from dynamically linked sources or libraries (DLLs). Software may also be implemented in various forms such as a stand-alone program, a web-based program, a function call, a subroutine, a servlet, an application, an app, an applet (e.g., a Java applet), a plug-in, instructions stored in a memory, part of an operating system, or other type of executable instructions or interpreted instructions from which executable instructions are created.

“Module” or “engine” as used herein will be appreciated as comprising various configurations of computer hardware and/or software implemented to perform operations. In some embodiments, modules or engines as described herein may be represented as instructions operable to be executed by a processor in a processor or memory. In other embodiments, modules or engines as described herein may be represented as instructions read or executed from readable media. A module or engine may operate in either hardware or software according to application specific parameters or user settings. It will be appreciated by those of skill in the art that such configurations of hardware and software may vary, but remain operable in substantially similar ways.

“Data storage device,” as used herein includes, but is not limited to, a device or devices for non-transitory storage of code or data, e.g., a device with a non-transitory computer readable medium. As used herein, “non-transitory computer readable medium” mean any suitable non-transitory computer readable medium for storing code or data, such as a magnetic medium, e.g., fixed disks in external hard drives, fixed disks in internal hard drives, and flexible disks; an optical medium, e.g., CD disk, DVD disk; and other media, e.g., ROM, PROM, EPROM, EEPROM, flash PROM, external memory drives, etc.

While the above exemplary definitions have been provided, it is Applicant's intention that the broadest reasonable interpretation consistent with this specification be used for these and other terms. Aspects and implementations of the present disclosure will be understood more fully from the detailed description given below and from the accompanying drawings of the various aspects and implementations of the disclosure. This should not be taken to limit the disclosure to the specific aspects or implementations, but explanation and understanding only.

Described herein are various technologies pertaining to a sorter system that includes a plurality of carriages with belts. The sorter system may also include a sorter power system and a belt controller system. The carriages include a belt drive system configured to decrease the width of the carriage. The belt drive system may actuate the belt of the carriage in either a first direction or a second direction and the belt drive system may receive a control command or signal to control the actuation direction, such as actuating the belt in a first direction when a first signal is received and actuating the belt in a second direction when a second signal is received. The carriages may be configured to reduce the width of the carriage, such as to increase the number of carriages defining the conveying surface, to increase control of packages disposed on the conveying surface, to decrease the height of the conveyor, and/or to convey smaller packages via the sorter. The carriages may also be configured to maintain control of the belts, decrease friction of the belt on a frame of the carriage, and/or to reduce an amount of energy required to rotate the belts around the frame. The sorter system may include a power line and power pick ups on one or more carriages to provide power to carriages as the carriages rotate around tracks of the sorter system. The sorter system may also include a control line and a carriage controller system on or more carriages to control the actuation of belts on one or more carriages as the carriages rotate around tracks of the sorter system.

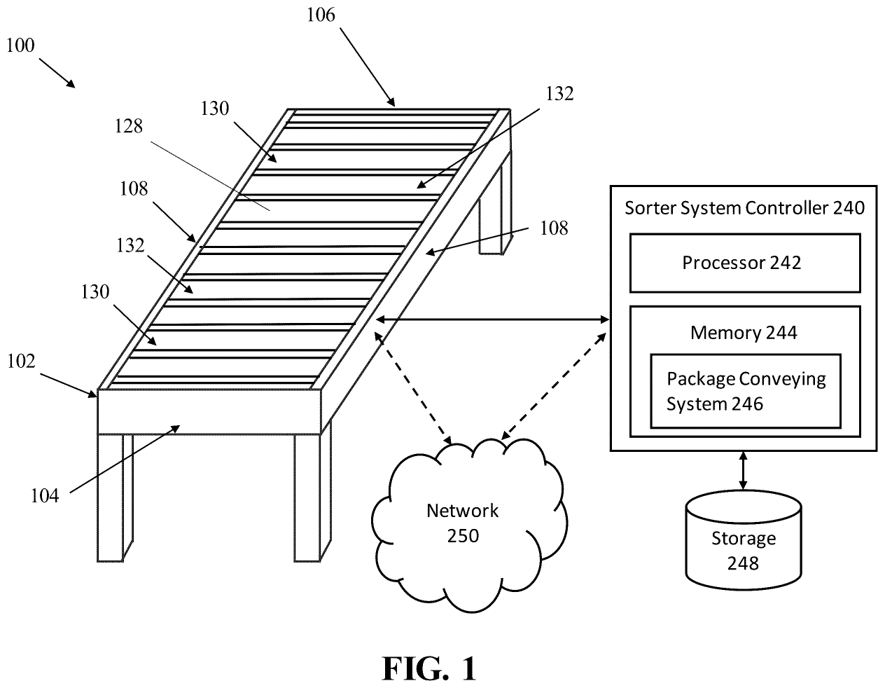

Referring to FIG. 1, a package conveyor or sorter system 100 is depicted according to one embodiment. The sorter system 100 includes a frame 102 extending from a proximal or upstream end 104 to a distal or downstream end 106 opposite the upstream end 104, frame sides 108 extending on each side of the frame 102 between the upstream end 104 and the downstream end 106, and a plurality of carts or carriages 130 disposed between the frame sides 108 along a length of the sorter system 100 substantially extending from the upstream end 104 to the downstream end 106.

In some embodiments, the frame 102 may include legs disposed on an underside of the frame 102 and wheels disposed at the end of the legs such that the sorter system 100 may be moved or otherwise positioned, such as on a floor. In the illustrated embodiment, the sorter system 100 is linear. However, the sorter system 100 may have other suitable shapes or configurations. For example, the sorter system 100 may be rounded, curved, serpentine, circular, etc.

The carriages 130 may be disposed on the frame 102 of the sorter system 100 such that the carriages 130 may travel along a top of the frame 102 from the upstream end 104 to the downstream end 106 and then loop back underneath from the downstream end 106 to the upstream end 104. The carriages 130 may also be disposed on the frame 102 such that the carriages 130 may travel in a looped configuration from the upstream end 104 to the downstream end 106 along the top of the frame 102 and back to the upstream end 104 below the carriages 130 disposed at the top of the frame 102. The carriages 130 may be affixed to a track of the frame 102 in the looped configuration such that the carriages 130 may move from the upstream end 104 to the downstream end 106 at a first height substantially equivalent to the top surface of the frame 102, move or rotate downwardly from the first height to a second height lower than the first height near the downstream end 106, move from the downstream end 106 to the upstream end 104 at the second height, and move or rotate upwardly from the second height to the first height near the upstream end 104. The top surfaces of the carriages 130 at the first height may define a conveying surface 128 for moving packages along the sorter system 100 in a direction extending from the upstream end 104 to the downstream end 106. The carriages 130 may move in the looped configuration such that one or more packages may be conveyed along the conveying surface 128 from the upstream end 104 toward the downstream end 106. The carriages 130 may also be configured to convey packages laterally to direct packages laterally over one or more sides of the frame 102 at one or more positions along a length of the conveying surface 128, such as to the chutes disposed to the left and/or right of the conveying surface 128. It will be understood that the term “packages” is not limited to boxes containing items, but also encompasses any items or articles which may be conveyed along a conveyor, including bags, products, components, and the like.

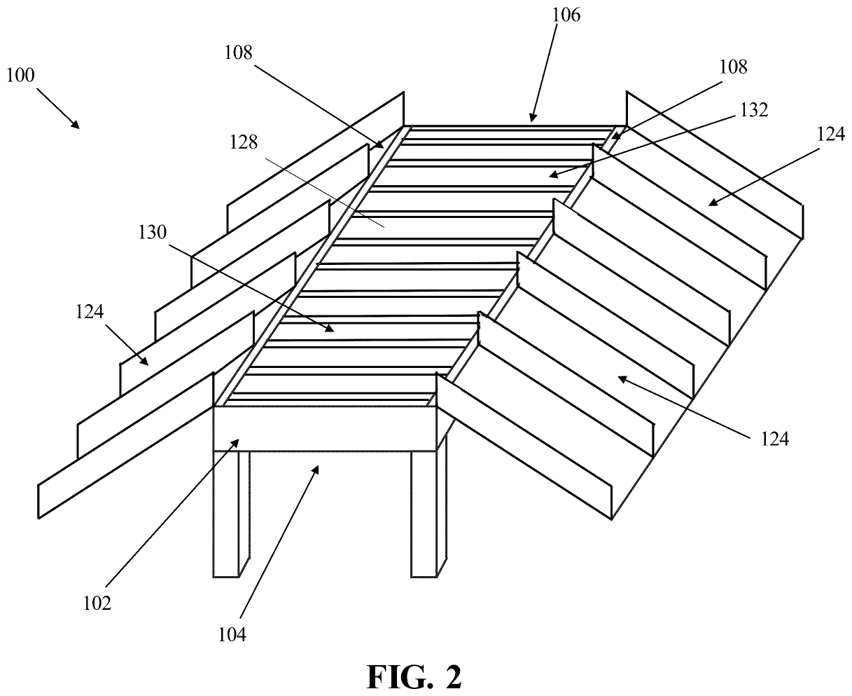

As shown in FIG. 2, the sorter system 100 may include or be coupled with a plurality of chutes 124 extending from one or more sides of the conveying surface 128. The chutes 124 may be disposed along at least portion of the sorter system 100 at positions extending from the upstream end 104 of the sorter system 100 to the downstream end 106. The chutes 124 may be configured to receive packages conveyed laterally from the conveying surface 128 of the sorter system 100, such as via actuation of one or more carriages 130. In some embodiments, the chutes 124 direct packages to separate receiving locations. For example, the chutes 124 may be angled with a bin or receptacle at the end of the chute 124 such that packages may be moved down or along the chute 124, such as due to gravity, and be received or collected in the receptacle. In other embodiments, the chutes 124 may direct packages to subsequent conveyors, such as to convey packages to different locations. Each chute 124 may correspond to a particular characteristic of the package such that packages may be grouped and/or sorted by the package characteristics. For example, each chute 124 may correspond to a particular shipping location, such as a zip code. While not shown, the sorter system 100 may also include one or more chutes 124 extending from the downstream end 106 of the sorter system 100. In some embodiments, one or more of the upstream and downstream edges of the chutes 124 may be rounded or otherwise raised, such as to funnel or otherwise direct packages into the chutes 124.

In other embodiments, the sorter system 100 may be used without chutes and be used directly with a plurality of receptacles, such as containers, bins, or hampers, or other conveyors disposed or otherwise placed directly against one or both sides of the sorter system 100. The receptacles or chutes may be disposed to receive packages which are moved off the conveying surface 128, such as by actuation of one or more carriages 130. In some embodiments, the receptacles may be configured to be actuated to move up and down relative to the conveying surface 128 to better receive packages from the conveying surface 128.

In some embodiments, the sorter system 100 includes a sorter system controller 240 (FIG. 1) configured to control one or more operations of the sorter system 100, such as the actuation of one or more carriages 130. The sorter system controller 240 is in data communication with the carriages 130 of the sorter system 100. The sorter system controller 240 may be configured to generate one or more command outputs which cause the carriages 130 of the sorter system 100 to execute one or more movement operations, as detailed below. For example, the sorter system controller 240 may be configured to generate one or more command outputs to actuate one or more carriages 130 to convey or otherwise move packages to the chutes 124.

In some embodiments, the sorter system controller 240 is directly in data communication with the carriages 130, such as via a control line. Additionally or alternatively, the sorter system controller 240 may be in data communication with the carriages 130 via one or more networks 250. The networks 250 may be any suitable network capable of providing data communication between the sorter system controller 240 and the carriages 130, such as a Bluetooth, Internet, intranet, cellular, infrared, WiFi, radio, ultraband, ZigBee, or other network.

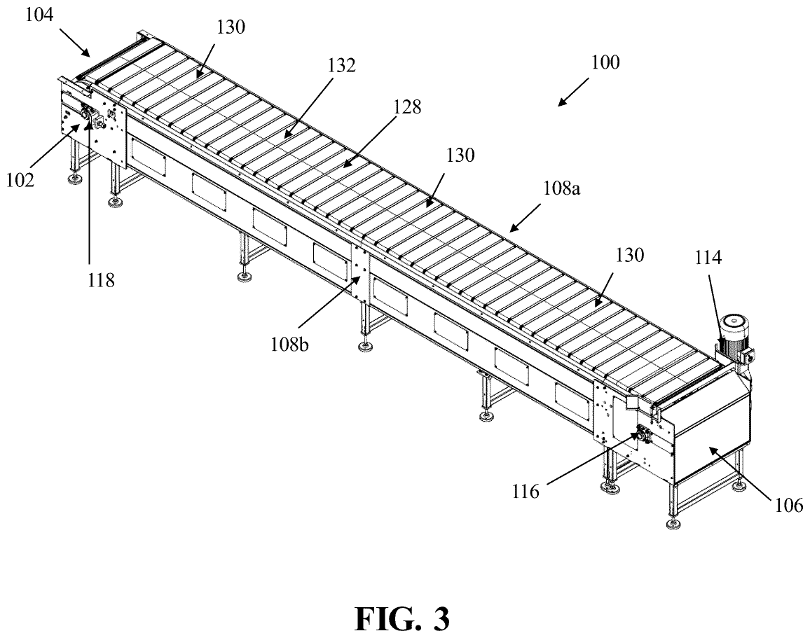

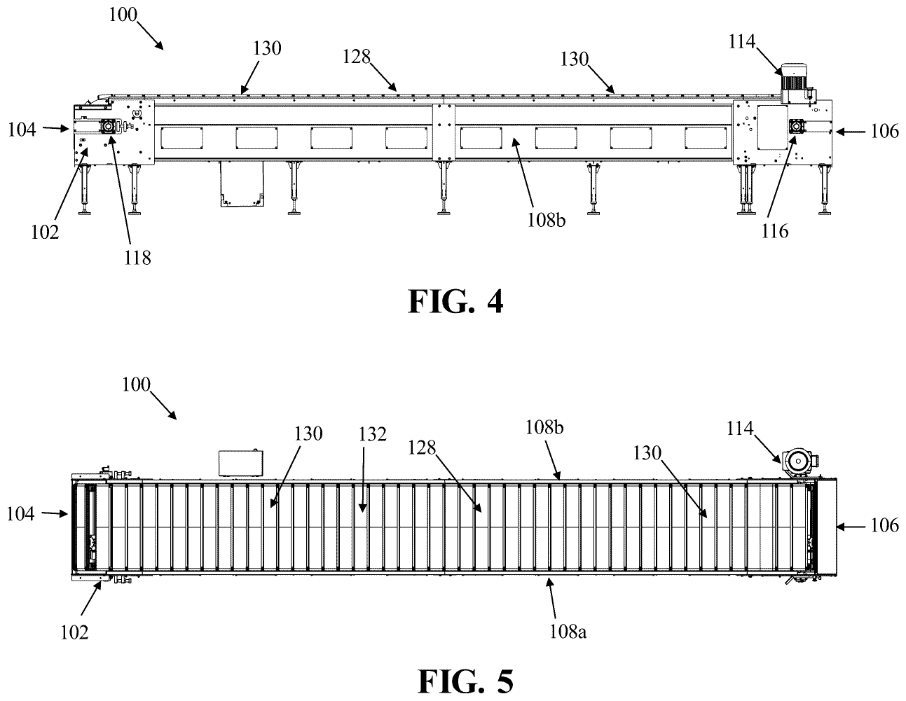

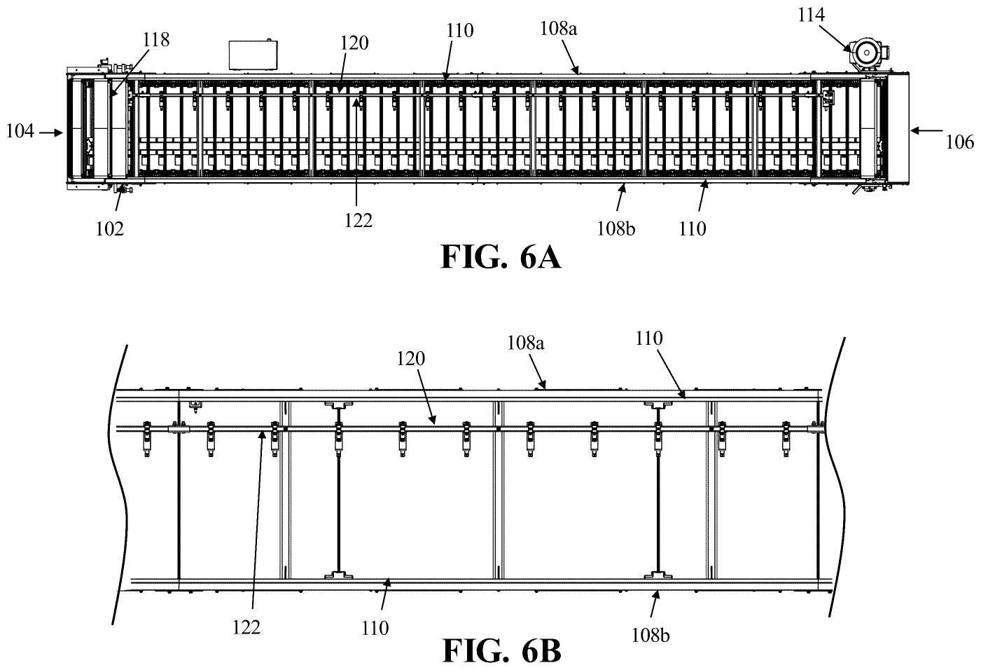

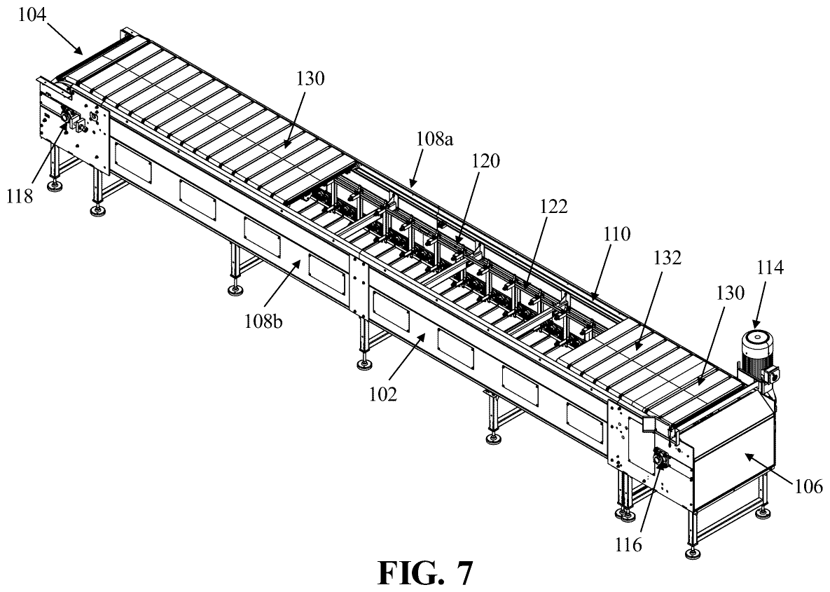

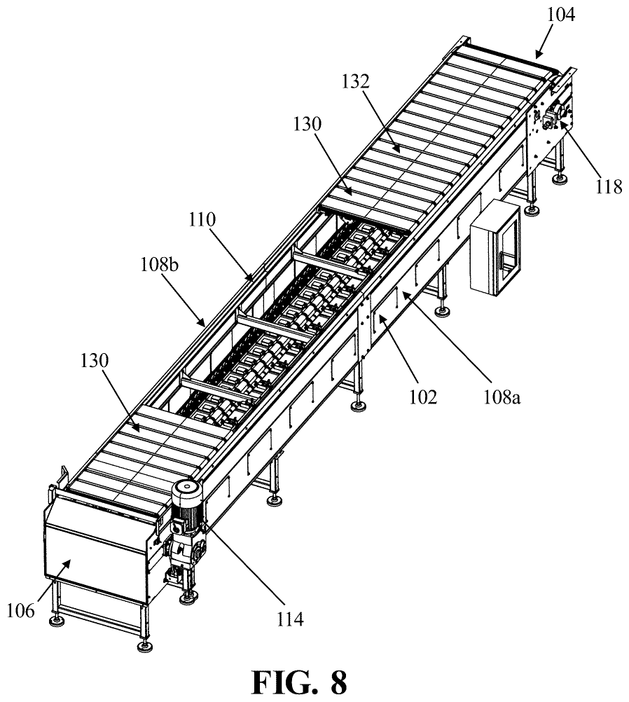

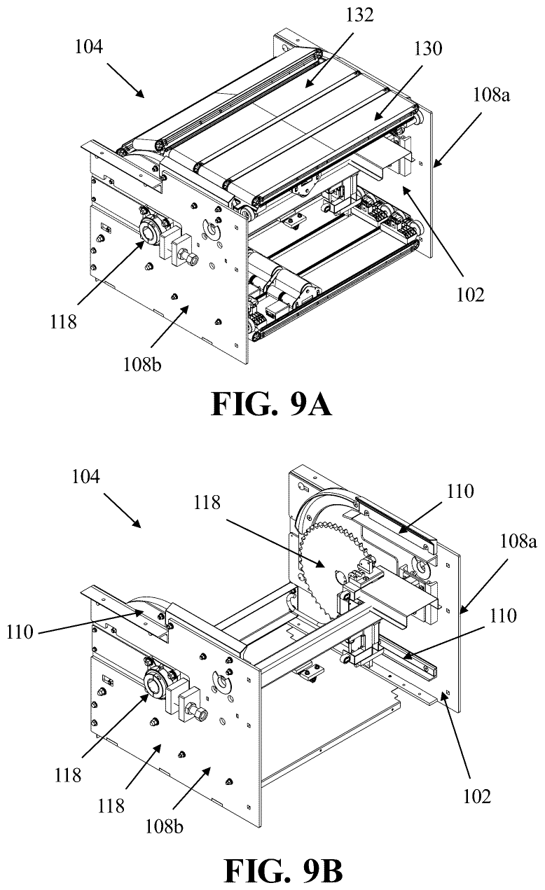

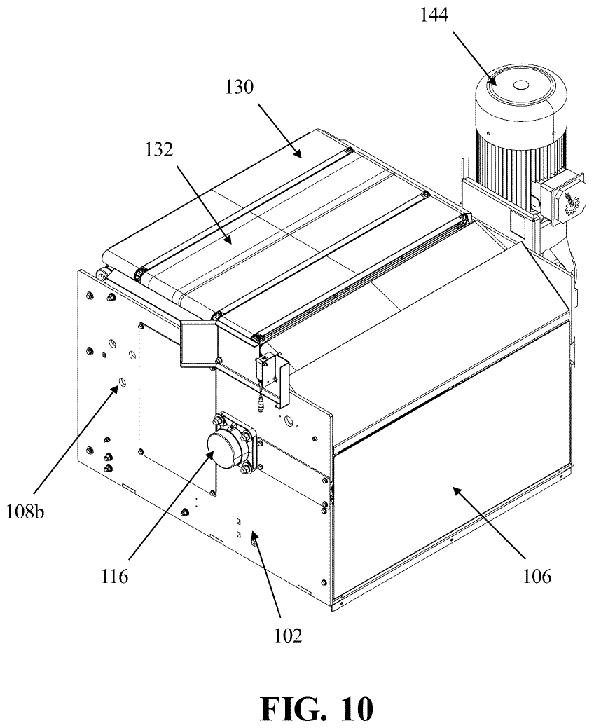

Referring now to FIGS. 3-10, the sorter system 100 is shown according to one embodiment. The frame 102 may include a left or first frame side 108a extending along one side of the sorter system 100 from the upstream end 104 to the downstream end 106 and a right or second frame side 108b extending on the opposite side of the frame 102 from the upstream end 104 to the downstream end 106. In the illustrated embodiment, the frame 102 includes one first frame side 108a and one second frame side 108b. However, it will be understood that the sorter system 100 may have other configurations. For example, the frame 102 may include two or more first frame sides 108a and two or more second frame sides 108b. Additionally or alternatively, the sorter system 100 may include two or more frames 102 connected in series (e.g., upstream end 104 to downstream end 106), such as to increase the length of the sorter system 100.

The frame 102 may include one or more tracks 110 configured to receive the carriages 130 and permit the carriages 130 to move the looped configuration. The tracks 110 may be disposed between the frame sides 108 and be configured to guide or otherwise allow the carriages 130 to move in a substantially continuous loop within the frame 102. In some embodiments, the tracks 110 guide the movement of the carriages 130. The one or more tracks 110 may extend in a looped configuration along the frame 102 with a top portion extending substantially along a top of the frame 102 from the upstream end 104 to the downstream end 106, a bottom portion extending substantially along the frame 102 from the downstream end 106 to the upstream end 104 below the top portion, and curved portions connecting the top and bottom portions near each of the upstream end 104 and the downstream end 106. The carriages 130 may be at least partially disposed on one or more tracks 110 such that the carriages 130 form a continuous loop are the tracks 110 and such that the carriages 130 may travel downstream on the top portion of the tracks 110, rotate around the curved portion of the tracks 110 at the downstream end 106, travel upstream on the bottom portion of the tracks 110, and rotate around to the curved portion of the tracks 110 at the upstream end 104 back to the top portion of the tracks 110. In some embodiments, the frame 102 includes first tracks 110a disposed along the first frame side 108a and second tracks 110b disposed along the second frame side 108b. The first and second tracks 110a, 110b may be aligned such that the carriages 130 are substantially level (e.g., horizontal) when disposed on the first and second tracks 110a, 110b.

The tracks 110 may be disposed such that the carriages 130 are supported by the top portion of the tracks 110 at a first height and such that the carriages are supported by the bottom portion of the tracks 110 at a second height. The carriages 130 may be moved downstream in an upright position at the first height and may be moved upstream at in an upside down position at the second height. The tracks 110 may be positioned and configured such that the top surfaces of the carriages 130 disposed at the first height are substantially at the same height as the top surfaces of the frame sides 108, such as to allow packages conveyed laterally via the carriages 130 to slide off the carriages 130 and over the frame sides 108. The carriages 130 may be configured such that the distance (e.g., height) between the first and second heights may be reduced. For example, the carriages 130 may be configured to have a narrower width such the curved portions of the tracks 110 may be reduced in height, such as by having tighter turn radiuses between the top and bottom portions of the tracks 110. The carriages 130 may be disposed on the tracks 110 such that the carriages 130 form a continuous loop around the tracks 110 at the first and second heights from the upstream end 104 to the downstream end 106. The carriages 130 may be individually placed on the tracks 110 such that the carriages 130 form a continuous loop of carriages 130 and may be pivotably connected to each other, such as via pivotable connectors, fasteners, or linkages, such that the carriages 130 may move in a collective loop around the tracks 110.

The tracks 110 may be sized, shaped, and configured such that wheels of the carriages 130 may roll, discussed below, along the tracks 110 in the looped configuration. The tracks 110 may also be sized, shaped, and configured to at least partially retain the wheels of the carriages 130 on the tracks 110 as the carriages 130 roll along the tracks 110, such as when the carriages 130 move from the top portion of the tracks 110 to the bottom portion of the tracks 110, when the carriages 130 move along the bottom portion of the tracks 110, and when the carriages 130 move from the bottom portion of the tracks 110 back to the top portion of the tracks 110. In the illustrated embodiments, the tracks 110 are substantially L-or C-shaped such that wheels of the carriages 130 may be retained on and/or within the tracks 110. However, it will be understood that the tracks 110 may have any suitable shape for at least partially retaining the carriages 130 as the carriages 130 travel in the looped configuration.

In the illustrated embodiment, the tracks 110 extend inwardly from the respective frame side 108. The first track 110a extends inwardly from the first frame side 108a and the second track 110b extends inwardly from the second frame side 108b. For example, the first track 110a may be attached to or be an inwardly extending portion of the first frame side 108a and the second track 110b may be attached to or be an inwardly extending portion of the second frame side 108b. While the tracks 110 of the illustrated embodiment are attached to or integral with the frame sides 108, it will be understood that the sorter system 100 may have other suitable configurations. For example, the tracks 110 may be disposed between the frame sides 108 and may be affixed to the frame sides 108, such as via a plurality of cross-frame members.

Each carriage 130 may be placed on the sorter system 100 with one side of the carriage 130 disposed on the first tracks 110a and the other side of the carriage 130 disposed on the second tracks 110b such that carriages 130 extend substantially between the frame sides 108. The carriages 130 may be individually placed on the tracks 110 such that the carriages 130 form a continuous loop or the carriages 130 may be pivotably connected to each other, such as via pivotable connectors, fasteners, or linkages, such that the carriages 130 may move in a collective loop around the tracks 110. While the sorter system 100 has been described as including two tracks 110, it will be understood that the sorter system 100 may have any suitable number of tracks 110. For example, the sorter system 100 may include one or three or more tracks 110.

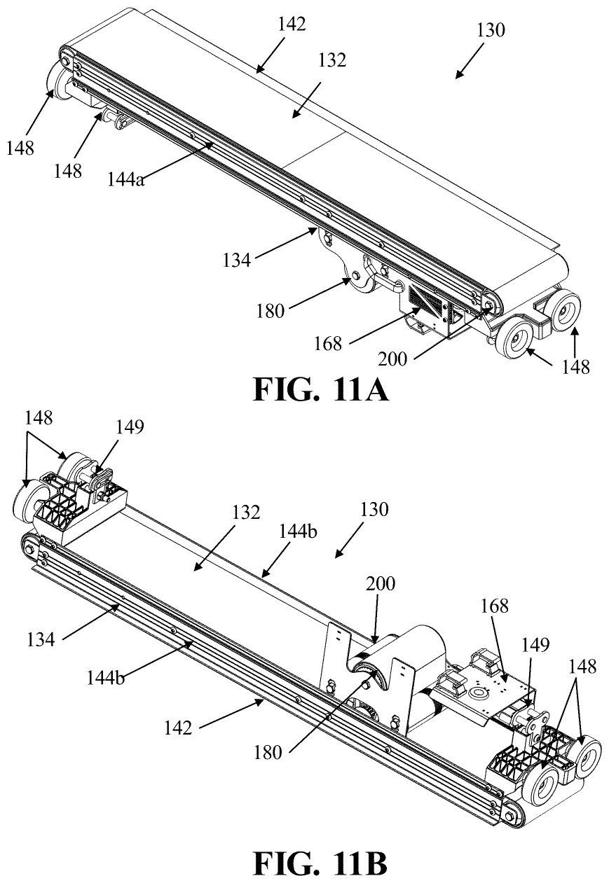

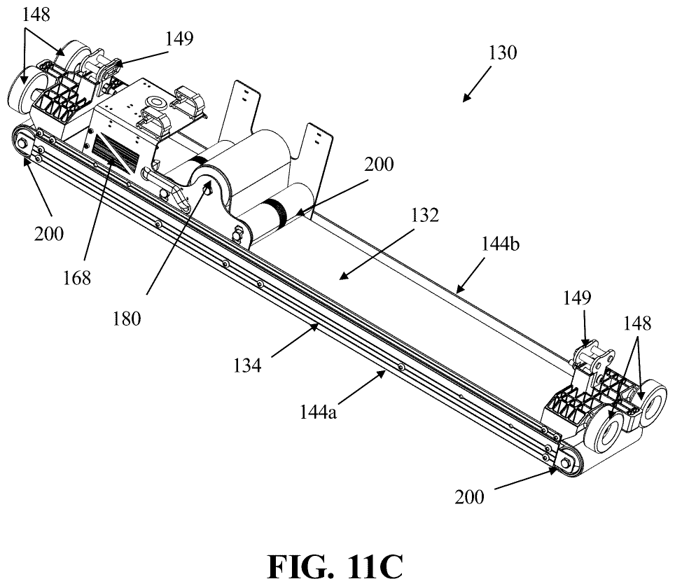

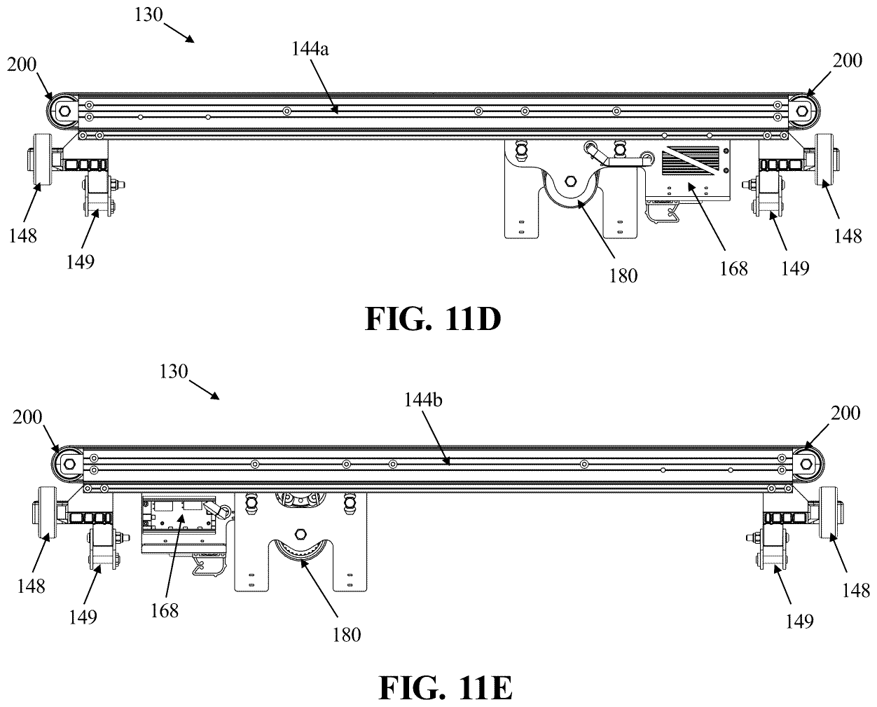

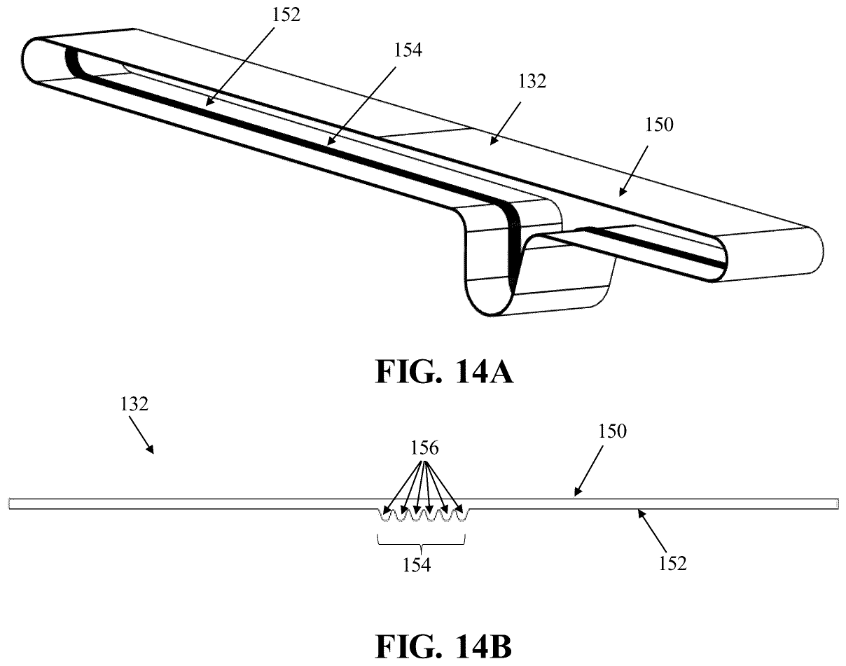

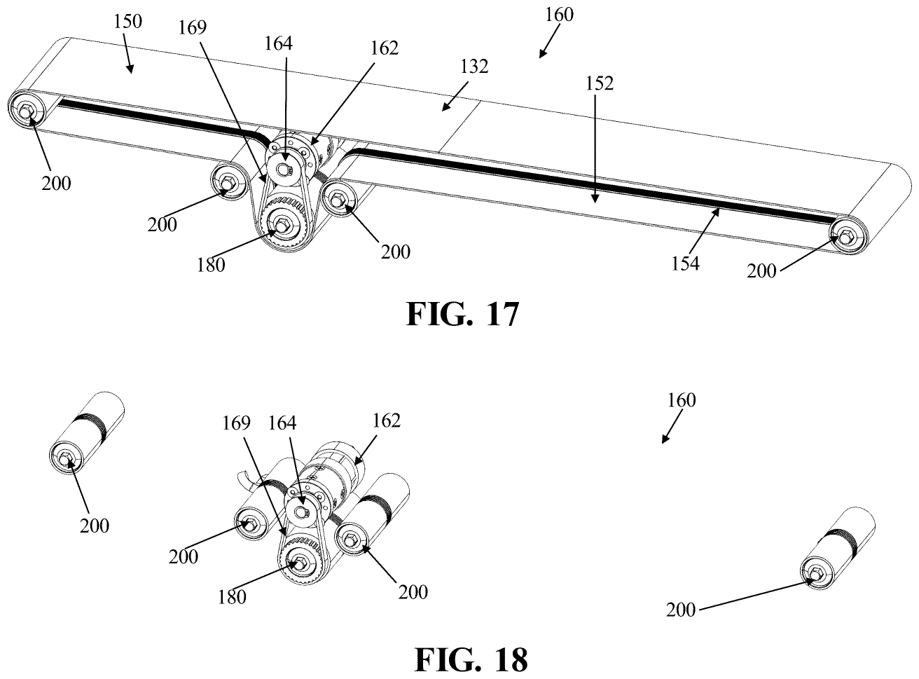

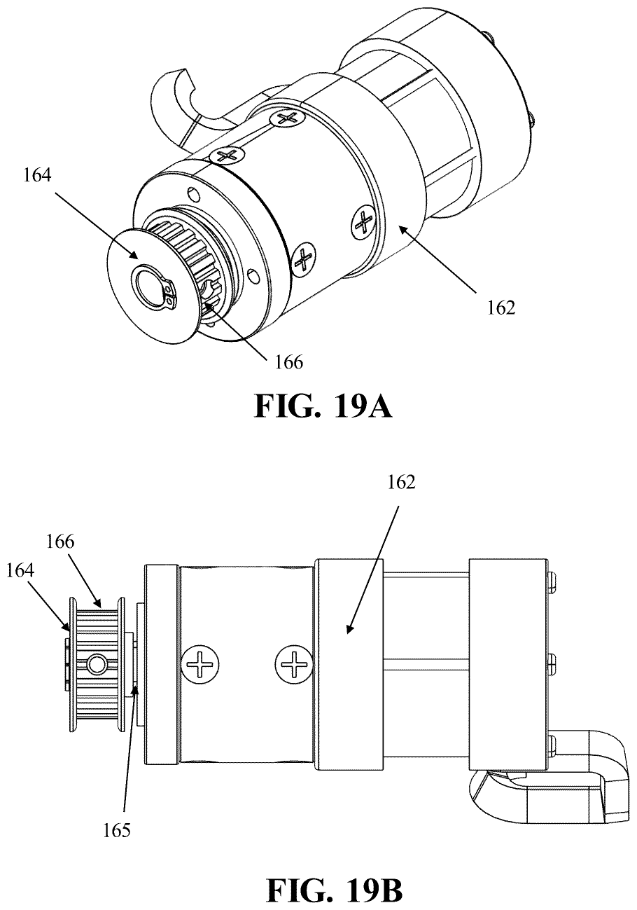

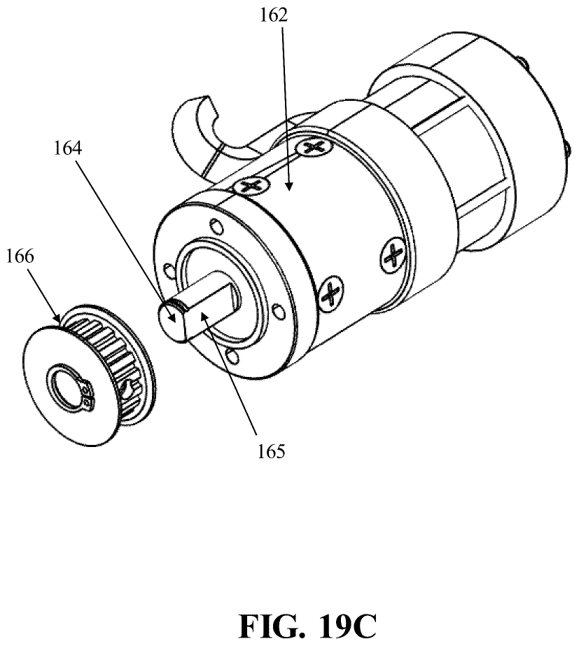

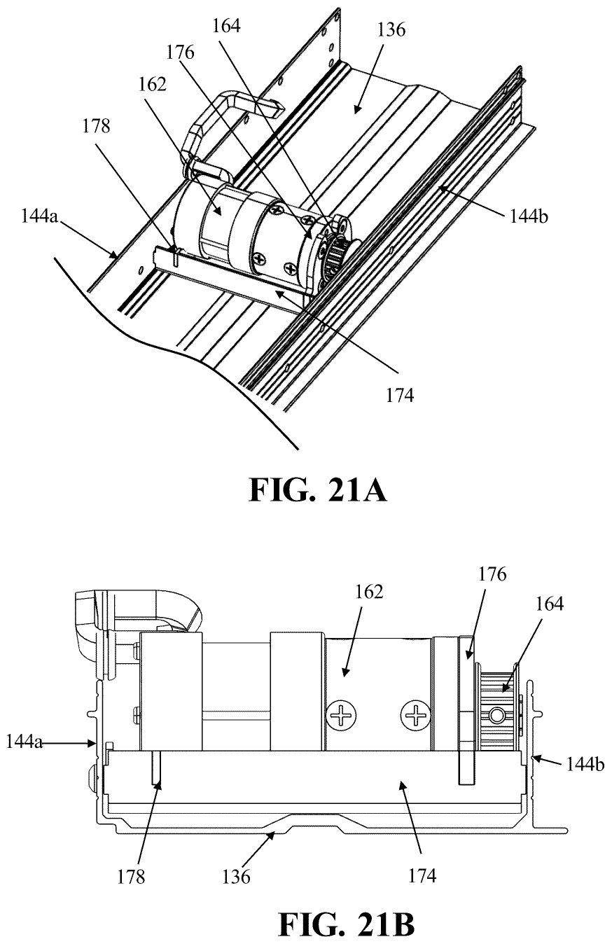

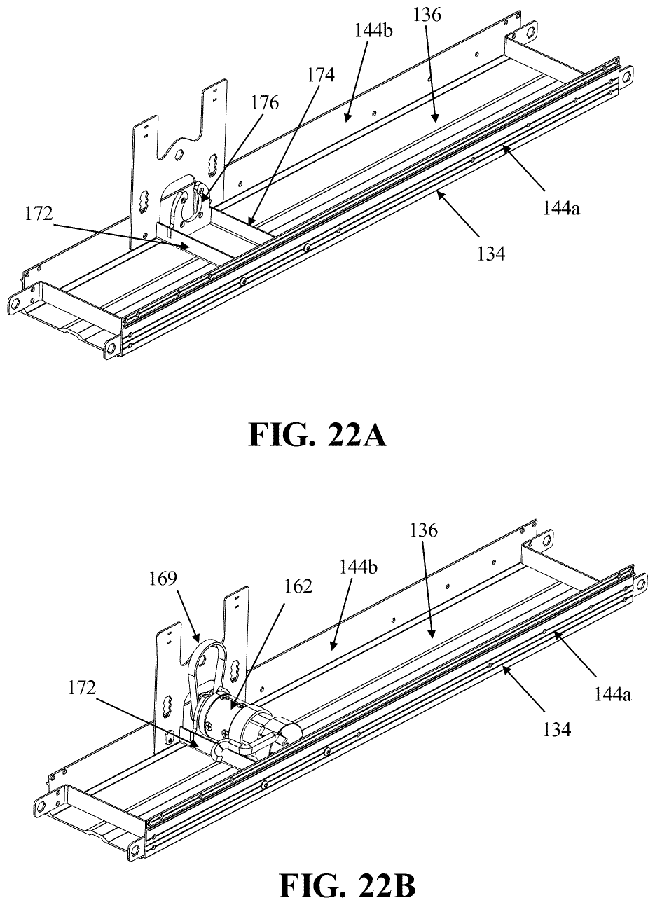

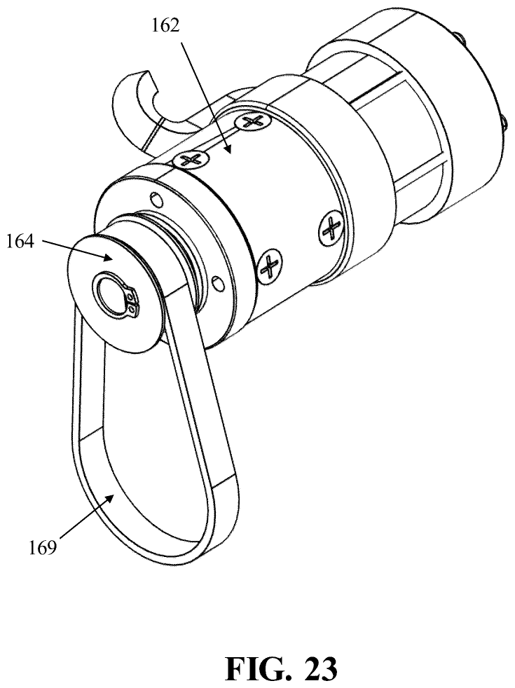

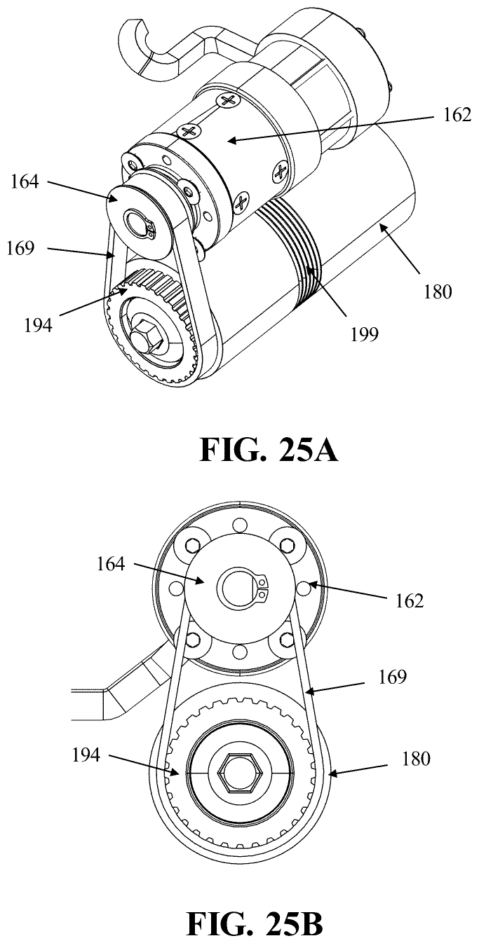

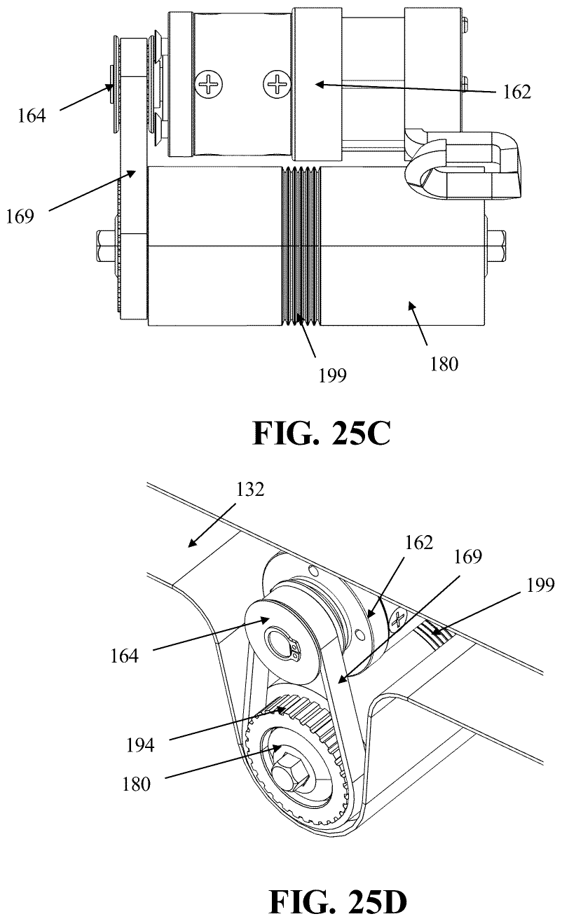

As shown in FIGS. 11A-27B, the sorter system 100 may also include a carriage drive system 112 configured to drive or otherwise move the carriages 130 around the tracks 110. The carriage drive system 112 may include a motor 114 coupled to a drive shaft 116 within the frame 102. The motor may be coupled to a power source to provide power to the motor 114 to cause the drive shaft 116 to rotate. The drive shaft 116 may be disposed near the upstream end 104 of the sorter system 100 and be connected to a follower shaft 118 near the downstream end 106 of the sorter system 100. The drive and follower shafts 116, 118 may include a rod or shaft rotatably secured in the frame 102, such as within the frame sides 108, and a wheel or gear. The gears of the drive and follower shafts 116, 118 may be aligned and connected or otherwise coupled with one or more coupling device such as a drive belt, a linked chain, or the like. The coupling device may be coupled to, in abutment with, or otherwise connected to the carriages 130 on the tracks 110 such that movement or rotation of the coupling device moves or rotates the carriages 130 along the tracks 110. Rotation of the drive shaft 116 may rotate the coupling device, thereby rotating the follower shaft 118 and the carriages 130 along the tracks 110. The power source may provide power to the motor 114 which causes the drive shaft 116 to rotate which rotates the coupling device, thereby rotating the follower shaft 118 and moving or rotating the carriages 130 along the tracks 110.

The sorter system 100 may include a sorter power line 120 configured to provide power to one or more carriages 130 in the sorter system 100. The sorter power line 120 may be connected with a power source and may be disposed between the frame sides 108. The sorter power line 120 may extend substantially from the upstream end 104 to the downstream end 106 and may be disposed between the frame sides 108 such that carriages 130 disposed on the tracks 110 may receive power from the sorter power line 120. For example, the sorter power line 120 may be disposed between the frame sides 108 such that carriages 130 traveling along the top portion of the tracks 110 (e.g., carriages 130 defining the conveying surface 128) are disposed near the sorter power line 120 such that carriages 130 may receive power from the sorter power line 120. In some embodiments, the sorter power line 120 is stationary relative to the frame 102 such that the sorter power line 120 does not move as the carriages 130 are rotates around the tracks. In the illustrated embodiment, the sorter power line 120 is mounted to the frame 102 of the sorter system 100 such that the sorter power line 120 is stationary relative to the frame 102 as the carriages 130 travel in a looped configuration around the tracks 110. However, it will be understood that the sorter system 100 may have other suitable configurations. For example, the sorter system 100 may include one or more power lines 120 coupled to one or more carriages 130 such that the power lines 120 remain coupled to the respective carriages 130 as the carriages 130 travel in the looped configuration around the tracks 110.

The sorter power line 120 may provide power sufficient to operate each of the carriages 130 disposed on the top portion of the tracks 110. For example, the sorter power line 120 may provide sufficient power to simultaneously rotate each belt 132 of each carriage 130 defining the conveying surface 128 of the sorter system 100. The sorter power line 120 may receive and convey alternating current (AC) power. In some embodiments, the sorter power line 120 is configured to transmit power at about 480V AC. In some embodiments, the sorter power line 120 is a high frequency cable. One or more carriages 130 may receive power provided via the power line 120 and subsequently provide or otherwise distribute the received power to one or more adjacent carriages 130 to actuate each carriage 130, as detailed below.

The sorter system 100 may also include a control line 122 configured to transmit or otherwise provide control signals to one or more carriages 130 to control the operation of carriages 130 in the sorter system 100. The control line 122 may extend substantially from the upstream end 104 to the downstream end 106 and may be disposed between the frame sides 108 such that carriages 130 disposed on the tracks 110 may receive control signals from the control line 122. For example, the control line 122 may be disposed between the frame sides 108 such that carriages 130 disposed along the top portion of the tracks 110 are disposed near the control line 122 such that the carriages 130 may receive control signals transmitted from control line 122. In the illustrated embodiment, the control line 122 is mounted to the frame 102 of the sorter system 100 such that the control line 122 is stationary relative to the frame 102 as the carriages 130 travel in a looped configuration around the tracks 110. However, it will be understood that the sorter system 100 may have other suitable configurations. For example, the sorter system 100 may include one or more control lines 122 coupled to one or more carriages 130 such that the control lines 122 remain coupled to the respective carriages 130 as the carriages 130 travel in the looped configuration around the tracks 110. The control line 122 may be configured to transmit command signals generated by the sorter system controller 240 to one or more carriages 130 such that the carriages 130 may be actuated based upon the command signals, as detailed below. The control line 122 may be configured to wirelessly transmit control signals to one or more carriages 130 as the carriages 130 travel around the tracks 110 of the sorter system 100. The control line 122 may transmit control signals to one or more master carriages 130 which are configured to transmit control signals to one or more adjacent carriages 130 to control actuation of the adjacent carriages 130, as detailed below. In some embodiments, the control line 122 is a leaky coaxial cable which is configured to wirelessly transmit or radiate control signals along a length of the control line 122. While the sorter system 100 has been described as having a control line 122 that is configured to wireless transmit control signals along a length of the control line 122, it will be understood that the sorter system 100 may have other suitable configurations. For example, the sorter system controller 240 may comprise one or more network interfaces, such as a Bluetooth, Internet, intranet, cellular, infrared, WiFi, radio, ultraband, ZigBee, or other network, which is configured to transmit command outputs and one or more receivers disposed on one or more carriages 130 and configured to receive the command outputs transmitted by the network.

Referring now to FIGS. 11A-13C a carriage 130 is shown according to one embodiment. The carriage 130 includes a carriage frame 134 and a belt drive system 160 with a belt 132 configured to convey one or more packages laterally to one or both sides of the conveying surface 128, such as into chutes 124 or receptacles, as packages are conveyed along the conveying surface 128 from the upstream end 104 toward the downstream end 106. The belt drive system 160 may also be configured to reduce the size of the carriages 130, such as the width of the carriages 130 (e.g., length of the carriages 130 extending in a direction between the upstream and downstream ends 104, 106). The widths of the carriages 130 may be reduced to increase control of the conveyance of one or more packages through the sorter system 100 and/or to reduce the overall size (e.g., height and/or length) of the sorter system 100, as detailed below. The belt drive system 160 may also be configured to reduce the energy inputs required to sort or otherwise move packages, such as by decreasing frictional forces of actuating the carriages 130, as detailed below.

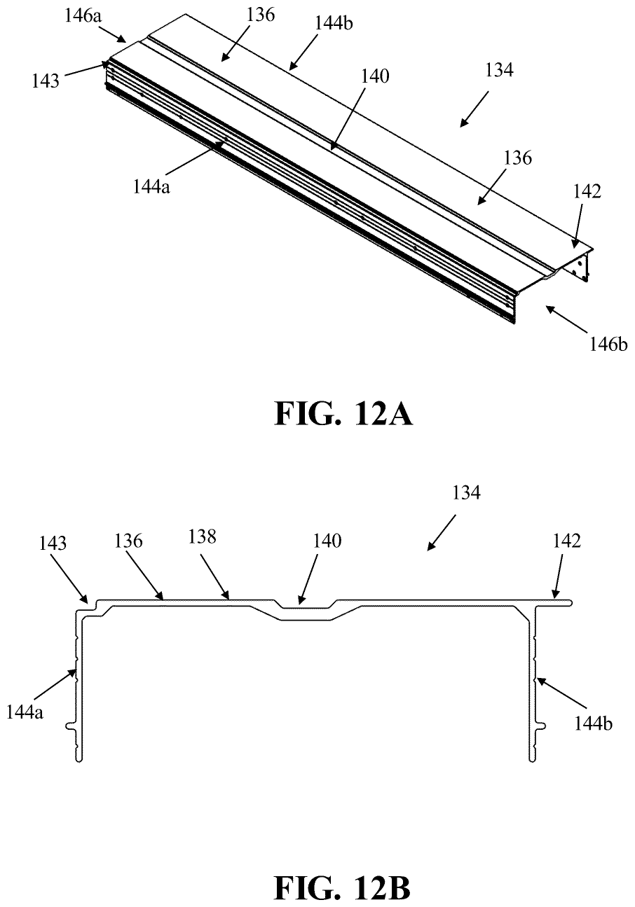

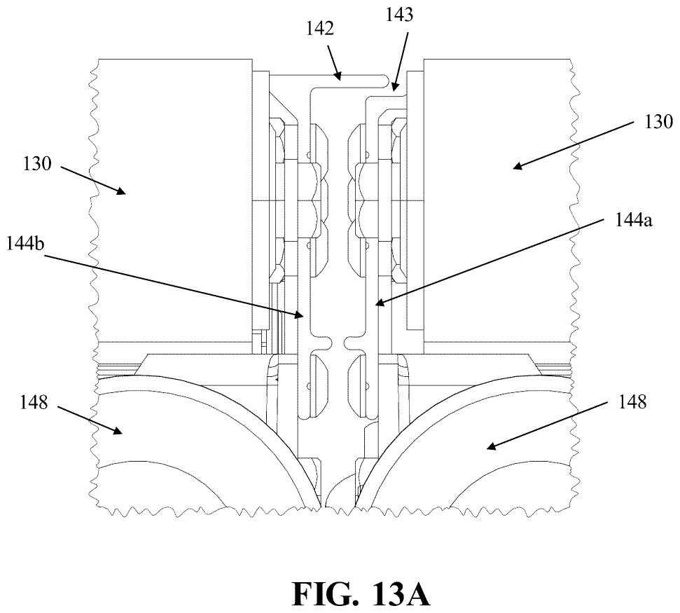

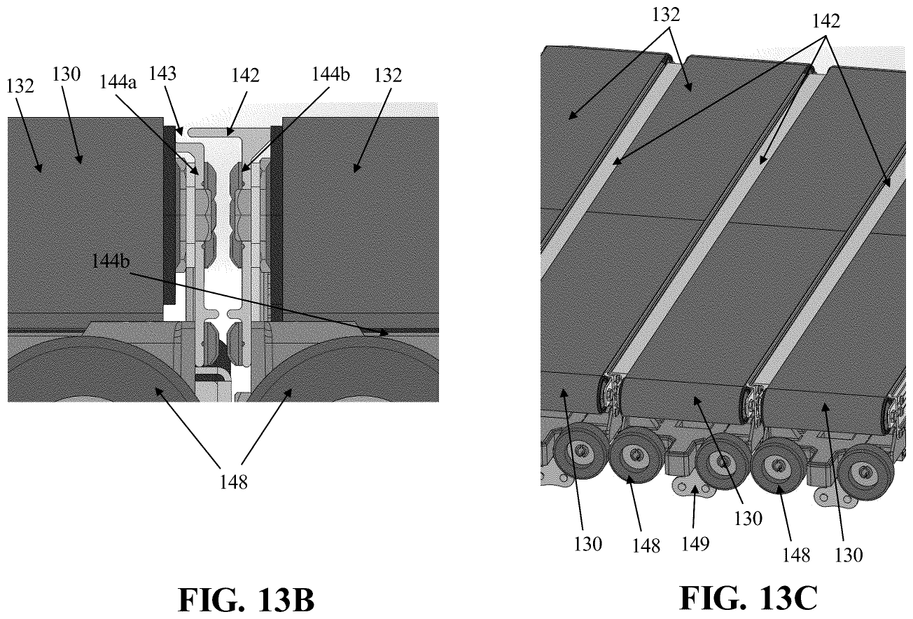

As shown in FIGS. 12A-13C, the carriage frame 134 may be a substantially rectangular U-shape with a top wall 136 defining a top surface 138 (when the carriage 130 is in the upright position) and side walls 144 disposed on the upstream and downstream sides of the top wall 136. The carriage frame 134 may include a first or upstream side wall 144a and a second or downstream side wall 144b opposite the first side wall 144a. The top surface 138 may extend substantially between lateral edges 146 of the carriage frame 134 disposed near the frame sides 108 when the carriage 130 is disposed on the tracks 110. For example, the top surface 138 may extend between a first edge 146a and a second edge 146b, the first and second edges 146a, 146b may be spaced apart a distance such that the carriage 130 extends substantially between the frame sides 108 when the carriage 130 is disposed on the tracks 110. The carriage frame 134 may be sized, shaped, and configured such that the belt 132 defines a portion of the conveying surface 128 when the carriage 130 is disposed on the top portion of the tracks 110 of the frame 102. The carriage frame 134 may be configured such that the belt 132 may be rotated around a portion of the carriage frame 134 and such that the belt 132 may be actuated or driven in a first direction (e.g., from the first edge 146a toward the second edge 146b) and a second direction (e.g., from the second edge 146b toward the first edge 146a) along the top surface 138 of the carriage frame 134. The first and second side walls 144a, 144b may be spaced apart to accommodate at least a portion of the belt drive system 160. In some embodiments, the carriages 130 are configured to reduce the distance between the side walls 144 such that the width of the carriages 130 may be reduced, as detailed below.

The top surfaces 138 of the carriage frames 134 may comprise materials and/or coatings, or combinations thereof, with low coefficients of friction such that the belt 132 may rotate around a portion of the carriage frame 134 smoothly and at a reduced torque or energy level. In some embodiments, the top surface 138 of the carriage frame 134 has a dynamic coefficient of friction between about 0.15 and about 0.50, such as between about 0.20 and about 0.40, such as about 0.295. In some embodiments, the top surface 138 of the carriage frame 134 comprises extruded aluminum and/or a hard anodized coating. The top surfaces 138 of the carriage frames 134 may also be sized, shaped, and configured to retain the belt 132 on the carriage frame 134 and to improve the drive of the belt 132 around the carriage frame 134, as described below.

The carriage 130 may also include one or more wheels 148 disposed on opposite sides of the carriage 130. The wheels 148 may be spaced apart such that one or more carriage wheels 148 on opposite sides of the carriage 130 may be disposed on and/or in the tracks 110 of the frame 102 such that the carriages 130 may move along the tracks 110. The wheels 148 may be sized, shaped, and configured to engage with the tracks 110 of the frame 102. The wheels 148 may extend laterally from a bottom portion of the carriage frame 134 such that each of the carriage wheels 148 may rotate along the tracks 110 in the looped configuration (e.g., along a top surface of the top portion of the tracks 110 and along a bottom surface of the bottom portion of the tracks 110). In the illustrated embodiment, each carriage 130 includes four wheels 148 with two wheels 148 disposed near each edge 146 of the carriage frame 134. However, it will be understood that the carriages 130 may have other suitable configurations. For example, the carriage 130 may include one or three or more wheels 148 near each edge 146 of the carriage frame 134.

In some embodiments, the carriages 130 also include one or more retention members 149 configured to retain the carriages 130 on the tracks 110 when the wheels 148 are disposed on the tracks 110. The retention members 149 may extend laterally from a bottom portion of the carriage frame 134 below the carriage wheels 148 when the carriage 130 is in an upright position. The retention members 149 may be spaced apart vertically from the carriage wheels 148 such that the retention members 149 may be disposed on an inside surface of the tracks 110 opposite from the carriage wheels 148 when the carriage wheels 148 are disposed on the outer surface of the tracks 110. For example, the retention members 149 may be disposed on a bottom surface of the tracks 110 when the carriage wheels 148 roll on the top portion of the tracks 110, a top surface of the tracks 110 when the carriage wheels 148 roll on the bottom portion of the tracks 110, and an inside surface of the tracks 110 when the carriage wheels 148 roll around the curved portions of the tracks 110 between the top and bottom portions. The retention members 149 may contact surface of the tracks 110 opposite where the wheels 148 contact the tracks 110 to provide opposite forces which retain the carriages 130 on the tracks 110 (e.g., pinch the tracks 110 between the retention members 149 and the wheels 148).

In the illustrated embodiment, the retention members 149 include two tubular projections which extend laterally from other portions of the carriage frame 134 and a shoulder attached to the outside ends of the tubular projections. The tubular projections of the retention members 149 are configured to slide along the inside surface of the tracks 110 and the shoulder is configured to abut an outside surface of the tracks 110, such as to retain the retention members 149 on the tracks 110. In some embodiments, the tubular projections of the retention members 149 are rotatable such that the tubular members may roll or otherwise rotate on the underside of the tracks 110. While the retention members 149 are shown as including tubular projections and a shoulder, it will be understood that the retention members 149 may have other suitable configurations. For example, the retention members 149 may be or include wheels configured to roll or otherwise rotate along the underside of the tracks 110 opposite the carriage wheels 148 to retain the carriages 130 on the tracks 110 as the carriages 130 are moved in the looped configuration around the tracks 110.

While the carriages 130 are described as having carriage wheels 148 slidable on the tracks 110 and retention members 149 configured to retain the carriage 130 on the tracks 110 of the frame 102, it will be understood that the sorter system 100 and/or the carriages 130 may have other configurations. For example, the carriages 130 may be coupled to frame 102 via magnets driven around the sorter system 100 in a looped configuration via magnetic induction.

The carriages 130 may be sized, shaped, and configured such that the carriages 130 may rotate around the tracks 110 together, such as via rotation of the sorter drive shaft 116. In some embodiments, the carriages 130 are disposed on the tracks 110 such that the movement of one carriage 130 abuts an adjacent carriage 130 to drive the movement of the carriages 130 around the tracks 110. For example, the sorter system 100 may include a sufficient number of carriages 130 to substantially fill the tracks 110. In some embodiments, the sorter system 100 includes a continuous belt or chain disposed between the frame sides 108 and extending around the sorter drive shaft 116 and the follower shaft 118 and from the upstream end 104 and the downstream end 106 and coupled with one or more of the carriages 130. The continuous belt or chain may be rotated via the drive shaft 116, such by actuation of the motor 114, disposed at the upstream or downstream end 104, 106 such that rotation of the continuous belt or chain drives the carriages 130 around the tracks 110. However, it will be understood that the carriages 130 may be disposed around the tracks 110 in other suitable manners. For example, each carriage 130 may be coupled to one or more adjacent carriage 130 via fasteners or other similar mechanisms disposed on the side walls 144 of the carriage frames 134.

In some embodiments, each carriage frame 134 may include one or more longitudinal projections 142 extending longitudinally (e.g., upstream or downstream) from the top surface 138. The longitudinal projections 142 may extend from the first or second side wall 138a, 138b at a height substantially equivalent to the top surface 138 and/or top wall 136 to extend the top surface 138 in either the upstream or downstream direction. In the illustrated embodiment, the longitudinal projections 142 extend from the second side wall 144b such that the top surface 138 extends in the downstream direction beyond the second side wall 144b. However, it will be understood that the longitudinal projections 142 may alternatively extend from the first side wall 144a such that the top surface 138 extends in the upstream direction beyond the first side wall 144a.

The longitudinal projections 142 may extend a distance upstream or downstream from the respective side wall 144 such that the top surface 138 of each carriage 130 is substantially contiguous with the top surface 138 of the adjacent upstream or downstream carriage 130 when the carriage 130 are disposed on the top portion of the tracks 110. The carriages 130 and/or the longitudinal projections 142 may be sized, shaped, and configured such that the top surfaces 138 of carriages 130 defining the conveying surface 128 are substantially continuous (e.g., no gaps) from the upstream end 104 to the downstream end 106. For example, the longitudinal projections 142 may extend a distance toward an adjacent carriage 130 such that the longitudinal projections 142 cover the gap between adjacent carriages 130 disposed on the top portion of the tracks 110 (e.g., the carriages 130 defining the conveying surface 128).

In some embodiments, each carriage frame 134 also includes one or more receiving portions 143 configured to receive the longitudinal projection 142 of an adjacent carriage 130. The receiving portions 143 may extend into the side wall 144a, 144b opposite the longitudinal projections 142 at a height substantially equivalent to the top surface 138 and corresponding to a height of the longitudinal projection 142. Each receiving portion 143 is configured to receive the longitudinal projection 142 of the adjacent carriage 130 such that top surfaces 138 of the carriages 130 defining the conveying surface 128 are substantially contiguous. The longitudinal projections 142 and the receiving portions 143 may be configured such that the longitudinal projections 142 may pivot radially outwardly from the receiving portions 143 when the carriages 130 travel around the curved portion of the tracks 110. The substantially continuous conveying surface 128 may prevent packages from falling between adjacent carriages 130 and/or reduce the likelihood of packages getting stuck on the conveying surface 128 (e.g., getting wedged between the side walls 144 of adjacent carriages 130). The disposition of the longitudinal projections 142 in the receiving portions 143 may also reduce the cap or clearance between adjacent carriages 130. In the illustrated embodiment, the receiving portions 143 extend downstream from the first side wall 144a. However, it will be understood that the receiving portions 143 may extend upstream from the second side wall 144b, such as in embodiments in which the longitudinal projections 142 extend upstream from the first side wall 144a.

Each carriage 130 includes a carriage belt 132 disposed in a looped configuration around and/or partially within the carriage frame 134. The belts 132 are configured to rotate in first and/or second directions orthogonally to the direction of travel of the carriages 130 on the tracks 110. For example, the carriage belts 132 may be configured to rotate left and/or right in relation to the conveying direction of the sorter system 100, such as to direct packages to chutes 124 disposed on the left and/or right of the sorter system 100. The carriage belts 132 may be disposed around the carriage frames 134 such that a top surface of the portion of the carriage belt 132 disposed on the top surface 138 of the carriage frame 134 defines a portion of the conveying surface 128. Each carriage belt 132 has a width extending in a direction extending between the upstream and downstream ends 104, 106. The width of the carriage belts 132 may be substantially equivalent to the width of the carriage frames 134 between the first and second side walls 144 of the carriage frames 134. The belts 132 may be sized, shaped, and configured to reduce the torque and/or energy required to drive the belts 132 and/or to reduce friction between the belts 132 and the carriage frames 134, as detailed below. In some embodiments, the belts 132 comprise fabric. In some embodiments, the belts 132 are laminated belts and may include a composite of materials, such as fabric, as well as other materials. The belts 132 may also include cords disposed within the belt 132 and extending longitudinally through the belt 132, such as to increase the strength of the belt 132. In some embodiments, the belts 132 comprise urethane with Kevlar cords disposed in and extending longitudinally through the belt 132.

Each belt 132 is a continuous loop with an outer surface 150 and an inner surface 152 opposite the outer surface 150. The inner surface 152 is configured to slide along the top surface 138 of the carriage frame 134 between the first and second edges 146a, 146b. The outer surface 150 of the portion of the belt 132 disposed on the top surface 138 of the carriage frame 134 may define a portion of the conveying surface 128 such that packages may be at least partially disposed on the outer surface 150 of the belt 132 on the carriage frame 134. The outer surface 150 of the belt 132 may be configured to sufficiently grip packages disposed on the outer surface 150 such that the packages may be moved via rotation of the belt 132, such as being conveyed over the frame sides 108 of the sorter system 100 as the belt 132 is rotated around the carriage frame 134. For example, the outer surface 150 of the belt 132 may be textured and/or comprise a material and/or coating with a high coefficient of friction such that the outer surface 150 sufficiently grips packages and such that rotation of the belt 132 correspondingly conveys or otherwise moves packages disposed on the belt 132. Additionally or alternatively, the outer surface 150 of each belt may include materials, coatings, and/or compositions, or any combinations thereof, which increase the coefficients of friction of the outer surfaces 150. In some embodiments, the outer surfaces 150 of the belts 132 comprise textured urethane, such as to increase the grip of the outer surfaces 150 on packages disposed on the belt 132.

The inner surface 152 of the belt 132 may be configured such that the belt 132 rotates smoothly around the carriage frame 134, such as along the top surface 138 of the carriage frame 134. The inner surface 152 of the belt 132 may comprise materials and/or coating to reduce the coefficient of friction of the inner surface 152 such that the belt 132 slides easily around the carriage frame 134, including along the top surface 138 of the carriage frame 134, as one or more packages are disposed on the belt 132. The lower coefficient of friction of the inner surface 152 may also reduce the energy and/or torque required to drive the belts 132, such as to reduce the cost of operating the sorter system 100 and/or to reduce the energy draw on the drive motor of each carriage 130. In some embodiments, at least a portion of the inner surface 152 of the belt 132 comprises a smooth fabric.

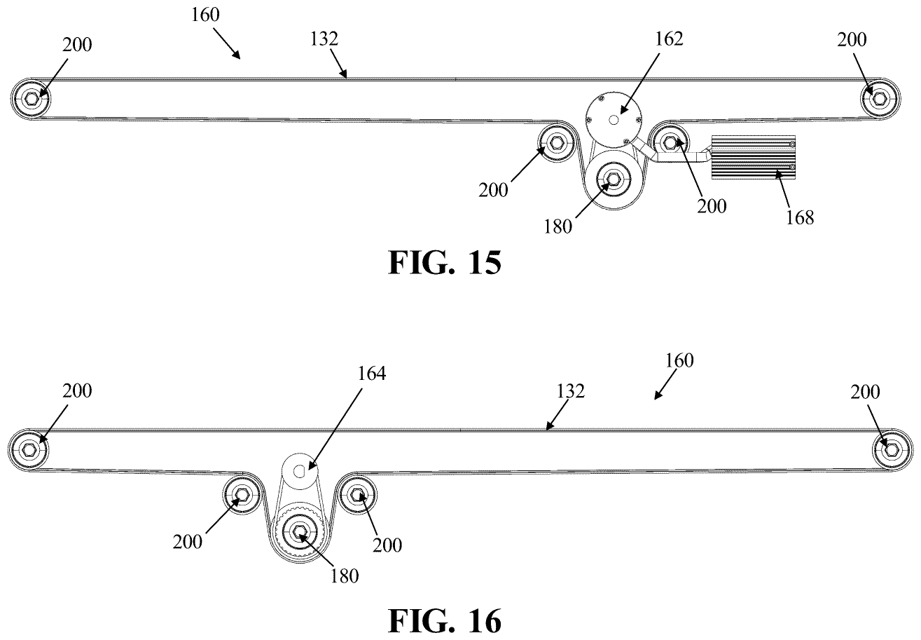

Referring now to FIGS. 15-23, each belt drive system 160 includes a belt drive motor 162 connected to a belt drive shaft 164 configured to rotate the belt 132 within and/or around the carriage frame 134, such as in directions perpendicular to the traveling direction of the carriage 130 along the tracks 110. Each belt drive motor 162 may be coupled with the respective belt drive shaft 164 such that the belt drive shaft 164 rotates with actuation of the belt drive motor 162. The belt drive system 160 may be configured to rotate the respective belt 132 around the respective carriage frame 134 such that the portion of the belt 132 disposed on the top surface 138 of the carriage frame 134 laterally moves or actuates in a first (e.g., left) direction and/or a second (e.g., right) direction. The belt drive system 160 may be sized, shaped, and configured such that the width of the carriage 130, such that the width of the carriage frame 134 may be reduced, such that a greater number of carriages 130 and/or a greater number of belts 132 may define the conveying surface 128, such that the precision of the sorter system 100 may be increased, and/or such that sorter system 100 may suitable sort a larger number and/or a greater density of packages.

Each belt drive motor 162 may be coupled to a drive controller 168 configured to provide power and/or command signals to the belt drive motor 162 to control the operation of the belt drive motor 162. Each belt drive motor 162 may be configured to rotate the respective belt drive shaft 164 in either a first direction or a second direction (e.g., clockwise or counterclockwise), such as via the belt drive shaft 164, based upon the power (voltage, current, polarity, etc.) and/or command signal received from the drive controller 168. The belt drive motors 162 may also be configured to rotate the respective belt drive shaft 164 at varying speeds and for varying amounts of time (e.g., varying distances) based upon the power and/or command signal received form the respective drive controller 168. In some embodiments, the belt drive motors 162 are brushless DC motors.

Each drive controller 168 may be disposed on the underside of the carriage frame 134 near the belt drive motor 162. Each drive controller 168 is configured to receive power and command signals as the carriage 130 travels around the tracks 110, such as from the control line 122, as detailed below. Each drive controller 168 may be coupled with the respective belt drive motor 162 via a wire or cable to provide power and command signals to the belt drive motor 162 to control the actuation of the belt 132 around the carriage frame 134. In some embodiments, the drive controllers 168 are configured to control the speed, amount (e.g., distance), and/or direction of belt 132 actuation via the belt drive motor 162 based upon command signals provided to the belt drive motors 162. For example, the belt drive motors 162 may be configured to rotate the belt 132 based upon the control signals received from the drive controller 168. In other embodiments, the drive controllers 168 are configured to control the speed, amount, and/or direction of belt 132 actuation via the belt drive motor 162 based amount the amount and polarity of energy provided to the belt drive motor 162 (e.g., rotating in a first direction based on a first polarity and rotating in a second direction based upon a second polarity). For example, the drive controller 168 may be configured to control the amount and/or polarity of the power provided to the belt drive motor 162 to control the actuation of the belt 132.

The belt drive motor 162 may be coupled with the belt drive shaft 164 such that actuation of the belt drive motor 162 rotates the belt drive shaft 164. The belt drive shaft 164 may include a shaft portion 165 and a connector coupling portion 166. The shaft portion 165 may be substantially cylindrical and disposed partially within or otherwise coupled with the belt drive motor 162 such that actuation of the belt drive motor 162 rotates the shaft portion 165. The connector coupling portion 166 is disposed at an end of the shaft portion 165 opposite the belt drive motor 162 such that the connector coupling portion 166 extends radially around (e.g., surrounds) the end of the shaft portion 165. The connector coupling portion 166 is configured to engage with a drive connector 169, as detailed below. The connector coupling portion 166 has a diameter larger that the diameter of the shaft portion 165 such that the connector coupling portion 166 has a greater circumference than the shaft portion 165.

The drive connector 169 is a looped belt configured to be disposed at least partially around the connector coupling portion 166 of the belt drive shaft 164 and at least partially around another rotational member, such as a drive pulley, to transfer rotational movement of the connector coupling portion 166 the other rotational member. The drive connector 169 may be sized, shaped, and configured to be stretched around the outer surfaces of the connector coupling portion 166 and the other rotational member. In some embodiments, the drive connector 169 comprises polyurethane and/or rubber. The drive connector 169 may also be sized, shaped, and configured to engage with the outer surfaces of the connector coupling portion 166 of the belt drive shaft 164 and the other rotational member, as detailed below. For example, the drive connector 169 may be a V-belt type connector, may be pitched, may comprise a plurality of shaped or patterned teeth or ribs which may correspond to notches or receiving portions of the connector coupling portion 166 and/or a drive pulley, and/or may be textured or otherwise configured to increase frictional engagement between the drive connector 169 and the connector coupling portion 166 and the drive pulley.

The connector coupling portion 166 has a radial outer surface configured to engage with an inner surface of the drive connector 169. A portion of the radial outer surface of the connector coupling portion 166 may be configured to interlock with the drive connector 169 and/or to increase frictional forces between the connector coupling portion 166 and the drive connector 169. In some embodiments, an outer radial surface of the connector coupling portion 166 of the belt drive shaft 164 comprises a plurality of shaped or patterned teeth or ribs to increase rotational engagement between the connector coupling portion 166 and the drive connector 169. In some embodiments, the connector coupling portion 166 includes radially extending walls on either side of the portion of the connector coupling portion 166 configured to engage with the drive connector 169 to prevent the drive connector 169 from decoupling from the connector coupling portion 166, such as by preventing the drive connector 169 from sliding off the connector coupling portion 166.

In the illustrated embodiment, the shaft portion 165 is separate from the connector coupling portion 166. The shaft portion 165 and the connector coupling portion 166 are sized, shaped, and configured such that the connector coupling portion 166 may be disposed on one end of the shaft portion 165 and such that the connector coupling portion 166 may rotate with the shaft portion 165. At least a portion of the shaft portion 165 may be non-circular and the connector coupling portion 166 may have an aperture or passage extending through a center of the connector coupling portion 166 sized, shaped, and configured to receive the shaft portion 165 and to abut a portion of the shaft portion 165 such that the connector coupling portion 166 rotates with the shaft portion 165. In some embodiments, at least a portion of the shaft portion 165 is substantially D-shaped and the passage extending through the connector coupling portion 166 is similarly D-shaped. Further, the connector coupling portion 166 may include a clamp on the side opposite the drive motor 162 configured to engage with the shaft portion 165 to secure the connector coupling portion 166 on the end of the shaft portion 165. While the shaft portion 165 has been described as being separate from the connector coupling portion 166, it will be understood that the shaft portion 165 may be integral with the connector coupling portion 166.

The belt drive motor 162 may be connected to or otherwise coupled with the carriage frame 134 such that the belt drive motor 162 is substantially stationary relative to the carriage frame as the belt drive motor 162 rotates the belt drive shaft 164. The belt drive motor 162 may be coupled with the carriage frame 134 by a saddle 170. In some embodiments, the saddle 170 includes a first saddle frame 172 disposed on the underside of the top wall 136 on a first side of the belt drive motor 162 and a second saddle frame 174 disposed on the underside of the top wall 136 on the opposite side of the belt drive motor 162, the first and second saddle frames 172, 174 extending between the first and second side walls 144a, 144b of the carriage frame 134. The belt drive motor 162 may be coupled with the first and second saddle frames 172, 174 such that the belt drive motor 162 is prevented from moving between the first and second edges 146a, 146b of the carriage frame 134.

The carriage frame 134 may also include a saddle bracket 176 disposed on the underside of the top wall 136 against a side of the belt drive motor 162 such that the belt drive motor 162 is disposed substantially against an inside of one of the first and second side walls 144a, 144b of the carriage frame 134. The saddle bracket 176 may substantially prevent the belt drive motor 162 from moving between the first and second side walls 144a, 144b. The saddle bracket 176 may have a cut-out such that the saddle bracket 176 is substantially U-shaped and such that the shaft portion 165 of the belt drive shaft 164 may extend through the cut-out of the saddle bracket 176. The saddle bracket 176 may be spaced apart a distance from the side wall 144a, 144b opposite the belt drive motor 162 such that the connector coupling portion 166 may rotate between the saddle bracket 176 and the side wall 144a, 144b opposite the belt drive motor 162. The saddle bracket 176 may maintain the position of the belt drive motor 162 and allow the belt drive shaft 164 to rotate between (e.g., within) the side walls 144a, 144b of the carriage frame 134 which may reduce the width of each carriage 130 and/or reduce the space between adjacent carriages 130.

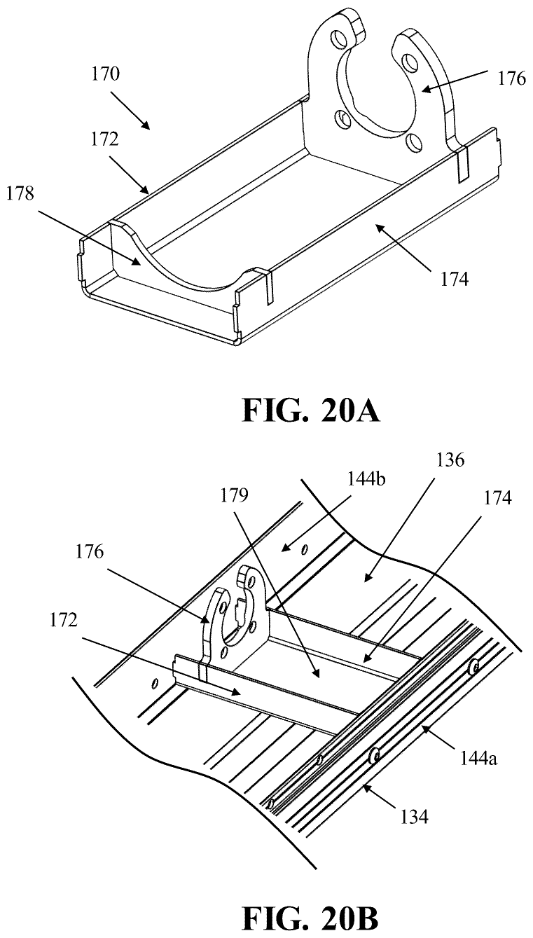

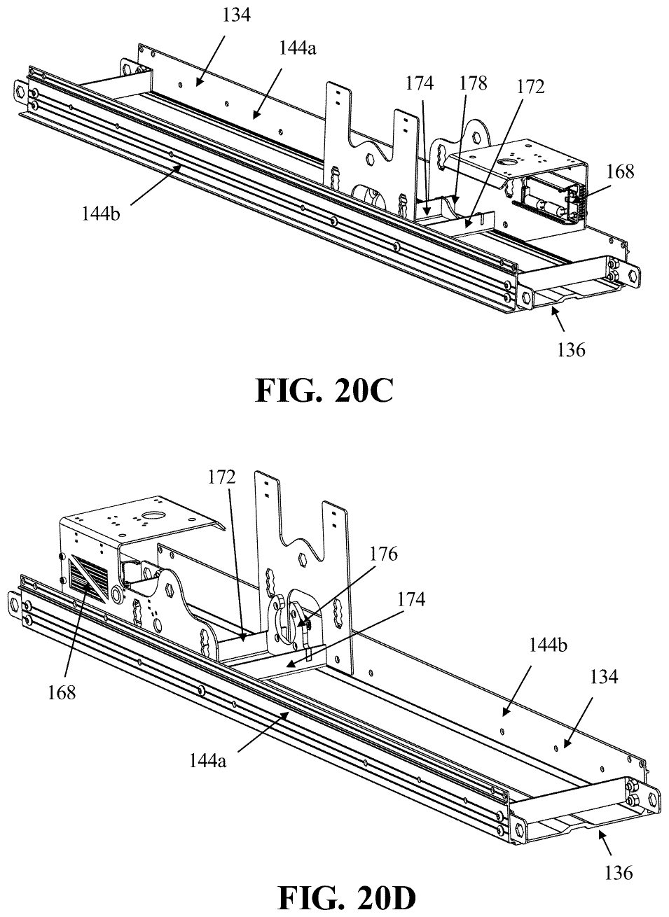

In some embodiments, the saddle 170 also includes a saddle support 178 between the first and second saddle frames 172, 174 spaced apart from the saddle bracket 176 and configured to support the belt drive motor 162 against the underside of the top wall 136 of the carriage frame 134. The saddle support 178 may be sized, shaped, and configured to conform to a top surface of the belt drive motor 162 (when the carriage 130 is in the upright position) such that the belt drive motor 162 remains substantially stationary in the carriage frame 134 when the belt drive motor 162 rotates the belt drive shaft 164. In some embodiments, a bottom of the saddle support 178 (top of the saddle support in FIG. 20A) is rounded or curved to support the rounded or curved outer surface of the belt drive motor 162.

The belt drive system 160 may also include a drive pulley 180 configured to engage with and rotate the belt 132. The drive pulley 180 is substantially cylindrical and is disposed and configured such that the drive pulley 180 may be rotated via rotation of the belt drive shaft 164. The drive pulley 180 is disposed adjacent to and in parallel with the belt drive shaft 164 the belt drive shaft 164. The drive pulley 180 is coupled with the belt drive shaft 164 via the drive connector 169 such that the drive pulley 180 rotates with the belt drive shaft 164. The drive connector 169 may have a size, shape, and configuration suitable to rotate the drive pulley 180 in the same direction (e.g., clockwise or counterclockwise) as the belt drive shaft 164. For example, as discussed above, the belt drive connector 169 may comprise a plurality of shaped or patterned teeth or ribs which may correspond to notches or receiving portions of the belt drive shaft 164 and the drive pulley 180.

Referring now to FIGS. 15-16 and 24A-25D, a drive pulley 180 for use with one of the carriages 130 is shown according to one embodiment. The drive pulley 180 is substantially cylindrical and configured to drive the belt 132 as the drive pulley 180 rotates. The drive pulley 180 has an outer surface 182 extending from near a first end 184 of the drive pulley 180 to near a second end 186, the outer surface 182 being configured to engage the inner surface 152 of the belt 132 as the belt 132 is at least partially disposed around the drive pulley 180. The drive pulley 180 also includes a pulley shaft 188 extending through a medial portion of the drive pulley 180, pulley bearings 190 disposed on each side of the pulley shaft 188 near the first and second ends 184, 186, and a drive cover 192 disposed around the pulley bearings 190 and at least partially defining the outer surface 182 of the drive pulley 180. The pulley shaft 188 of the drive pulley 180 may be attached or otherwise coupled to the carriage frame 134 such that the pulley shaft 188 is substantially stationary relative to the carriage frame 134. The pulley bearings 190 are disposed on the pulley shaft 188 near the ends 184, 186 of the drive pulley 180 (e.g., ends of the pulley shaft 188) and are configured to rotate about the pulley shaft 188. The drive cover 192 is a substantially hollow tube configured to be disposed around the pulley bearings 190 such that the drive cover 192 may rotate with and/or around the pulley bearings 190. The drive cover 192 may extend longitudinally beyond the pulley bearings 190 and the drive cover 192 may have a length substantially equivalent to the width of the belt 132. The pulley shaft 188 and the pulley bearings 190 may be sized, shaped, and configured to reduce the length of the drive pulley 180 between the first and second ends 184, 186 such that the width of the carriages 130 may be reduced, as detailed below. In some embodiments, the drive covers 192 comprise nylon, such as injunction molded nylon. In some embodiments, the drive pulleys 180 and/or the drive covers 192 are filled, such as with glass.

In some embodiments, the drive cover 192 of the drive pulley 180 includes a drive engagement portion 194 configured to rotatingly couple the drive pulley 180 with the belt drive motor 162, such as via the belt drive shaft 164 and the drive connector 169. The drive engagement portion 194 is configured such that a drive connector may be disposed at least partially around drive engagement portion 194 and at least partially around a drive shaft coupled with the carriage motor such that the drive pulley 180 rotates with rotation of the drive shaft via the drive coupler, as detailed below. The drive engagement portion 194 may include a plurality of notches, ribs, or teeth configured to engage with an inner surface of the drive connector, such as with corresponding notches, ribs, or teeth of the drive connector.

In some embodiments, the outer portions of the drive engagement portion 194 extends radially to a distance less than the outer surface 182 (e.g., are radially inset from the outer surface 182 of the drive pulley 180) such that the combined diameter of the drive engagement portion 194 and the drive connector is less than the outer diameter of the outer surface 182. For example, the outer portions of the drive engagement portion 194 are radially inset from the outer surface 182 such that the drive connector 169 may be disposed at least partially around the drive engagement portion 194 while the belt 132 is disposed around the remainder of the outer surface 182 of the drive pulley 180, as detailed below.

While the drive pulley 180 has been described as including a drive engagement portion 194 configured to at least partially engage with a drive connector to rotatingly couple the drive pulley 180 with the motor of the carriage, it will be understood that the drive pulley 180 may be rotatingly coupled with the carriage motor in other manners. For example, the drive pulley 180 may have a plurality of geared teeth extending around a circumference of the drive pulley 180, such as extending beyond the outer surface 182 of the drive pulley 180, which mesh or otherwise engage with geared teeth of the motor (or drive shaft of the motor) such that the drive pulley 180 rotates directly and oppositely with the motor (or drive shaft).

The belt drive system 160 may also include one or more tensioning pulleys 200 configured to at least partially tension or otherwise support the belt 132 such that a portion of the belt 132 is horizontally disposed above the top surface 138 of the carriage frame 134 and defines a party of the conveying surface 128 (when the carriage 130 is on the top portion of the tracks 110 and to permit the belt 132 to rotate around the carriage frame 134. The belt drive system 160 may include two tensioning pulleys 200 disposed near edges 146 of the carriage frame 134 near an upper portion of the carriage frame 134 such the belt 132 may extend along the top surface 138 of the carriage frame 134. The tensioning pulleys 200 disposed near the top surface 138 of the carriage frame 134 may be substantially cylindrical with an outer surface 202 and may have a diameter corresponding to the heights of the one or both side walls 144 of the carriage frame 134. The belt 132 may extend around a portion of the outer surface 202 of the tensioning pulley 200 near the first edge 146a, extend along the top surface 138 of the carriage frame 134, and extend around a portion of the outer surface of the tensioning pulley 200 near the second edge 146b. The tensioning pulleys 200 disposed near the first and second edges 146a, 146b may be disposed at a height such that the top of each of the tensioning pulleys 200 is substantially equal to the top surface 138 of the carriage frame 134 (e.g., such that the belt 132 is substantially level as it extends over the top surface 138 of the carriage frame 134). The tensioning pulleys 200 disposed near the top surface 138 of the carriage frame 134 may be sized, shaped, configured, and positioned such that the belt 132 is substantially taught as it extends across the top surface 138 of the carriage frame 134.

The belt drive system 160 may also include two additional tensioning pulleys 200 disposed near the drive pulley 180 and configured to direct the belt 132 from the drive pulley 180 to the tensioning pulleys 200 disposed near the top surface 138 of the carriage frame 134. The tensioning pulleys 200 near the drive pulley 180 may be substantially the same as the other tensioning pulleys 200. The belt drive system 160 may be configured such that the belt 132 extends around an outer surface of the drive pulley 180, around a portion of one of the tensioning pulleys 200 disposed near the drive pulley 180, around a portion of one of the tensioning pulleys 200 disposed near the top surface 138 of the carriage frame 134, along the top surface 138 of the carriage frame 134, around a portion the other tensioning pulley 200 disposed near the top surface 138, around a portion of the other tensioning pulley 200 disposed near the drive pulley 180, and back to the drive pulley 180. The tensioning pulleys 200 disposed near the drive pulley 180 may be disposed at a height between the drive pulley 180 and the tensioning pulleys 200 disposed near the top surface 138 of the carriage frame 134. The tensioning pulleys 200 disposed near the drive pulley 180 may be positioned on either side of the drive pulley 180 such that belt 132 is substantially horizontal as it extends between the tensioning pulleys 200 disposed near the drive pulley 180 and the tensioning pulleys 200 near the top surface 138 of the carriage frame 134. The tensioning pulleys 200 may be sized, shaped, configured, and positioned such that the belt 132 forms a T-shape around the carriage frame 134.

Referring now to FIGS. 15-16 and 26A-26B, a tensioning pulley 200 for use with one of the carriages 130 is shown according to one embodiment. The tensioning pulley 200 is substantially cylindrical and configured to provide tension to the belt 132 as the belt 132 is disposed around the carriage frame 134 and to rotate with the belt 132. The outer surface 202 of the tensioning pulley 200 extends from near a first end 204 of the tensioning pulley 200 to near a second end 206, the outer surface 202 being configured to engage either the inner surface 152 or the outer surface 150 of the belt 132 as the belt 132 is at least partially disposed around the tensioning pulley 200. The tensioning pulley 200 also includes a pulley shaft 208 extending through a medial portion of the tensioning pulley 200, pulley bearings 210 disposed on each side of the pulley shaft 208 near the first and second ends 204, 206, and a tensioning cover 212 disposed around the pulley bearings 210 and at least partially defining the outer surface 202 of the tensioning pulley 200.

The pulley shaft 208 of the tensioning pulley 200 may be attached or otherwise coupled to the carriage frame 134 such that the pulley shaft 208 is substantially stationary relative to the carriage frame 134. The pulley bearings 210 are disposed on the pulley shaft 208 near the ends 204, 206 and are configured to rotate about the pulley shaft 208. The tensioning cover 212 is a substantially hollow tube configured to be disposed around the pulley bearings 210 such that the tensioning cover 212 may rotate with and/or around the pulley bearings 210. The tensioning cover 212 may extend longitudinally beyond the pulley bearings 210 and the tensioning cover 212 may have a length substantially equivalent to the width of the belt 132. The tensioning cover 212 may be sized, shaped, and configured such that the tensioning pulley 200 (e.g., the tensioning cover 212) has a diameter smaller than a diameter of the drive pulley 180 (e.g., the drive cover 192). For example, the tensioning pulley 200 may be sized, shaped, and configured such that the belt 132 may be disposed at least partially around the tensioning pulley 200 and at least partially around the drive pulley 180 and such that the belt 132 may rotate around the tensioning pulley 200 without significant loss or torque when the belt 132 is driven by the drive pulley 180. The pulley shaft 208 and the pulley bearings 210 may be sized, shaped, and configured to reduce the length of the tensioning pulley 200 between the first and second ends 204, 206 such that the width of the carriages 130 may be reduced, as detailed below.

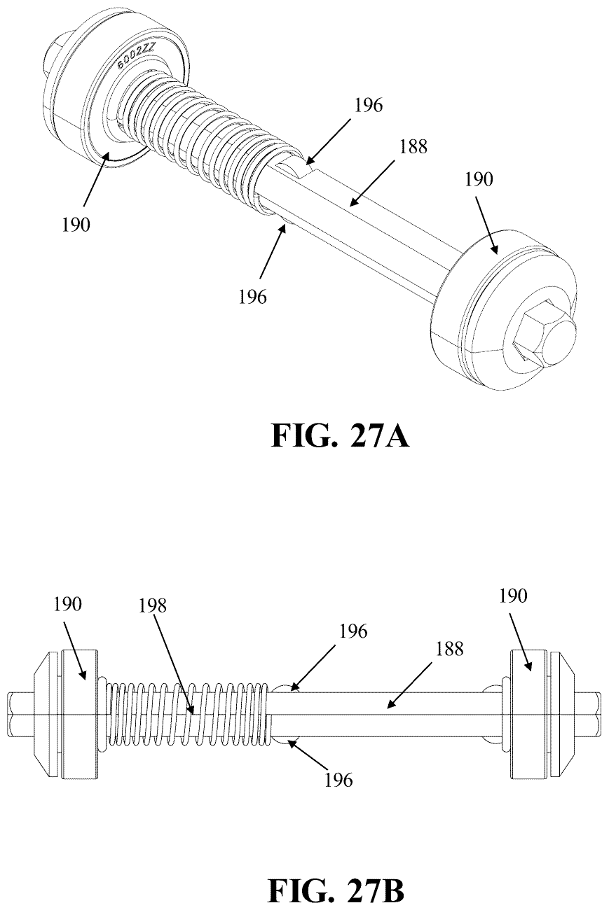

Referring now to FIGS. 27A-27B, a pulley shaft 188 and pulley bearings 190 for use with one of the drive pulleys 180. The pulley shaft 188 and the pulley bearings 190 may be used in conjunction with the drive cover 192 such that the drive pulley 180 may be coupled to and decoupled from the carriage frame 134, such as a carriage frame 134 with a reduced width. The pulley shaft 188 and pulley bearings 190 may be configured such that one end of the pulley shaft 188 may be inserted into an aperture in the carriage frame 134, the pulley shaft 188 may be pivoted, and the opposite end of the pulley shaft 188 may be inserted through an opposite aperture in the carriage frame 134. In some embodiments, the one or more pulley bearings 190 may be biased on the pulley shaft 188 such that the pivoted into and out of coupling with the carriage frame 134. The pulley shaft 188 may be configured such that the drive pulley 180 may be longer than conventional pulleys used with the same frame width such that the width of the carriage frame 134 may be reduced.

The pulley shaft 188 may include one or more first radial protrusions 196 and one or more biasing members 198. The radial protrusions 196 may protruding radially from an outer surface of the pulley shaft 188. The first radial protrusions 196 may be disposed along a medial portion of the pulley shaft 188 and the biasing member 198 may be disposed on or around the pulley shaft 188 between the first radial protrusions 196 and one of the pulley bearings 190. The first radial protrusions 196 may extend radially outwardly from the remainder of the pulley shaft 188 such that the biasing member 198 does not move beyond (e.g., over) the first radial protrusions 196 toward the other pulley bearing 190. For example, the first radial protrusions 196 may extend radially outwardly from the remainder of the pulley shaft 188 a distance greater than a radial thickness of the biasing member 198.

The biasing member 198 is movable between a biased position and an unbiased position to control the position of the adjacent pulley bearing 190 relative to the first radial protrusions 196. In the unbiased position, the biasing member 198 may extend laterally away from the first radial protrusions 196 such that the adjacent pulley bearing 190 is moved toward and/or disposed near the end of the pulley shaft 188. In the biased position, the biasing member 198 may be compressed such that the adjacent pulley bearing 190 may move laterally toward the other pulley bearing 190. The biasing member 198 may have an uncompressed length (e.g., the unbiased position) substantially corresponding to the distance between the first radial protrusions 196 and the adjacent pulley bearing 190 when the pulley bearing 190 is disposed in the desired position on the pulley shaft 188. For example, in the unbiased position, the biasing member 198 may have a length extending from the first radial protrusions 196 such that the adjacent pulley bearing 190 is disposed near the end of the pulley shaft 188.

The biasing member 198 is also compressible such that the drive pulley 180 may be inserted into and removed from the carriage frame 134 without additional tools. The end of the pulley shaft 188 near the biasing member 198 may be at least partially inserted into an aperture of the carriage frame 134, the aperture being smaller than the pulley bearings 190 such that the pulley bearing 190 does not pass through the aperture. The pulley shaft 188 may then be inserted farther through the aperture such that the adjacent pulley bearing 190 abuts the carriage frame 134 and such that the adjacent pulley bearing 190 compresses the biasing member 198 into the biased position against the first radial protrusions 196 as the pulley shaft is inserted farther through the carriage frame 134. The pulley shaft 188 may then be pivoted or angled such that the other end of the pulley shaft 188 may be aligned with and inserted into an opposite aperture in the carriage frame 134. The pulley shaft 188 may then be released such that the biasing member 198 extends to the unbiased position such that the pulley shaft 188 extends through both apertures and the pulley bearings 190 are disposed in the desired or operative positions, such as near the ends of the pulley shaft 188 and near the apertures of the carriage frame 134. The pulley shaft 188 may be removed from the carriage frame 134 in an opposite manner. While not shown, the pulley shaft 188 may include second radial protrusions extending radially outwardly from the remainder of the pulley shaft 188. The second radial protrusions may be disposed on the pulley shaft 188 to maintain the pulley bearings 190 in the operative positions. For example, the pulley shaft 188 may include one second protrusion on the side of the pulley bearing 190 adjacent to the biasing member 198 which prevents the pulley bearing 190 from moving laterally (e.g., away from the biasing member 198) beyond the operative position. The pulley shaft 188 may also include second protrusions on either side of the other pulley bearing 190 which maintain the pulley bearing in the operative position.

In the illustrated embodiment, the pulley shaft 188 includes one biasing member 198 that is a helical compression spring extending between the first radial protrusions 196 and one of the drive pulleys 180. However, it will be understood that the pulley shaft 188 may have other suitable configurations. For example, the pulley shaft 188 may be used with two or more biasing members 198 and/or the biasing member(s) 196 may be a leaf spring, a torsion spring, a variable rate spring, a flat spring, a molded spring, or the like, or any combination thereof.

While the pulley shaft 188, pulley bearings 190, first radial protrusions 196, and biasing member 198 are described as being for use with the drive pulley 180, it will be understood that the pulley shaft 188, pulley bearings 190, first radial protrusions 196, and biasing member 198 may be used with tensioning pulleys 200. Accordingly, the description of the pulley shaft 188, pulley bearings 190, first radial protrusions 196, and biasing member 198 apply equally to the tensioning pulleys 200 with the pulley shaft 208 and pulley bearings 210 being sized, shaped, and configured for use with the tensioning pulleys 200. For example, the pulley shaft 208 and/or pulley bearings 210 for use with the tensioning pulleys 200 may have a diameter smaller than the diameter of the pulley shaft 188 and pulley bearings 190 for use with the drive pulley 180. Additionally or alternatively, the tensioning covers 212 of the tensioning pulleys 200 may have a thickness and/or outer diameter less than the thickness and/or diameter of the drive cover 192 such that the outer surface 202 of the tensioning pulleys 200 has a diameter less than the diameter of the outer surface 182 of the drive pulley 180.

In some embodiments, the belt drive system 160 may be configured and disposed within each carriage 130 to reduce the width of each carriage 130. The belt drive system 160 may also be configured and disposed within each carriage 130 such that the belts 132 substantially cover the top surface 138 of the carriage 130. For example, the belt drive system 160 may be disposed substantially beneath the carriage frame 134 and the widths of components of the belt drive system 160 may be reduced such that the width of the carriage frame 134 may be reduced, such that the belts 132 may substantially define the conveying surface 128, and to allow minimal or no gaps between the carriages 130. Further, the sorter system 100 and/or the carriages 130 may be configured to provide power and command signals to the belt drive systems 160 to control the actuation of the belts 132 defining the conveying surface 128 without increasing the width of the carriage frame 134, as detailed below.

Referring now to FIGS. 11A-11E, 20C-20D, and 24A-25D, the drive pulley 180 may be rotatingly coupled with the carriage frame 134 such that the drive pulley 180 is aligned with the belt drive motor 162 and the belt drive shaft 164. The pulley shaft 188 of the drive pulley 180 may be disposed at least partially through apertures in the carriage frame 134 such that the outer surface 182 of the drive pulley 180 may rotate relative to the carriage frame 134. The drive pulley 180 may be coupled to the carriage frame 134 such that the drive pulley 180 is directly below the belt drive motor 162 and the belt drive shaft 164 (when the carriage 130 is in the upright position). The drive pulley 180 may have a width (e.g., distance extending between the first and second side walls 144a, 144b of the carriage frame 134) less than or substantially equal to the combined widths of the belt drive motor 162 and the belt drive shaft 164. The belt drive motor 162 and/or the connector coupling portion 166 of the belt drive shaft 164 may have a diameter less than or equal to a diameter of the drive pulley 180. The drive pulley 180 may be coupled with the belt drive motor 162 and the belt drive shaft 164 via the drive connector 169 such that the width of the carriage 130 may be reduced. For example, the drive pulley 180 may be coupled with the belt drive shaft 164 via the drive connector 169 at a position different than the position in which the drive pulley 180 drive the belt 132 such that the belt drive motor 162 and the belt drive shaft 164 may be disposed medially within the belt 132, as detailed below.

The belt drive motor 162, the belt drive shaft 164, and the drive pulley 180 may be sized, shaped, and configured such that the drive connector 169 is disposed substantially radially within the belt 132 when the drive connector 169 couples the belt drive shaft 164 to the drive pulley 180. For example, the belt drive motor 162, the belt drive shaft 164, the drive pulley 180, and the drive connector 169 may be sized such that the belt drive motor 162, the belt drive shaft 164, the drive pulley 180, and the drive pulley 180 do not extend longitudinally (e.g., in the travel direction of the carriage 130) beyond the belt 132 when coupled with the carriage frame 134. Additionally, the belt drive motor 162, the belt drive shaft 164, the drive pulley 180, and the drive connector 169 may be sized, shaped, and configured such that the drive pulley 180 is integrated with the belt drive motor 162 within the belt 132 (e.g., disposed within the loop of the belt 132). Further, the belt drive motor 162 and the drive belt shaft 164 may be disposed underneath the belt 132 within the carriage frame 134 and the drive pulley 180 may be configured to drive the belt 132 from a middle portion of the outer surface 182 of the drive pulley 180 (e.g., spaced from where drive engagement portion 194 of the drive pulley 180) such that the width of the carriage 130 may be reduced, as detailed below.

Each of the tensioning pulleys 200 may also be rotatingly coupled or fastened to the carriage frame 134 such that the tensioning pulley 200 may relative the carriage frame 134 as the belt 132 is actuated by the drive pulley 180. The pulley shaft 208 of each tensioning pulley 200 may be disposed at least partially through apertures in the carriage frame 134 or coupled with the carriage frame 134 via additional fasteners such that the outer surface 202 of each tensioning pulley 200 may rotate relative to the carriage frame 134. The tensioning pulleys 200 may be coupled with the carriage frame 134 in positions such that the belt 132 is substantially taught when looped around the drive pulley 180 and the tensioning pulleys 200 and such that the belt 132 is substantially horizontal along the top surface 138 of the carriage frame 134. For example, the tensioning pulleys 200 may be coupled with the carriage frame 134 such that the belt 132 is in a substantially horizontal position when one or more packages are disposed thereon and such that the belt 132 may actuate in either direction along the top surface 138 of the carriage frame 134 to move packages disposed on the belt 132.

In some embodiments, as shown in FIGS. 11A-11E and 20C-20D, the tensioning pulleys 200 disposed near the top surface 138 of the carriage frame 134 may be coupled with the first and second side walls 144 of the carriage frame 134 via U-shaped mounting brackets. The pulley shafts 208 of the tensioning pulleys 200 may be disposed at least partially through apertures in the U-shaped mounting bracket such that the outer surfaces 202 of the tensioning pulleys 200 may rotate relative to the U-shaped mounting bracket. The U-shaped mounting brackets may be coupled with carriage frame 134 such that the positions of the U-shaped mounting brackets are fixed relative to the carriage frame 134. For example, each end of the U-shaped mounting brackets may be coupled to one of the side walls 144 of the carriage frame 134 via one or more fasteners, such as screws, bolts, or nuts, via welding, or the like.

The drive pulley 180 and the tensioning pulleys 200 may be positioned and/or configured such that the width of the carriage 130 and/or the carriage belt 132 in the direction extending in the travel direction of the carriage 130 along the tracks 110 may be reduced. For example, the width of the belt 132 may be substantially equivalent to the longitudinal lengths of the outer surface 182 of drive pulley 180 and the outer surfaces 202 of the tensioning pulleys 200, and the carriage 130 may have a width substantially equal to or slightly larger than the width of the belt 132. In some embodiments, the belt drive motors 162, the belt drive shaft 164, the drive pulley 180, the drive connector 169, and the tensioning pulleys 200 (apart from the lateral outer portions of the tensioning pulleys 200 disposed near the top surface 138 of the carriage frame 134) are disposed inboard within the carriages 130, such as within the carriage frames 141, such that the belts 132 have widths substantially equal to the width of the carriages 130. As such, the carriages 130 may be disposed and aligned on the tracks 110 of the sorter system 100 such that there are minimal gaps between the belts 132.

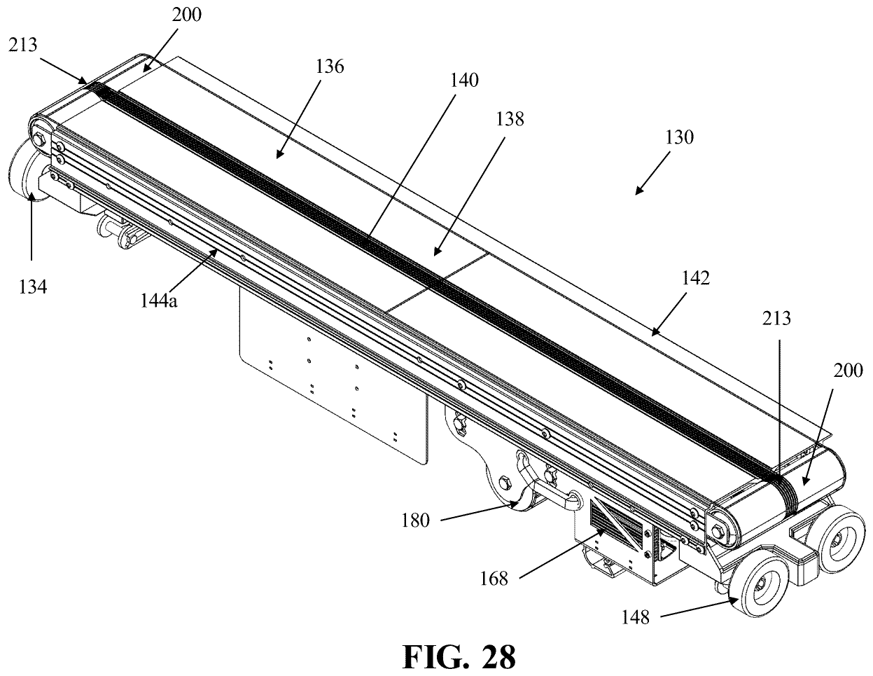

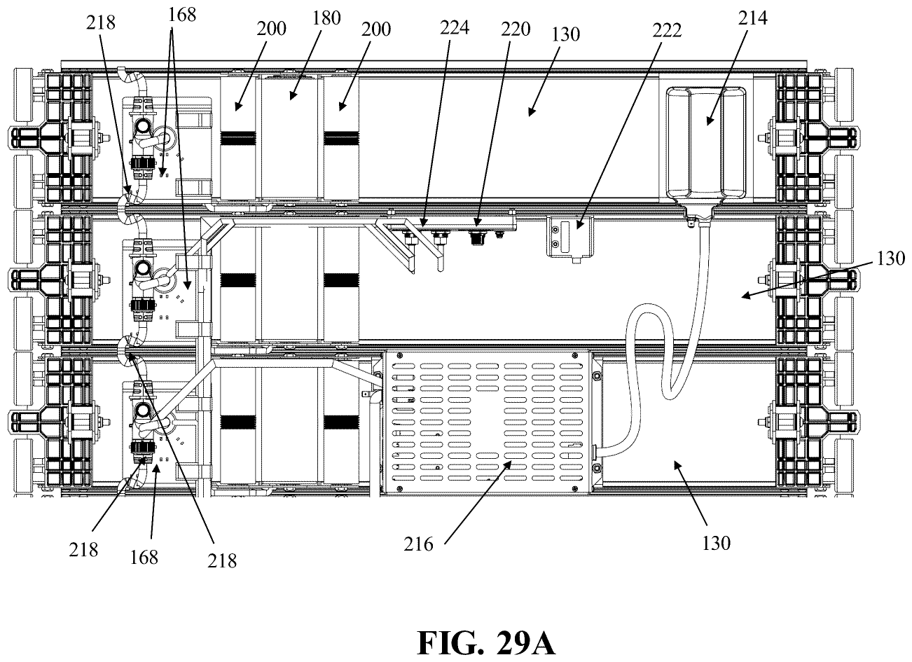

Referring now to FIGS. 12A-12B, 14A-18, 24A-26B, and 28, the belts 132, the carriage frames 134, the drive pulleys 180, and/or the tensioning pulleys 200 may be sized, shaped, and configured to reduce friction between the belt 132 and the carriage frames 134, the drive pulleys 180, and/or the tensioning pulleys 200, to drive the belt 132 from a particular portion of the belt 132, to maintain alignment of the belt 132, and/or to reduce the width of the carriages 130. The inner surface 152 of each carriage belt 132 may include a projection portion 154 configured to maintain alignment of the belt 132 on the respective carriage frame 134 and to improve the drivability of the belt 132 around the carriage frame 134. The projection portion 154 may extend radially inwardly from the remainder of the inner surface 152 of the belt 132. The projection portion 154 may be sized, shaped, and configured to correspond to a shape of the carriage frame 134 and/or a shape of the belt drive system 160, as detailed below. In some embodiments, the projection portion 154 is centered on the inner surface 152 of the belt 132 such that the belt 132 may be driven via engagement with the middle of the belt 132.

In some embodiments, the projection portion 154 includes two or more ribs 156 extending radially inwardly from the remainder of the inner surface 152 of the belt 132. The ribs 156 may be sized, shaped, and configured to increase engagement between the projection portion 154 of the belt 132 and the belt drive system 160, such as with portions of the outer surface 182 of the drive pulley 180 and the outer surface 202 of the tensioning pulley 200, as detailed below. In the illustrated embodiment, the projection portion 154 includes six V-shaped ribs 156. However, it will be understood that the projection portion 154 may include any suitable number of ribs 156 and the ribs 156 may have any suitable size, shape, or configuration.

In some embodiments, the projection portion 154 is disposed substantially in the middle of the belt 132 and covers between about 2% and about 25% of the width of the belt 132, such as between about 4% and about 10% of the width of the belt 132, such as about 5.5% of the width of the belt 132. In some embodiments, the belt 132 has a thickness of about 0.0866 inches (e.g., about 2.20 mm) In some embodiments, the projection portion 154 is about 0.33 inches with each rib 156 having a width of about 0.055 inches, a thickness of about 0.070 inches (e.g., about 1.78mm), and a pitch of about 0.092 inches (e.g., about 2.34 mm). However, it will be understood that the projection portion 154 and/or the ribs 156 may have any suitable sizes, shapes, or configurations.

In some embodiments, the top surface 138 of the carriage frame 134 includes one or more belt accommodating portion 140 configured to receive a portion of the belt 132. Each belt accommodating portion 140 may be sized, shaped, positioned, and configured to receive one of the projection portions 154 of the belt 132 as the belt 132 is rotated around the carriage frame 134. The belt accommodating portion 140 may be a recess or depression in the top wall 136 of the carriage frame 134 extending from the first edge 146a to the second edge 146b. The belt accommodating portions 140 be disposed at a height lower than the remainder of the top surface 138 of the top wall 136 when the carriage 130 is in the upright position. The belt accommodating portions 140 may extend a distance lower than the remainder of the top surface 138 of the carriage frame 134 such that the projection portion 154 remains at least partially in the belt accommodating portion 140 when the belt 132 is rotated around the carriage frame 134 and when the carriage 130 is moved around the tracks 110 of the sorter system 100. For example, the belt accommodating portion 140 may extend to a distance lower than the remainder of the top surface 138 such that the belt 132 remains aligned on the carriage frame 134 and is substantially prevented from sliding or twisting out of the belt accommodating portion 140 when the projection portion 154 is disposed in the belt accommodating portion 140.

In some embodiments, the belt accommodating portion 140 extends a distance lower than the remainder of the top surface 138 such that the inner portion of the projection portion 154 of the belt 132 does not contact the base of the belt accommodating portion 140 when the belt 132 is disposed around the carriage frame 134, such as to prevent or otherwise reduce friction between the belt 132 and the base of the belt accommodating portion 140. For example, the belt accommodating portion 140 may be sized, shaped, and configured such that the ribs 156 of the projection portion 154 may slide within the belt accommodating portion 140 without contacting the base of belt accommodating portion 140 as the belt 132 is driven in the first and/or second directions around the carriage frame 134. Further, the remainder of the top surface 138 of the carriage frame 134 and the remainder of the inner surface 152 of the belt 132 may be substantially smooth, as described above, to decrease friction between the inner surface 152 of the belt 132 and the top surface 138 of the carriage frame 134 when the belt 132 is rotated around the carriage frame 134.

In the illustrated embodiment, the belt accommodating portion 140 is a substantially flat, recessed groove extending into the top surface 138 of the carriage frame 134. The flat bottom of the belt accommodating portion 140 may allow the belt accommodating portion 140 to receive the V-shaped ribs of the projection portion 154 of the belt 132 without increasing the frictional engagement between the belt 132 and the top surface 138 of the carriage frame 134. However, it will be understood that belt accommodating portion 140 may have other suitable shapes and configurations. For example, the belt accommodating portion 140 may include a two or more grooves (e.g., near the side walls 144 of the carriage frame 134) corresponding to the size, shape, and configuration of the ribs 156 of the projection portion 154 of the belt 132 such that each rib 156 is laterally slidable within one of the grooves of the belt accommodating portion 140.

In the illustrated embodiment, the belt accommodating portion 140 is disposed substantially in the middle of the top surface 138 of the carriage frame 134. However, it will be understood that the carriages 130 may have other suitable configurations. For example, the top surface 138 of the carriage frame 134 may include two or more belt accommodating portions 140 and/or the belt accommodating portion(s) may be disposed near upstream or downstream sides of the top surface 138.

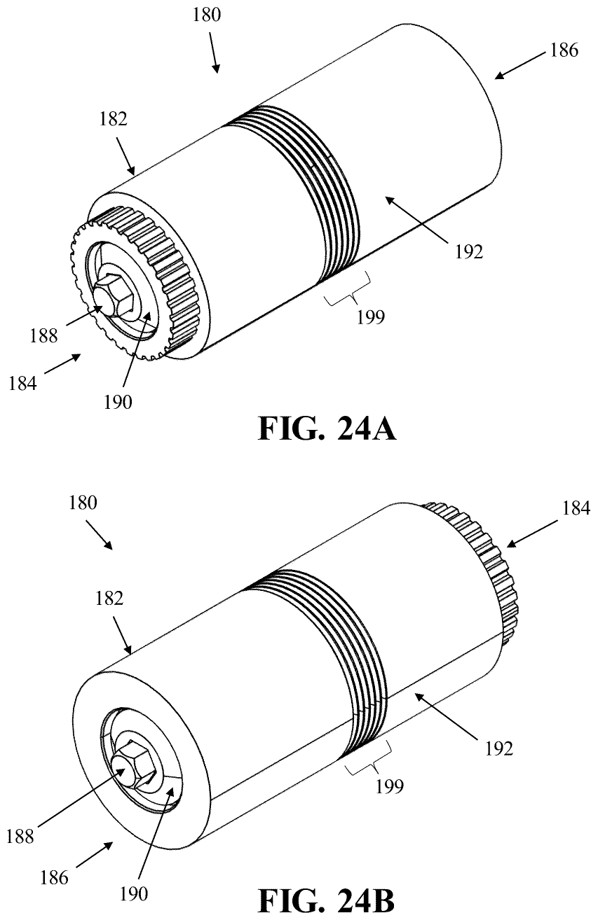

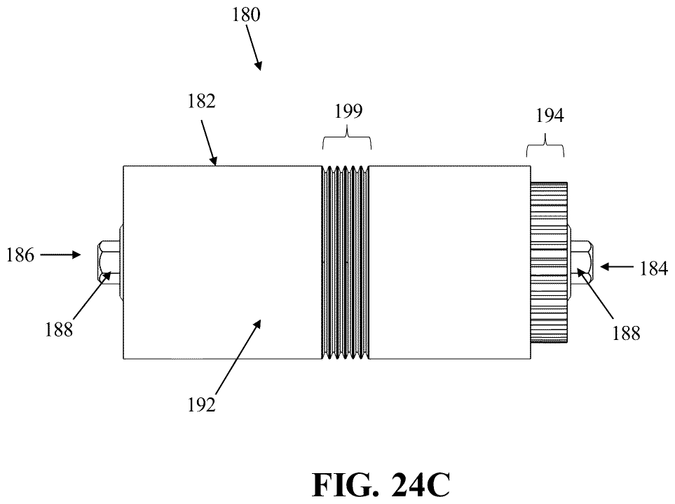

In some embodiments, as shown in FIGS. 24A-24C, the drive pulley 180 includes a belt driving portion 199 extending circumferentially around the outer surface 182 of the drive pulley 180. The belt driving portion 199 may be sized, shaped, configured, and positioned to engage with the projection portion 154 on the inner surface 152 of the belt 132 to drive rotation of the belt 132 as the drive pulley 180 is rotated via the belt drive motor 162. The belt driving portion 199 of the drive pulley 180 may be sized, shaped, positioned, and configured to correspond to the projection portions 154 of the belt 132 as the belt 132 is disposed around the carriage frame 134. In the illustrated embodiment, the drive pulley 180 includes one belt driving portion 199 disposed substantially in the middle of the outer surface 182 of the drive pulley 180. However, it will be understood that the drive pulley 180 may have other suitable configurations. For example, the drive pulley 180 may have belt driving portions 199 near the ends 184, 186 of the drive pulley 180 in embodiments where the belt 132 includes projection portions 154 disposed near the upstream and downstream ends of the belt 132.

The belt driving portions 199 of the drive pulleys 180 may be sized, shaped, and configured to engage with the projection portions 154 of the belts 132. The belt driving portions 199 of the drive pulleys 180 may sufficiently engage with the projection portions 154 of the belts 132 such that the engagement of the belt driving portions 199 with the projection portions 154 may drive rotation of the belt 132 around the carriage frame 134 as the drive pulley 180 is rotated. The remainder of the outer surface 182 of the drive pulley 180 and/or the remainder of the inner surface 152 of the belt 132 (e.g., not the projection portion 154 of the inner surface 152) may be configured such that the belt 132 rotates smoothly (e.g., with reduced friction) around the remainder of the outer surface 182 of the drive pulley 180 and such that the belt 132 is driven primarily via engagement between the projection portion 154 of the belt 132 and the belt driving portion 199 of the drive pulley 180.

The drive pulley 180 may be sized, shaped, and configured such that the belt driving portion 199 is spaced apart from the drive engagement portion 194 along the outer surface 182 of the drive pulley 180 such that the drive pulley 180 may be driven at a first location via engagement of the drive connector 169 with the drive engagement portion 194 and such that the drive pulley 180 may drive the belt 132 at a second location via engagement of the belt driving portion 199 and the projection portion 154 of the belt 132. The first location may be substantially at one end of the drive pulley 180 and the second location may substantially correspond to a middle of the drive pulley 180 and the belt 132. Driving the belt 132 via the belt driving portion 199 of the drive pulley 180, such as along a center portion of the belt 132, may reduce the amount of energy or torque required to actuate the belt 132, may reduce the width of the belt drive system 160, and/or may retain the alignment of the belt 132 relative to the carriage frame 134 as the belt 132 is actuated. For example, the belt drive motor 162 may operated with less torque as the drive pulley 180 only substantially engages with the belt 132 via the projection portion 154 with the remainder of the inner surface 152 of the belt 132 slidingly smoothly over the remainder of the outer surface 182 of the drive pulley 180 such that the remainder of the inner surface 152 of the belt 132 need not contact the outer surface 182 of the drive pulley 180. Further, as the belt 132 is driven primarily by engagement of the belt driving portion 199 of the drive pulley 180 and the projection portion 154 of the belt 132, the drive connector 169 may be disposed around the drive engagement portion 194 of the drive pulley 180 to drive rotation of the drive pulley 180 without interfering with the belt 132. For example, as the belt 132 may be driven primarily via engagement of the belt driving portion 199 and the projection portion 154 such that the remainder of the inner surface 152 of the belt 132 need not contact the outer surface 182 of the drive pulley 180, the belt driving portions 199 of the drive pulley 180 may be disposed beneath the belt 132 (e.g., below one of the sides of the belt 132), instead of extending longitudinally beyond an edge of the belt 132, without causing the belt 132 to substantially rotate or twist during operation. Accordingly, the width of the carriage frame 134 may be reduced as the drive connector 169 may be disposed radially within the belt 132 instead of longitudinally (e.g., upstream or downstream) beyond an edge of the belt 132.

In some embodiments, the belt driving portions 199 of the drive pulley 180 include a plurality of grooves corresponding to the ribs 156 of the projection portions 154 of the belts 132. The grooves of the belt driving portions 199 are sized, shaped, and configured such that the ribs 156 of the projection portions 154 may be received in the grooves of the belt driving portions 199 and such that rotation of the drive pulley 180 drives rotation of the belt 132 via engagement of the ribs 156 with the grooves of the belt driving portion 199. For example, the grooves of the belt driving portions 199 may have an increased coefficient, such as via texturing, coating, and/or materials, such that the grooves engage the ribs 156 of the projection portion 154 and drive rotation of the belt 132 around the carriage frame 134 as the drive pulley 180 is rotated. In some embodiments, the grooves of the belt driving portions 199 are substantially V-shaped to correspond with the V-shape of the ribs 156 of the projection portions 154 of the belts 132.

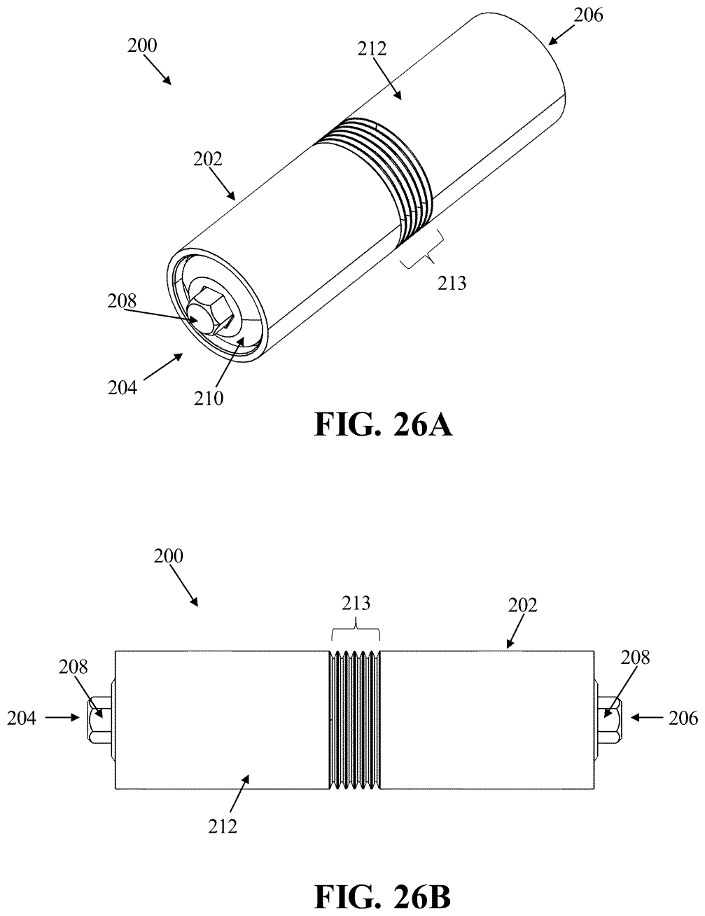

As shown in FIGS. 26A-26B, one or more of the tensioning pulleys 200 may also include a belt receiving portion 213 extending circumferentially around the outer surface 202 of tensioning pulley 200. The belt receiving portions 213 may be sized, shaped, configured, and positioned to engage with or otherwise receive the projection portions of the belts 132. The belt receiving portions 213 may be sized, shaped, positioned, and configured substantially equivalently to the belt driving portion 199 of the drive pulley 180. For example, the belt receiving portions 213 may be disposed in the middle of the outer circumferences of the tensioning pulleys 200 and include a plurality of grooves configured to engage with the ribs 156 of the projection portions 154 of the belts 132. The belt receiving portions 213 are configured to engage with or otherwise accommodate the projection portion 154 of the belt 132, such as the ribs 156 of the projection portion 154, as the belt 132 is rotated around the carriage frame 134, such as to maintain the position and alignment of the belt 132 as the belt 132 is rotated around the carriage frame 134.

In the illustrated embodiment, each of the tensioning pulleys 200 includes a belt receiving portion 213. However, it will be understood that the belt drive system 160 may have other configurations. For example, only the tensioning pulleys 200 disposed near the first and second edges 146a, 146b of the carriage frame 134 may include belt receiving portions 213.

The projection portion 154 of the belt 132, the belt driving portion 199 of the drive pulley 180, and the belt receiving portions 213 of the tensioning pulleys 200 may stabilize the belt 132 in relation to the carriage frame 134, may improve the efficiency of operating the carriage 130, may reduce the width of the carriage 130, and/or may reduce the cost of operating the sorter system 100. For example, the disposition of the projection portion 154 of the belt 132 in the belt driving portion 199 of the drive pulley 180 and the belt receiving portions 213 of the tensioning pulleys 200 may maintain the alignment of the belt 132 relative to the carriage frame 134 (e.g., centering the belt 132 on the carriage frame), such as by preventing the belt 132 from twisting on the carriage frame 134. Additionally, the disposition of the projection portion 154 of the belt 132 in the belt driving portion 199 of the drive pulley 180 may allow the drive pulley 180 via the projection portion 154 of the belt 132 to reduce the torque or energy to rotate the belt 132 and/or reduce the friction of the belt 132 around the pulleys 180, 200, such as by allowing portions of the inner surface 152 of the belt 132 with lower coefficients of friction (e.g., portions other than the projection portion 154) to slide over portions of the outer surfaces 182, 202 of the pulleys 180, 200 with lower coefficients of friction (e.g., portions other than the belt driving portion 199 or belt receiving portions 213). Driving the belt 132 from the middle of the belt 132 and/or pulleys 180, 200 may also permit the belt drive motor 162, the belt drive shaft 164, and the drive connector 169 to be disposed laterally (e.g., recessed within) within the belt 132 such that the width of the belt drive system 160 and the overall width of the carriage frame 134 may be reduced, as discussed above. For example, the projection portion 154 of the belt 132 may be disposed along a center of the belt 132 and comprise a plurality of V-shaped ribs 156 which engage with the grooves of the belt driving portion 199 of the drive pulley 180 (with the projection portion 154 also slidably disposed in the belt accommodating portion 140 of the carriage frame 134) to drive rotation of the belt 132 and the remainder of the of the inner surface 152 of the belt 132 may be a smooth fabric which slides over the outer surfaces 182, 202 of the pulleys 180, 200 and the top surface 138 of the carriage frame 134 to drive the belt 132 on center, to reduce frictional forces on the rotating belt 132, and to reduce the torque required to drive the belt 132.

The carriage frames 134 and belts 132 may be sized, shaped, and configured to decrease the size (e.g., height) of the sorter system 100, to increase the density of packages which may be acceptably sorted via the sorter system 100, allow the sorter system 100 to be used with smaller packages, and/or to increase the precision of the sorter system 100. In some embodiments, the carriages 130 are sized, shaped, and configured to increase the number of carriages 130 which may be disposed on the tracks 110, such as to increase the number of carriages 130 that define the conveying surface 128. For example, the widths of the carriage frames 134 and the carriage belts 132 may be reduced such that the carriages 130 may be rotated from the top portion of the tracks 110 to the bottom portion of the tracks 110 about a tighter turn radius such that the height of the curved portions of the tracks 110 and the overall height of the sorter system 100 may be reduced. Decreasing the height of the sorter system 100 may decrease the overall size and cost of the sorter system 100, may make the conveying surface 128 more accessible to users, and/or may allow the sorter system 100 to be implemented in locations with reduced space. Decreasing the widths of the carriages 130 may also allow the sorter system 100 to be used in conjunction with smaller packages.

Additionally, decreasing the widths of the carriages 130 may increase the precision of the sorter system 100, such as by decreasing the number of packages which are longitudinally spaced on each carriage belt 132 and increasing the acceptable package density (e.g., density of packages on the conveying surface 128) for use with the sorter system 100, as detailed below. Narrower carriages 130 may reduce the chances that two packages will be disposed at least partially on the same belt 132. Accordingly, with narrower carriages 130, it may be less likely that the actuation of one or more belts 132 to move a package on the conveying surface 128 also moves another package as it is less likely that multiple packages will be disposed on the same belt 132. Further, decreasing the widths of the carriages 130 may increase the precision and/or control of the sorter system 100, such as by allowing for more precise movement of packages and/or by allowing the sorter system 100 to be used with greater densities of packages., as detailed below.

In some embodiments, the carriage frames 134 have a width extending between the side walls 144 between about 4 inches and about 12 inches, such as between about 5 inches and about 8 inches, such as about 6 inches. In some embodiments, the carriage belts 132 have a width between about 4 inches and about 12 inches, such as between about 5 inches and about 8 inches, such as about 6 inches.

While the belt drive system 160 has been described as being used with the carriages 130 of the sorter system 100, it will be understood that the belt drive system 160 or portions thereof may be used in other configurations and/or systems. For example, the belt drive system 160 or components thereof, such as the belt 132 (e.g., with the projection portion 154), the belt drive motor 162, the belt drive shaft 164, the drive pulley 180, and/or the tensioning pulleys 200, may be used in other conveyor systems, such as belt-driven driven horizontal conveyors, belt-driven vertical conveyors, belt-driven alignment conveyors (e.g., belts driven orthogonally to a conveying direction to align and/or rotate packages), belt-driven singulators, or the like.

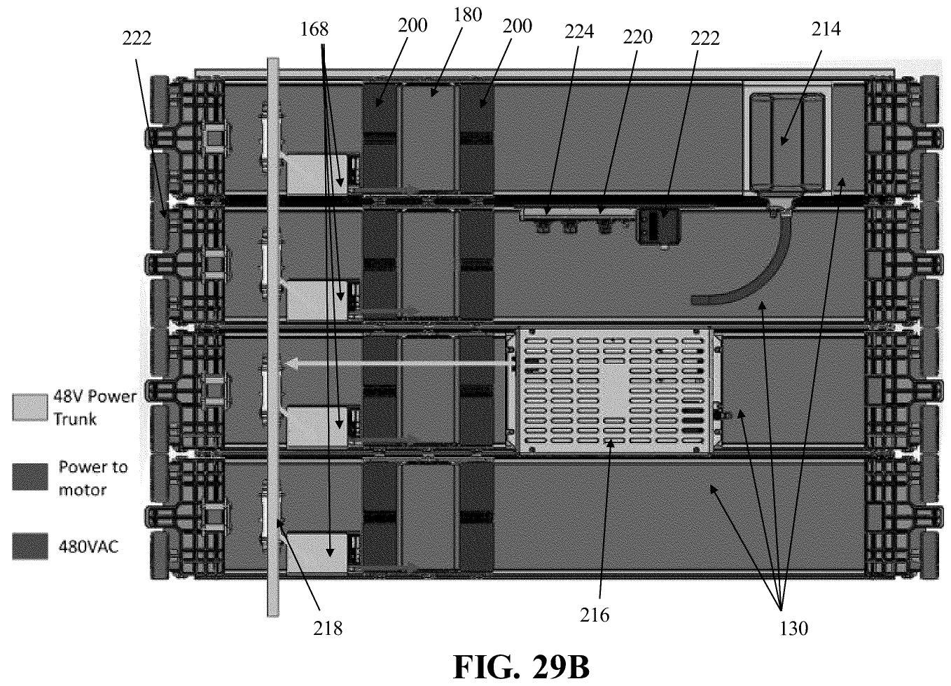

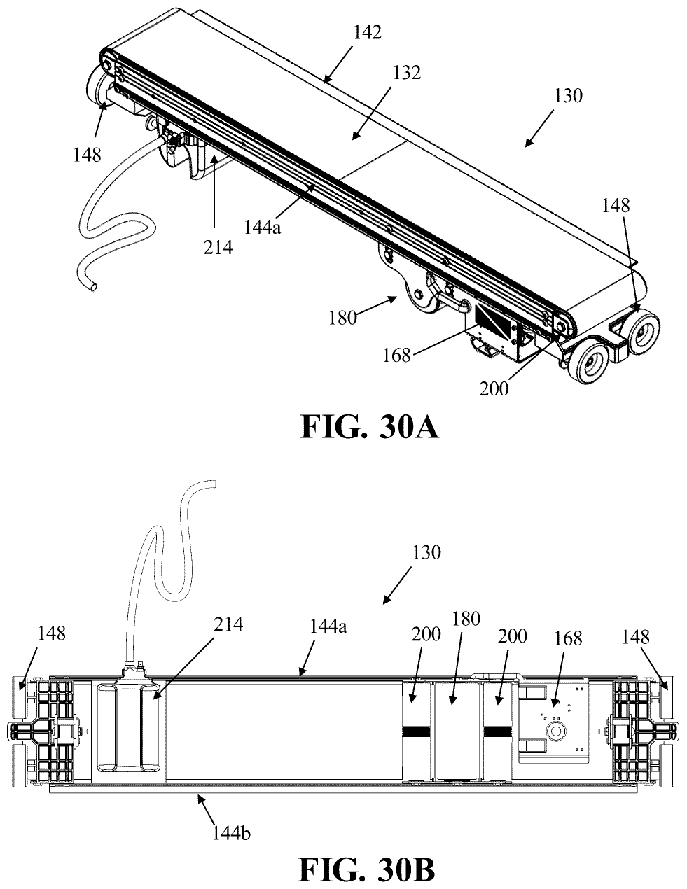

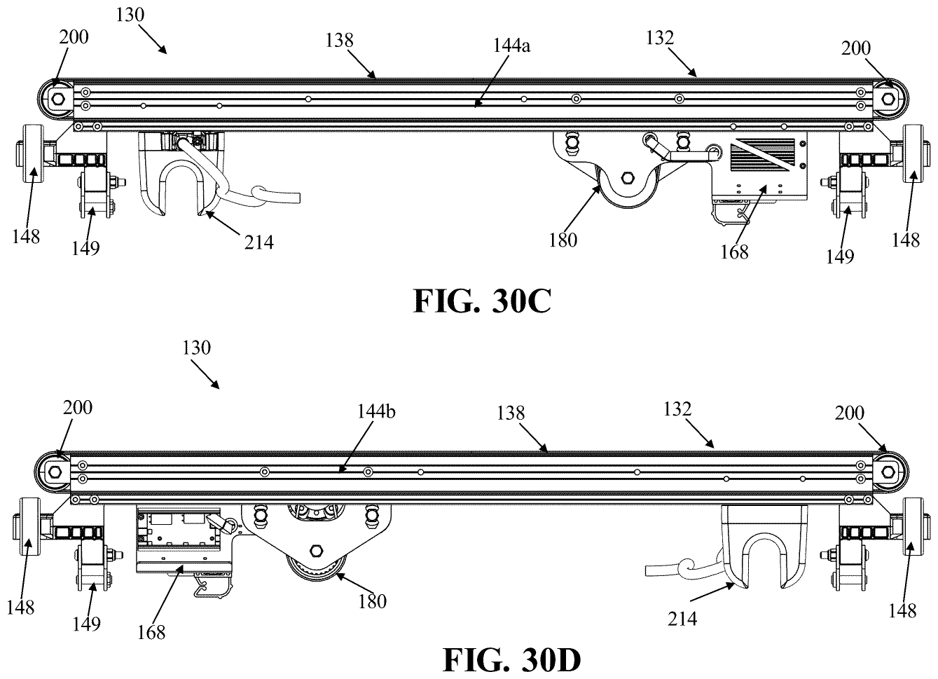

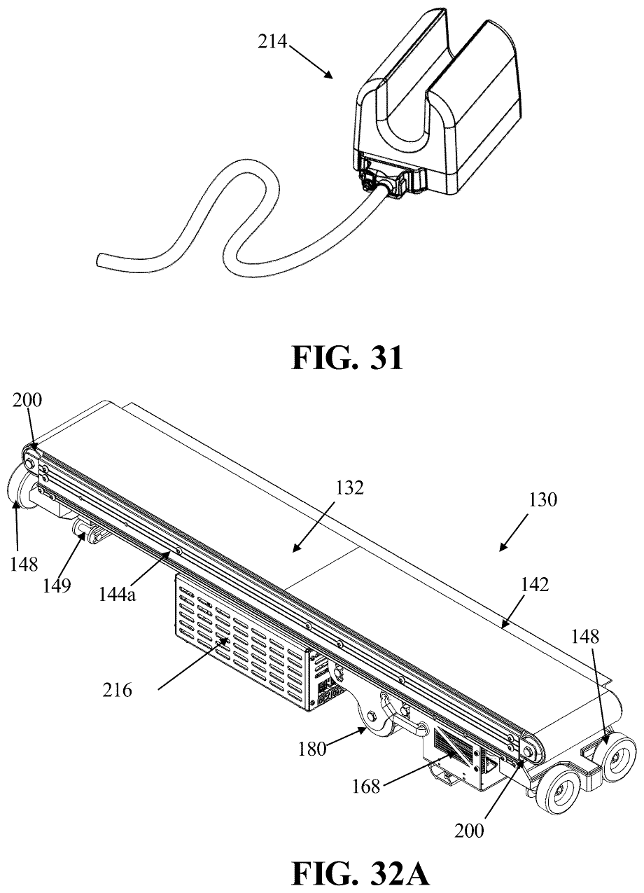

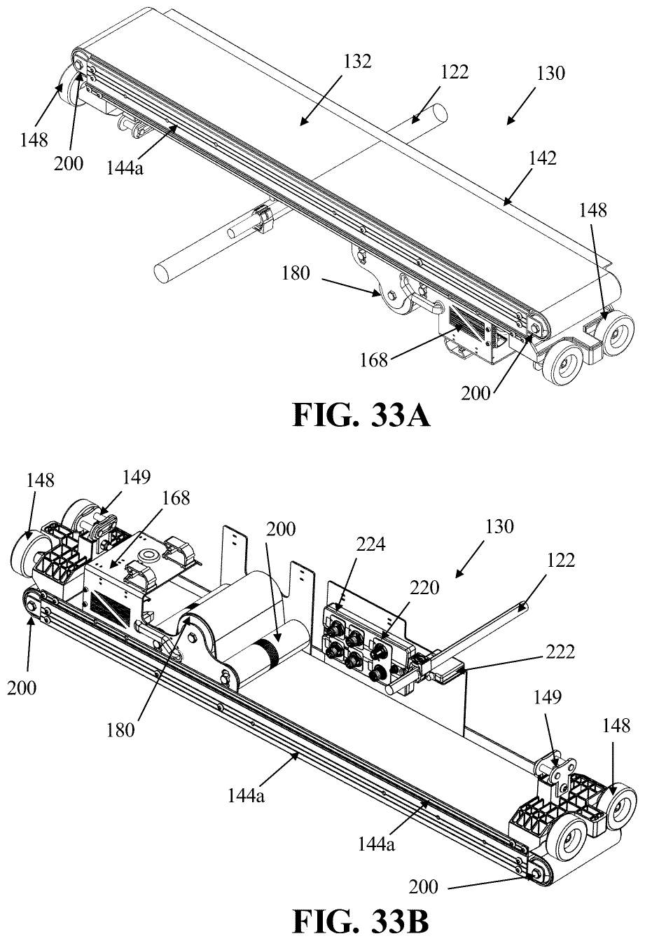

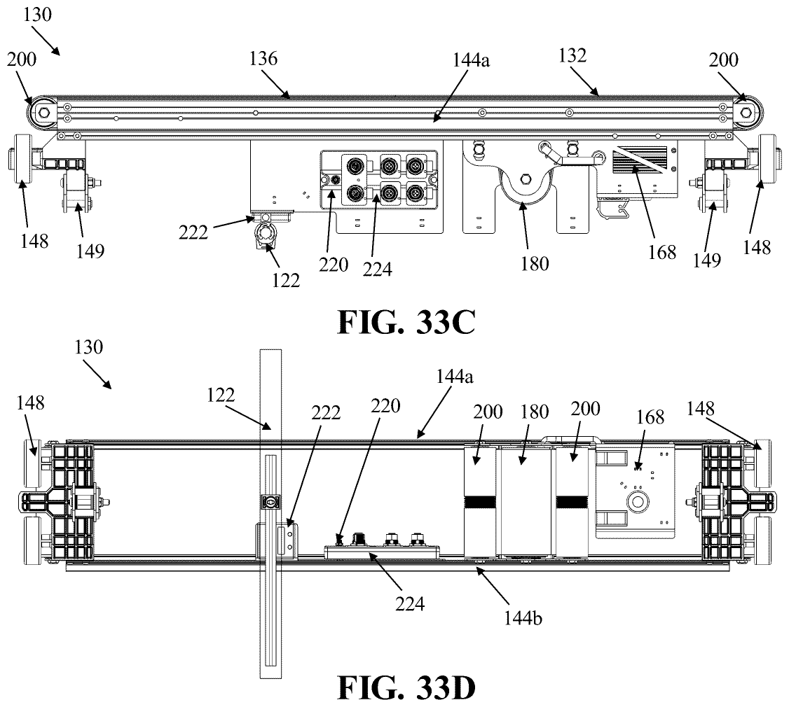

Referring now FIGS. 29A-35B, power and control signals may be provided to one or more of the carriages 130, such as to selective control the actuation of the belts 132 of the carriages 130. The power may be provided to the carriages 130 such that each of the carriages 130 defining the conveying surface 128 may be actuated as the carriages 130 travel around the tracks 110. The control signals may be provided to the carriages 130 such that each of the drive controllers 168 may control actuation of the respective belts 132 to control the position, location, and/or orientation of the packages disposed on the conveying surface 128 as the carriages 130 travel around the tracks 110. In some embodiments, power is provided to one or more carriages 130 and subsequently provided to one or more adjacent or neighboring carriages 130. In some embodiments, control signals are received by one or more carriages 130 and control signals are subsequently transmitted to one or more adjacent or neighboring carriages 130.

Referring now to FIGS. 29A-31, one or more of the carriages 130 in the sorter system 100 may include a power receiver 214 configured to receive power from the sorter power line 120 such that the power may be provided to one or more carriages 130 to actuate the belts 132 of the respective carriages 130. The power receiver 214 may be sized, shaped, configured, and positioned on the carriage frame 134 to contact the sorter power line 120 to receive power from the sorter power line 120. For example, the power receiver 214 may be disposed on an underside of the carriage frame 134 such that the power receiver 214 at least partially surrounds the sorter power line 120. The power receiver 214 may contact the sorter power line 120 when the respective carriage 130 is disposed on the top portion of the tracks 110 such that power may be transferred from the sorter power line 120 to the drive controllers 168 of one or more carriages 130 disposed on the top portion of the tracks 110 to actuate the respective belts 132. In the illustrated embodiment, the power receiver 214 is substantially U-shaped such that the power receiver 214 may be disposed on top of and on both sides of the sorter power line 120 as the carriage 130 travels along the top portion of the tracks 110. In some embodiments, the power receiver 214 is configured to receive about 480 V of alternating current (AC) from the sorter power line 120.

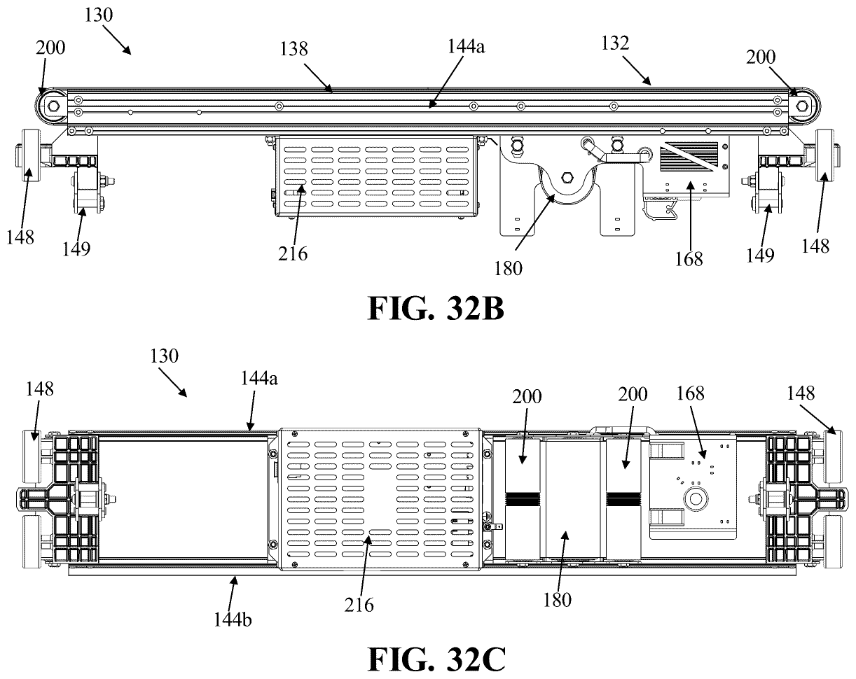

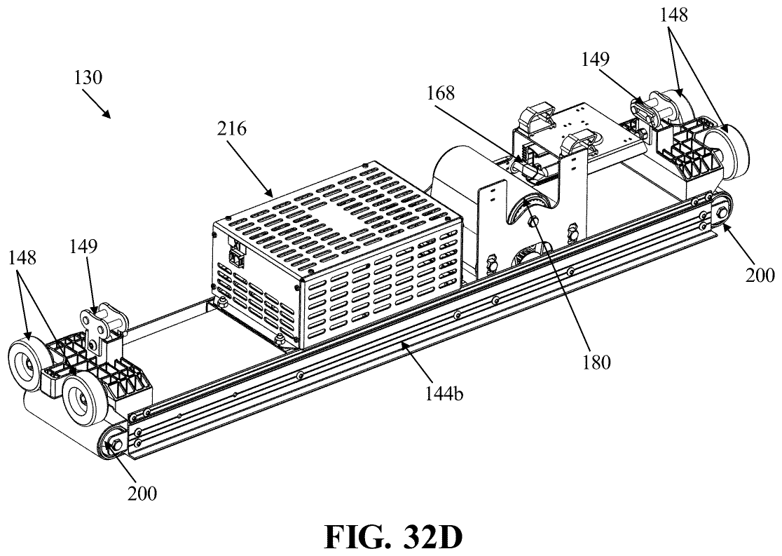

Referring now to FIGS. 29A-29B and 32A-32D, one or more of the carriages 130 may include a regulator 216 configured to distribute power such that the power may be received by one or more carriages 130 to actuate the respective belts 132. The regulator 216 may be coupled with the power receiver 214 via a wire or cable such that the regulator 216 may receive power from the power receiver 214. The regulator 216 may also be coupled with a carriage power line 218 coupled with one or more carriages 130 such that the regulator 216 may provide power to the carriages 130 coupled with the carriage power line 218.

The carriage power line 218 may be one or more wires coupling the carriages 130 in a section or group of two or more carriages 130. The carriages 130 in the sorter system 100 may be divided into one or more sections of carriages 130 such that each power receiver 214 and regulator 216 pair may provide power to two or more carriages 130 in the section. The size of (e.g., number of carriages 130 in) each section may be configured to reduce the number of components (e.g., power receivers 214 and regulators 216) in the sorter system 100, to divide weight within/around the sorter system 100, and/or to increase the control of the sorter system 100. In some embodiments, the sorter system 100 includes sections of six carriages 130 and includes one power receiver 214 and one regulator 216 for every section of carriages 130. However, it will be understood that the sorter system 100 may have other suitable configurations. For example, the sorter system 100 may include one power receiver 214 and one regulator 216 for every section of two to five carriages 130, for every section of seven of more carriages 130, or for the entire sorter system 100.

The carriage power line 218 may be coupled with the drive controller 168 of each carriage 130 in the section. The carriage power line 218 may be configured to provide power from the regulator 216 to the drive controller 168 and/or the belt drive motor 162 of each carriage 130 in the section. The carriage power line 218 may be relatively stationary relative to the carriages 130 in the section such that the carriage power line 218 moves with the carriages 130 as the carriages 130 in the section travel around the tracks 110 of the sorter system 100. In some embodiments, the carriage power line 218 is a single trunk line coupled with the regulator 216 and branching off to the drive controller 168 and/or the belt drive motor 162 of each carriage 130 in the section. In other embodiments, the carriage power line 218 includes a plurality of wires or cables coupling the regulator 216 with the drive controllers 168 and/or belt drive motor 162 of the carriages 130 in the section.

In some embodiments, the regulator 216 is configured to convert power between AC and DC current such that the belt drive motors 162 coupled with the regulator 216 via the carriage power line 218 may actuate the respective belt 132. The regulator 216 may be configured to receive AC power from the power receiver 214, convert the AC power to DC power, and provide the DC power to the carriage power line 218. In some embodiments, the regulator 216 receives power at about 480 V AC from the power receiver 214 and provides about 48 V DC power to the carriage power line 218.

In some embodiments, the carriages 130 with the power receivers 214 may be spaced apart from the carriages 130 with the regulators 216, such as to more evenly distribute weight within the sorter system 100. In the illustrated embodiment, the carriage 130 with the power receiver 214 is spaced apart from the carriage 130 with the regulator 216 with one carriage 130 in between. However, it will be understood that the sorter system 100 may have other suitable configurations. For example, the power receiver 214 and the regulator 216 may be disposed on a single carriage 130 or the carriage 130 with the power receiver 214 may be spaced apart from the carriage 130 with the regulator 216 by two or more carriages 130.

Referring now to FIGS. 29A-29B and 33A-34, one or more of the carriages 130 may include a carriage controller system 220 with one or more antennas 222 and a carriage controller 224. The carriage controller system 220 is configured to receive one or more command signals via the antennas 222 and output one or more command signals to one or more carriages 130 via the carriage controller 224. The sorter system 100 may include one carriage controller system 220 for every section of carriages 130 and the carriage controller system 220 may be configured to receive command signals, such as from the control line 122, and to output one or more command signals to control the operation of one or more carriages 130 within the section of carriages 130. The carriages 130 of the sorter system 100 may be divided or sub-divided into sections of adjacent carriages 130 such that the sorter system 100 includes two or more sections of carriages 130 disposed around the tracks 110. Each section of carriages 130 includes one or more carriages 130 with a carriage controller system 220 configured to control operations of each of the carriages 130 in the section. The carriage 130 with the carriage controller system 220 may be in data communication with the other carriages 130 in the section of carriages 130 such that the carriage 130 with the carriage controller system 220 acts as a master carriage for the carriages 130 in the section of carriages 130. The inclusion of a master carriage 130 configured to control the operation of multiple carriages 130 may reduce the components of the sorter system 100, reduce the cost of the sorter system 100, and/or reduce the overall size of the sorter system 100.

The antennas 222 may be configured to receive one or more command signals from the sorter system controller 240 via the control line 122. In some embodiments, each antenna 222 is configured to wireless receive command signals from the sorter system controller 240 that are wireless transmitted or radiated along the length of the control line 122. The antennas 222 may be sized, shaped, configured, and positioned on the carriages 130 such that the antennas 222 are disposed near the control line 122 when the carriages 130 move along a portion of the tracks 110. For example, the antennas 222 may be positioned on an underside of the carriage frames 134 such that the antennas 222 are disposed near the control line 122 when the carriage 130 upon which the antenna 222 is disposed is on the top portion of the tracks 110. In the illustrated embodiment, each carriage controller 224 includes one antenna 222. However, it will be understood that each carriage controller system 220 may have any suitable number of antennas 222.

Each antenna 222 may be configured to wireless receive signals, such as command signals, from the control line 122 while the antenna 222 travels along a length of the control line 122. In some embodiments, the control line 122 transmits command signals via radio frequencies and the antennas 222 are radio antennas configured to receive radio signals. In some embodiments, the antenna 222 is a near field antenna which is configured to wirelessly receive control signals transmitted or radiated along the length of the control line 122. However, it will be understood that antennas 222 may be any suitable receivers configured to receive signals from the sorter system controller 240 and/or the control line 122. While the carriage controller system 220 has been described as including one antenna 222 configured to receive command signals transmitted along the length of the control line 122, it will be understood that the carriage controller system 220 may have other suitable configurations. For example, each carriage controller system 220 may include one or more receivers configured to receive command signals from the sorter system controller 240 and/or the control line 122 via short-range cellular, infrared, WiFi, radio, ultraband, Bluetooth, or ZigBee transmissions.

The carriage controller 224 includes a processor 226 and a memory 228 in data communication with each other. The carriage controller 224 is configured to receive the signals, such as command signals, received by the antenna 222, generate one or more command signals, and transmit the command signals to one or more drive controllers 168, such as the drive controller 168 of each carriage 130 in the section of carriages 130. The carriage controller 224 may be disposed on the carriage frame 134 near the antenna 222 and may be coupled with the antenna 222 via a cable or wire configured to transmit signals from the antenna 222 to the carriage controller 224. The carriage controller 224 may be coupled with one or more drive controllers 168 such that the carriage controller 224 may output command signals which cause the drive controllers 168 to actuate the belt 132 of the respective carriage 130. Each carriage controller 224 may be coupled with the drive controllers 168 of each carriage 130 in a section of carriages 130. The section of carriages 130 coupled with each carriage controller 224 may correspond to the section of carriages 130 coupled with each regulator 216. For example, each section of carriages 130 may comprise six carriages 130 and each section of carriages 130 may include one power receiver 214, one regulator 216, and one carriage controller system 220. The carriage controller 224 may also be configured to receive signals output from the drive controllers 168 coupled with the carriage controller 224.

The carriage controller 224 may receive the command signals received by the antenna 222 as input and generate one or more command signals to control the drive controller 168 of one or more carriages 130 in the respective section of carriages 130. The carriage controller 224 may generate the one or more command signals based upon the signals received by the antenna 222 to control the operations of the drive controllers 168 coupled with the carriage controller 224. The carriage controller 224 may generate command signals for each of the drive controllers 168 in the section which cause the drive controller 168 to control the operation of respective belt drive motor 162, such as to control the direction, speed, and amount (e.g., distance) that each belt drive motor 162 actuates (e.g., rotates) each belt 132. For example, the carriage controller 224 may parse the command signals received by the antenna 222 into separate command signals for each drive controller 168 coupled with the carriage controller 224. The carriage controller 224 may then transmit the command signals to each of the drive controllers 168 to control the actuation of each belt 132 in the section of carriages 130.

In the illustrated embodiment, the carriage controller 224 is disposed on the same carriage 130 as the antenna 222 and the carriage controller 224 is coupled with six drive controllers 168 (including the drive controller 168 of the carriage 130 upon which the carriage controller 224 is disposed). However, it will be understood that the sorter system 100 may have other suitable configurations. For example, the carriage controller 224 may be disposed on a different carriage 130 from the antenna 222 and/or the carriage controller 224 may be coupled with the drive controllers 168 of a different number of carriages 130.

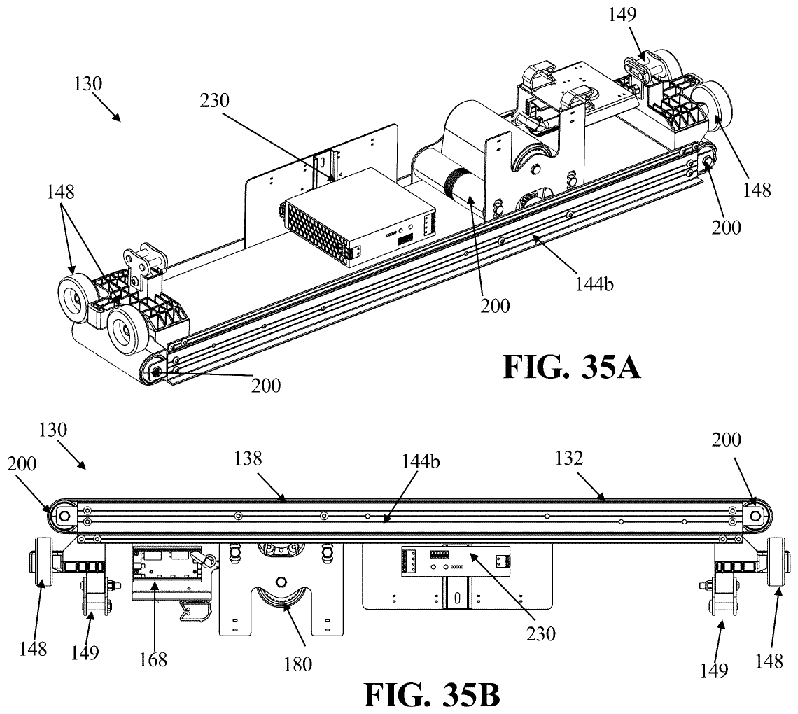

Referring now to FIGS. 35A-35B, one or more of the carriages 130 in the sorter system 100 may include a converter 230 configured to provide power to one or more of the carriage controller systems 220, such as to the carriage controllers 224 and/or the antennas 222. Each converter 230 may be configured to receive power at a first power level, convert the received power to a second power level, and provide power at the second power level to one or more carriage controller systems 220 such that the carriage controller systems 220 may operate. In some embodiments, the converter 230 is coupled with the carriage power line 218, such as via a wire or cable, such that the converter 230 may receive power from the carriage power line 218 and is coupled with one of the carriage controller systems 220, such as via another wire or cable, to provide converted power to the coupled carriage controller system 220. Subsequent carriage controller systems 220 may be coupled in sequence with the carriage controller system 220 coupled with the converter 230, such as via one or more wires or cables in a daisy chain configuration, such that the converted power to the coupled carriage controller system 220 may be distributed amongst the other carriage controller systems 220. In some embodiments, the converter 230 is configured to receive power at about 48V from the carriage power line 218 and to output power at about 24V to the coupled carriage controller system 220.

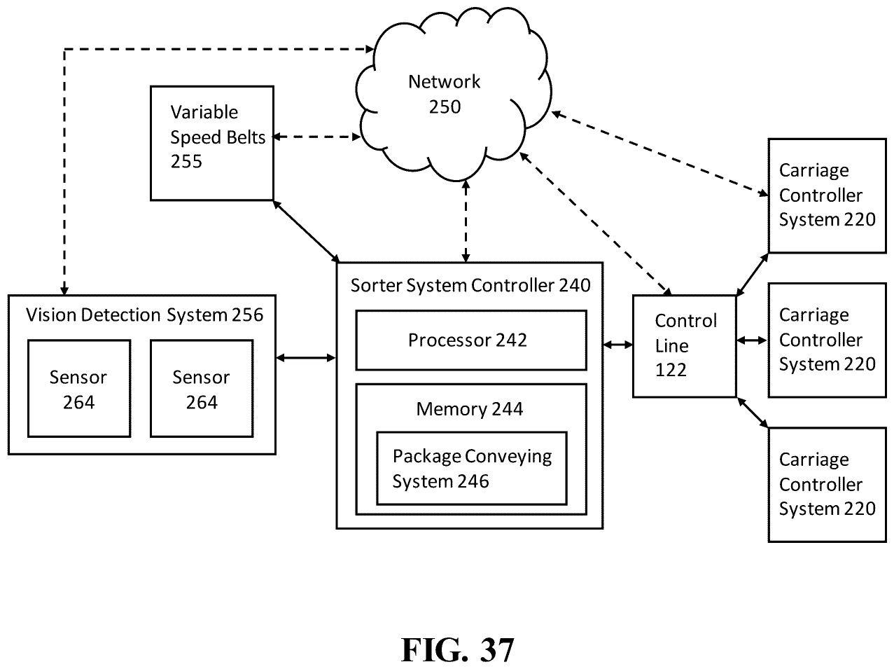

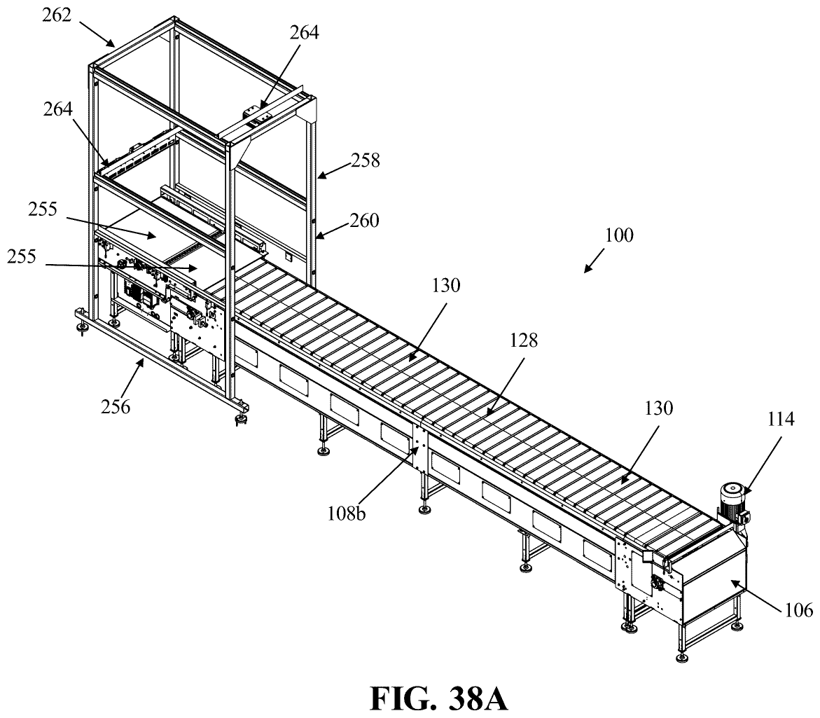

Referring now to FIGS. 1, 34, and 37, the sorter system controller 240 may include at least one processor 242 that executes instructions that are stored in a memory 244. Specifically, the memory 244 includes a package conveying system 246 that is configured to generate one or more command outputs to control actuation of the belts 132 of one or more carriages 130. The package conveying system 246 may be configured to generate command outputs based on the identity, position, location, size, and/or orientation of packages being conveyed onto the conveying surface 128 and/or packages disposed on the conveying surface 128. For example, the package conveying system 246 may generate an output which causes one or more belts 132 to rotate or otherwise move such that one or more packages on the conveying surface 128 are directed or moved into one of the chutes or into one of the receptacles. In some embodiments, the package conveying system 246 is configured to identify packages on or upstream of the conveying surface 128 and/or to determine the position, location, size, and/or orientation of packages on or upstream of the conveying surface 128. In some embodiments, the package conveying system 246 is coupled with one or more additional systems and/or sensors configured to generate outputs indicative of packages on or upstream of the conveying surface 128 such that the package conveying system 246 may identify the packages and/or determine the position, location, size, and/or orientation of the packages. The sorter system controller 240 may also include or be otherwise coupled with a storage 248 in data communication with the processor 242 and/or memory 244, and which includes information related to the packages, such as the destination chute or receptacle of each of the packages based upon a shipping location of the package. In some embodiments, the storage 248 includes information related to the weights, sizes, and/or destination locations of the packages.

The sorter system controller 240 may be configured to output one or more command signals to the control line 122 such that the command signals may be received by one or more carriages 130 and such that actuation of one or more belts 132 may be controlled, as described above. The sorter system controller 240 may be configured to generate output commands to the control line 122 based upon the identity and position, location, size, and/or orientation of the packages on the conveying surfaces 128 such that one or more drive controllers 168 actuate the respective belt drive motors 162, thereby rotating one or more belts 132 defining the conveying surface 128 in the first and/or second directions.

In some embodiments, the sorter system controller 240 is configured to assign and/or apply a carriage section identifying tag or label and/or a carriage identifying tag or label to each of the command signals such that the command signals may be received by the desired drive controller 168. The sorter system controller 240 may transmit the command signals with the identifying tags or labels via the control line 122 such that each carriage controller system 220 may receive the command signals corresponding to the respective section of carriages 130. For example, the antenna 222 of each carriage controller system 220 may be configured to receive command signals with identifying tags or labels corresponding to the respective section of carriages 130 and/or the carriage controller 224 may be configured to parse command signals with identifying information not corresponding to the respective section of carriages 130. In some embodiments, the sorter system controller 240 is configured to generate and transmit a control signals via the control line 122 such that the control signals may be received by the desired section of carriages 130 and the desired carriage 130, such as via time division multiplexing (TDMA). However, it will be understood that the control signals may be sent in other manners via the control line 122 such that the control signals may be received by the desired section of carriages 130 and the desired carriage 130. For example, the sorter system controller 240 may be configured to modulate the power level, amplitude, phase, timing, etc., such as via pulse modulated signals, of signals sent via the control line to encode which section of carriages 130 and/or which section of carriages 130 and/or which carriages 130 the control signals are destined for.

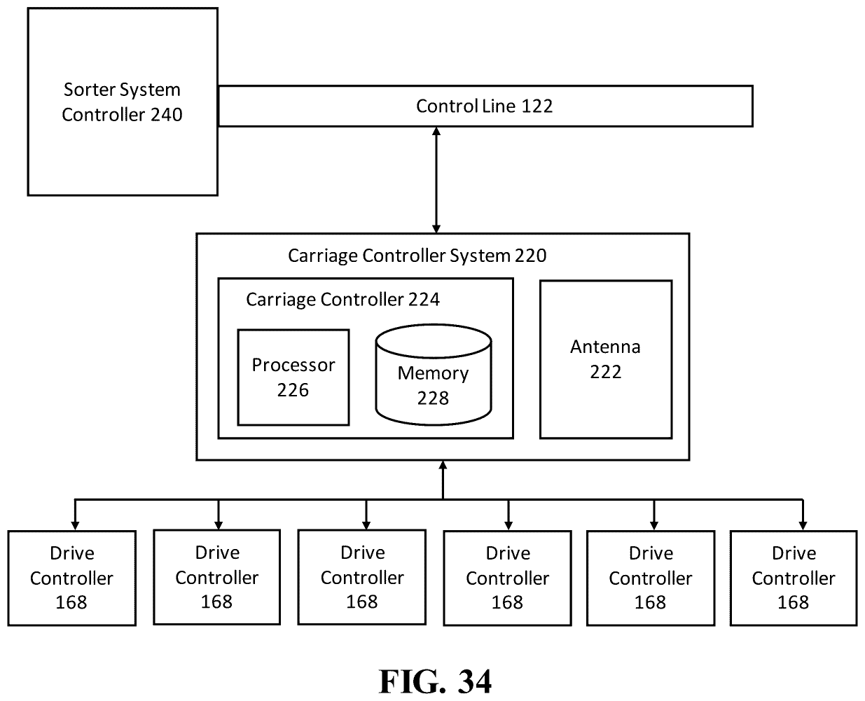

As shown in FIG. 34, the carriage controller system 220 may then transmit command signals to the desired drive controllers 168 based upon the command signals received by the antenna 222. For example, the or the carriage controller system 220 may selectively transmit the command signals to the drive controller 168 corresponding to the carriage identifying information and/or the drive controllers 168 may be configured to actuate the respective belt drive motor 162 based upon the carriage identifying tag or label or encoding contained in the command signal transmitted by the sorter system controller 240. The drive controllers 168 may then control the operation of the respective belt drive motor 162 to actuate the respective belt 132 based upon the command signal generated by the sorter system controller 240.

While illustrated as a single system, it is to be understood that the sorter system controller 240 may be a distributed system. Thus, for instance, several devices may be in communication by way of a network connection and may collectively perform tasks described as being performed by the sorter system controller 240.

The sorter system controller 240 can be a central processing unit (CPU), a graphical processing unit (GPU), a field programmable gate array (FRGA), or any suitable combination of such devices. Further, the sorter system controller 240 may implement a neural network which may be any suitable type of neural network, including a convolutional neural network, a deep neural network, a recurrent neural network, a graph neural network, etc.

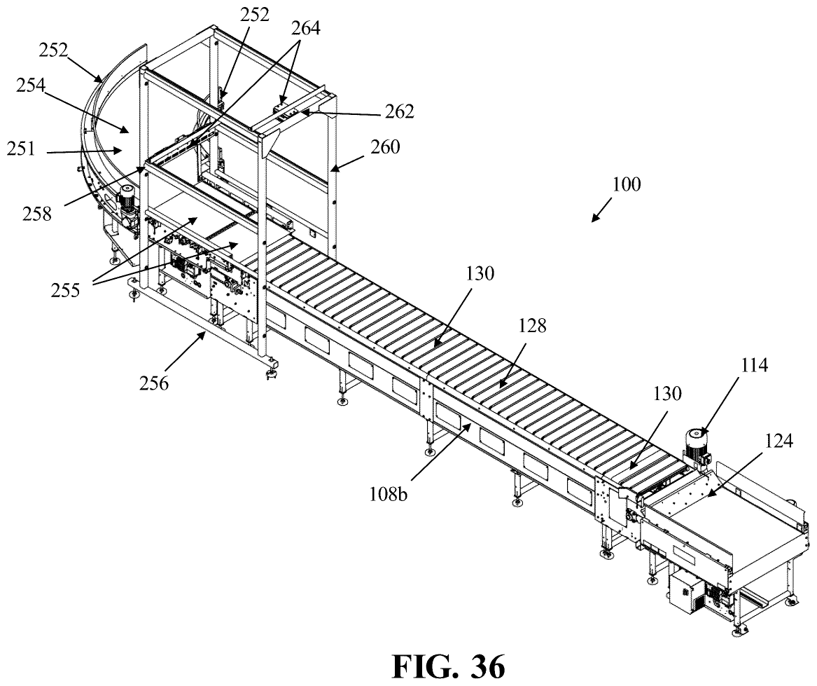

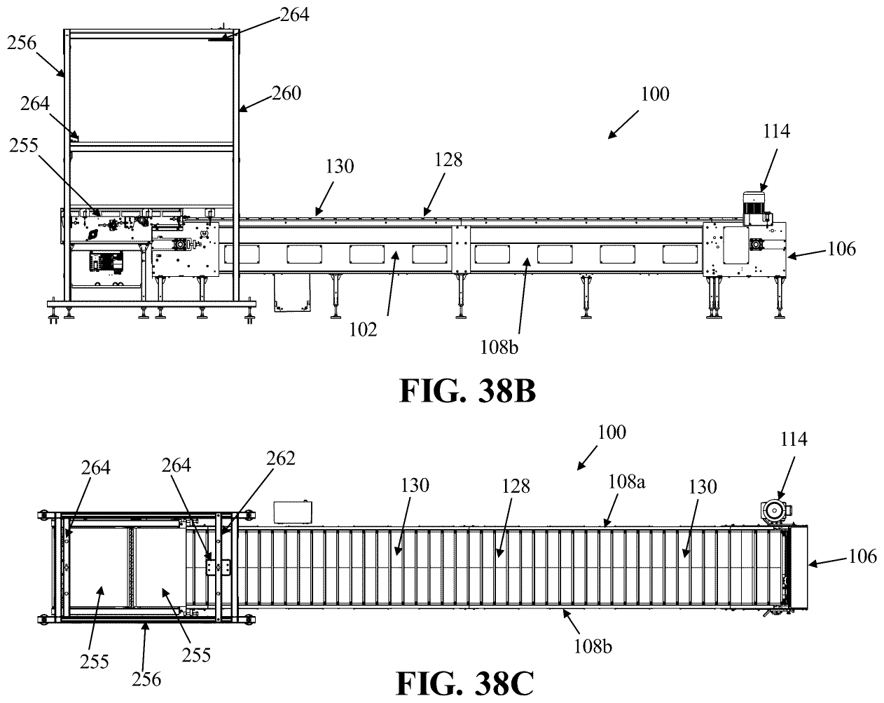

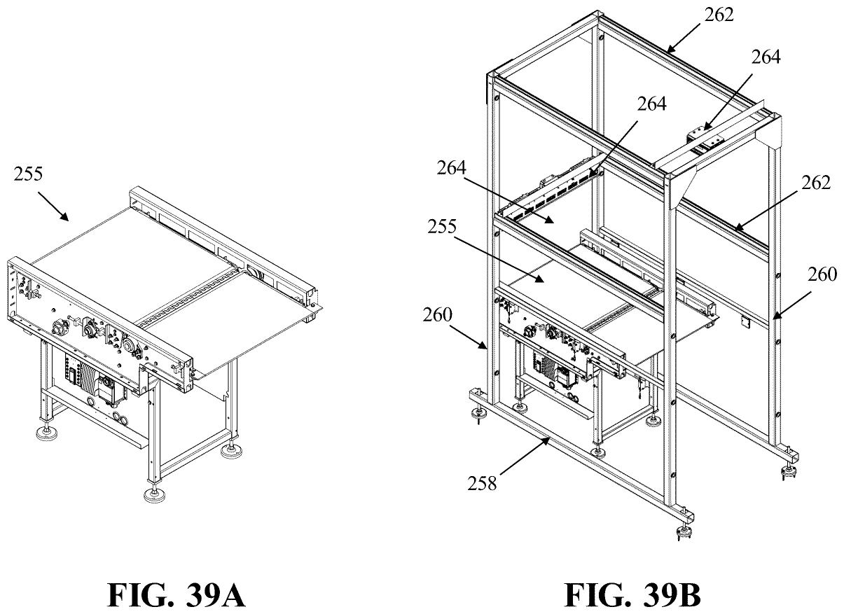

Referring now to FIGS. 36-39B, the sorter system 100 may include or be used in conjunction with one or more other conveyors or systems, such as to improve the operation of the sorter system 100. As shown in FIG. 36, the sorter system 100 may include or be used in conjunction with an input conveyor 251 configured to convey packages onto the conveying surface 128 of the sorter system 100. The input conveyor 251 may include input frame members 252 on both sides of the input conveyor 251 and define an input conveying surface 254 between the input frame members 252. The input frame members 252 may extend to a height above the input conveying surface 254 such that packages on the input conveying surface 254 do not fall over the sides of the input conveyor 251. The input conveyor 251 may receive packages at an upstream location and convey the packages downstream toward the conveying surface 128 of the sorter system 100. In the illustrated embodiment, the input conveyor 251 is curved. However, it will be understood that the input conveyor 251 may be any suitable size, shape, or configuration.

In some embodiments, the input conveyor 251 includes one or more variable speed belts 255 configured to control the rate and/or spacing of packages conveyed onto the conveying surface 128 of the sorter system 100. Each variable speed belt 255 may be a continuous belt coupled with a drive and one or more pulleys configured to rotate the variable speed belt 255 substantially in line the conveyance direction of the conveying surface 128. The variable speed belts 255 may be disposed upstream of the conveying surface 128 of the sorter system 100 and the speeds of each of the variable speed belts 255 may be controlled (e.g., adjusted) via the sorter system controller 240 to control the rate at which packages are conveyed onto the conveying surface 128 of the sorter system 100, such as to reduce the number of packages disposed on any of the carriages 130 of the sorter system 100. The variable speed belts 255 may be controlled to create gaps between packages disposed on the conveying surface 128 and/or such that packages are disposed on separate carriages 130 on the conveying surface 128. In some embodiments, the sorter system controller 240 is configured to generate and transmit one or more output commands which cause the variable speed belts 255 to be driven at variable speeds, such as to control the conveyance of packages onto the conveying surface 128. For example, based upon the flow of packages conveyed from the input conveyor 251 toward the conveying surface 128, the sorter system controller 240 may generate command outputs to control the speeds of the variable speed belts 255 to control the rate and/or spacing of packages conveyed onto the conveying surface 128 of the sorter system 100.

In the illustrated embodiment, the input conveyor 251 includes two variable speed belts 255 disposed in series. The two variable speed belts 255 may be operated independently, such as being driven by separate drives, to operate at different speeds. Each variable speed belt 255 has a width substantially equal to the width of the conveying surface 128 of the sorter system 100 such that packages are conveyed from the input conveyor 251 onto the upstream variable speed belt 255, onto the downstream variable speed belt 255, and onto the conveying surface 128 of the sorter system 100. In some embodiments, the upstream variable speed belt 255 may be operably driven at a lower rate to provide and the downstream variable speed belt 255 may be operably driven in bursts of higher speeds to speed packages onto the conveying surface 128 of the sorter system 100, such as to prevent or otherwise reduce the likelihood of multiple packages being disposed on the same carriage 130. However, it will be understood that the variable speed belts 255 may be operated in any suitable manner to control the rate and/or spacing of packages conveyed onto the conveying surface 128 of the sorter system 100.

While the sorter system 100 has been described as being used in conjunction with two variable speed belts 255, it will be understood that the sorter system 100 may be used with other numbers of variable speed belts 255. For example, the sorter system 100 may be used with one variable speed belt 255 or three or more variable speed belts 255. Further, while the sorter system 100 has been described as being used with variable speed belts 255 to control the rate and/or spacing of packages conveyed onto the conveying surface 128, it will be understood that the rate and/or spacing of packages conveyed onto the conveying surface 128 may be controlled in other manners. For example, the sorter system 100 may be used in conjunction with rollers driven at variable speeds, with skewed rollers or belts, skate wheels driven at variable speeds, or the like, or any combination thereof to control the rate and/or spacing of packages conveyed onto the conveying surface 128.

In some embodiments, as shown in FIGS. 36-39B, the sorter system 100 may include a vision detection system 256 configured to detect and/or identify packages disposed on the input conveyor 251 and/or on an upstream portion of the conveying surface 128. The vision detection system 256 may include frame 258 disposed at least partially above the input conveying surface 254 of the input conveyor 251 and/or the conveying surface 128 of the sorter system 100. The frame 258 of the vision detection system 256 may include one or more vertical frame supports 260 and one or more horizontal frame supports 262. In some embodiments, the vision detection system 256 is disposed at least partially above the variable speed belts 255 and at least partially above an upstream portion of the conveying surface 128 of the sorter system 100.

The vision detection system 256 may include one or more sensors 264 configured to generate one or more outputs indicative of the packages disposed on the input conveyor 251, on the variable speed belts 255, and/or on at least an upstream portion of the conveying surface 128. The sensors 264 may be any type of sensors configured to generate an output indicative of the position, size, number, identity, and/or orientation of packages disposed on the input conveyor 251, on the variable speed belts 255, and/or on at least an upstream portion of the conveying surface 128. For example, the sensors 264 may include one or more light sensors, bar-code readers, QR code readers, 2D cameras, 3D cameras, or the like, or any combination thereof. In some embodiments, the vision detection system 256 includes an array bridge comprising a plurality of sensors 264 configured to sense packages from a plurality of positions and angles to generate outputs indicative of the size, shape, orientation, location, and position of packages being conveyed onto the conveying surface 128 and/or of packages disposed on an upstream portion of the conveying surface 128, such as 2D or 3D images or maps of the packages. The vision detection system 256 may be in data communication with the sorter system controller 240, either directly or via one or more networks 250, such that the sorter system controller 240 may receive the outputs of the sensors 264 as input. The sorter system controller 240 may be configured to generate one or more output commands based upon the outputs of the sensors 264 of the vision detection system 256 to control the sorting, position, location, and/or orientation of packages on the conveying surface 128, as detailed below.

In some embodiments, the sensors 264 of the vision detection system 256 are configured to generate an output indicative of the volumetric sizes of packages being conveyed onto the conveying surface 128 and/or of packages disposed on an upstream portion of the conveying surface 128. In some embodiments, the vision detection system 256 may be used in conjunction with one or more scales disposed in the input conveyor 251 and configured to generate an output indicative of the weights of the packages to be conveyed onto the conveying surface 128 of the sorter system 100 and/or barcodes and/or QR codes on the packages may include identifying information and/or metadata relating to the weight of the packages, destination locations of the packages, and the like. For example, the sensors 264 of the vision detection system 256 may be configured to generate an output indicative of identifying information of the packages, such as package labels, barcodes, or QR codes, and the storage 248 and/or memory 244 may contain information corresponding to the packages, such as the destination location and/or weight of the packages, such that the sorter system controller 240 may generate one or more command signals to control operation of the carriages 130 based upon the identifying information, as detailed below.

The outputs of the sensors 264 (and the scales) may be provided as input to the sorter system controller 240 and the sorter system controller 240 may be configured to generate an output indicative of the destination, position, size, number, identity, orientation, and/or weight of packages disposed on the input conveyor 251, on the variable speed belts 255, and/or on at least an upstream portion of the conveying surface 128. For example, the sorter system controller 240 may be configured to generate a 2D or 3D map of known positions, sizes, and orientations of packages being conveyed onto the sorter system 100. The sorter system controller 240 may also be configured to control an operation of the sorter system 100 based upon the known positions, sizes, and orientations of packages, as detailed below. In some embodiments, the sorter system controller 240 is configured to generate output commands to control the speeds of the variable speed belts 255 to control the rate and/or spacing of packages conveyed onto the conveying surface 128, such as to prevent or otherwise reduce the likelihood of multiple packages being disposed on the same carriage 130.

While the sorter system 100 has been described as being used in conjunction with one vision detection system 256, it will be understood that the sorter system 100 may have other suitable configurations. For example, the sorter system 100 may be used in conjunction with two or more vision detection systems 256 and/or the sorter system 100 may include or be used in conjunction with additional sensors 264, such as sensors 264 disposed along the input conveyor 251, the variable speed belts 255, along at least a portion of the length of the conveying surface 128, and/or near or on the chutes 124.

In some embodiments, the sorter system 100 is configured to control position and/or orientation of packages disposed on the conveying surface 128 of the sorter system 100. The sorter system controller 240 may be configured to generate command signals to actuate one or more carriages 130 to rotate packages on the conveying surface 128, such as to orient the package to reduce the number of carriages 130 upon which the packages are disposed and/or the number of packages which are disposed on a single carriage 130. The sorter system controller 240 may generate output commands to actuate the carriages 130 based upon the outputs of the vision detection system 256, such as the known destinations, positions, sizes, and orientations of the packages conveyed onto the conveying surface 128. For example, the sorter system controller 240 may generate one or more output commands which cause adjacent carriages 130 to rotate at different rates and/or in different directions, such that packages disposed on the carriages 130 rotate or otherwise move. The sorter system controller 240 may cause the carriages 130 to rotate such that packages are aligned on the conveying surface 128, such as to reduce the profile of the packages on the conveying surface 128 and/or the number of carriages 130 on which packages are disposed, and/or to align packages to reduce the longitudinal overlap of packages on the conveying surface 128, such as to reduce the number of packages disposed on the same carriages 130. For example, when a package is disposed on two or more carriages 130, the sorter system controller 240 may generate command signals to cause one or more carriages 130 supporting the downstream end of the package to actuate their respective belts 132 in a first direction and to cause one or more carriages 130 supporting the upstream end of the package to actuate their respective belts 132 in an opposite direction to twist the package on the conveying surface 128.

The sorter system controller 240 may also be configured to generate command signals to actuate one or more carriages 130 to align or otherwise position packages on the conveying surface 128, such as to pre-position the packages for conveyance off the conveying surface 128. The sorter system controller 240 may be configured to generate command signals to actuate one or more carriages 130 to position packages on the conveying surface 128 to prepare the packages for conveyance off the conveying surface 128. For example, the sorter system controller 240 may generate command signals to actuate one or more carriages 130 to position packages on the side of the conveying surface 128 corresponding to the destination of the package (e.g., the side of the conveying surface 128 corresponding to the destination chute 124).

The sorter system controller 240 may also be configured to control the timing of actuation of one or more carriages 130 to control the conveyance of packages off the conveying surface 128, such as into one of the chutes 124. For example, when a package is disposed on multiple carriages 130, the sorter system controller 240 may generate output commands which first actuate the downstream supporting carriages 130 and then the other supporting carriages 130 such that the package is rotated (e.g., twisted or slid) into the destination chute 124. By pre-staging packages near the sides of the conveying surface 128, the distance each carriage belt 132 may need to be actuated to divert the package may be reduced and/or the time to divert the packages may be reduced.

In some embodiments, the sorter system 100 is configured to control the conveyance of packages off the conveying surface 128, such as to one of the chutes 124 disposed on one of the sides of the conveying surface 128. The sorter system controller 240 may be configured to control the rate of actuation (e.g., speed) of the belts 132 of one or more carriages 130 to convey packages off the conveying surface 128, such as to increase the safety of the sorter system 100. The sorter system controller 240 may be configured to control the rate of actuation of the carriage belts 132 based upon the known sizes and/or weights of packages disposed on conveying surface 128, such as sensed or otherwise determined from the outputs of the sensors 264 of the vision detection system 256. For example, the sorter system controller 240 may generate one or more output commands to reduce the actuation speed or rate of carriages 130 supporting smaller (e.g., lighter) packages such that the packages are not shot off the conveying surface 128 and/or over the respective chute 124. Controlling the movement speeds of packages off the conveying surface, such as by reducing the movement speeds of lighter packages, may increase the efficiency of the sorter system and/or may reduce potential safety issues.

The sorter system controller 240 may also be configured to control the timing of actuation of belts 132 supporting one or more packages to increase the precision and/or efficiency of laterally conveying packages off the conveying surface 128, such as into the destination chutes 124. When a package is disposed longitudinally along two or more carriages 130 on the conveying surface 128, the sorter system controller 240 may generate one or more command outputs which cause belts 132 supporting the downstream portion of the package to actuate first and subsequently cause belts 132 supporting the upstream portion of the package to actuate, such as to direct the package into the destination chute 124. For example, the sorter system controller 240 may be configured to actuate the belts 132 supporting a package having a longitudinal length on the conveying surface 128 greater than a width of the destination chute 124 such that the package rotates or pivots on the conveying surface 128 such that the package may be conveyed into the destination chute 124 (e.g., with the downstream end of the package conveyed into the destination chute 124 before the upstream end). Controlling the timing of belt 132 actuation may increase the precision of the sorter system 100 and reduce the size of the chutes 124 used in conjunction with the sorter system 100, such as to increase the efficiency of the sorter system 100, increase the number of chutes 124 which may be used in conjunction with the sorter system 100, and/or decrease the size (e.g., footprint) of the sorter system 100.

The sorter system 100 may also be combined with one or more other sorter systems 100 such that an object or package may move along the conveying surface 128 of a first sorter system 100 and then along the conveying surface 128 of a second sorter system 100 and so on. The frames 102 of the sorter systems 100 may be connected or otherwise attached together via fasteners, such as screws, nuts, and bolts. However, it will be appreciated that the two sorter systems 100 may be attached via other suitable means, such as welding, magnets, or adhesives.

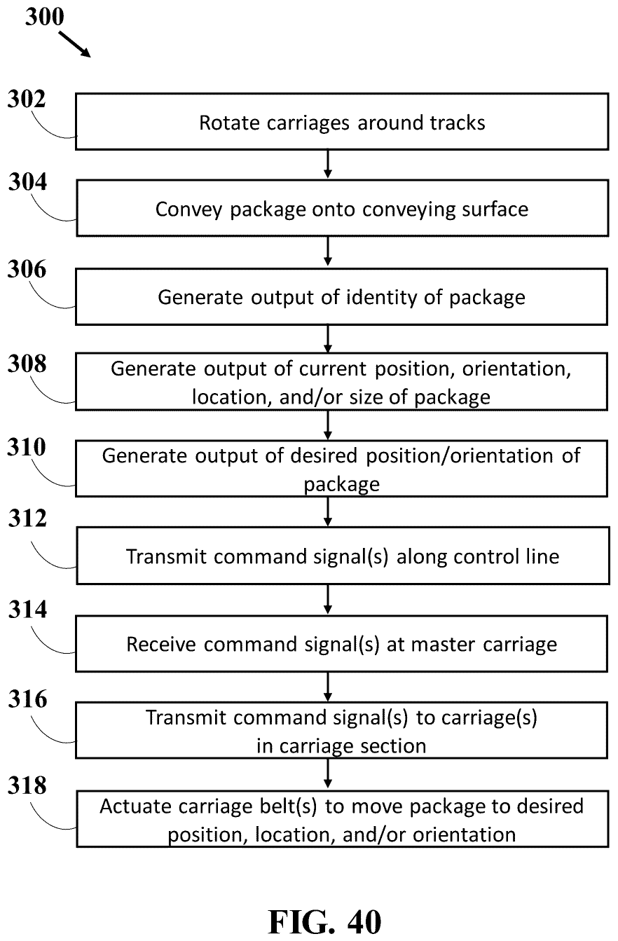

FIG. 40 illustrates an exemplary methodology 300 relating to package sorting in a sorter system. While the methodology is shown as being a series of acts that are performed in a sequence, it is to be understood that the methodology is not limited by the order of the sequence. For example, some acts can occur in different orders than what is described herein. In addition, an act can occur concurrently with another act. Further, in some instances, not all acts may be required to implement the methodology described herein.

Moreover, the acts described herein may be computer-readable instructions that can be implemented by one or more processors and/or stored on a computer-readable medium or media. The computer-executable instructions can include a routine, a sub-routine, programs, a thread of execution, and/or the like. Still further, results of acts of the methodology can be stored in a computer-readable medium displayed on a display device, and/or the like.

At step 302, carriages in the sorter system are rotated around looped tracks. The tracks may be disposed in the sorter system such that the carriages travel in a looped configuration around the tracks from an upstream end of the sorter system to a downstream end of the sorter system. The carriages may be disposed on the tracks such that carriages on the top portion of the tracks define a conveying surface of the sorter system. As described above, a motor may be actuated such that a plurality of carriages move or otherwise rotate around the tracks within the sorter system such that each carriage may define a portion of the conveying surface from the upstream end to the downstream end as the carriage travels along the top portion of the tracks. Each carriage includes an actuatable belt which defines a portion of the conveying surface when the carriage is disposed on the top portion of the tracks.

At step 304, one or more packages are conveyed or otherwise placed on the conveying surface of the sorter system. The packages may be disposed on the conveying surface at any position extending along a length of the conveying surface between the upstream and downstream ends of the sorter system. As discussed above, in some embodiments, the packages are conveyed onto the upstream portion of the conveying surface via an input conveyor. In some embodiments, packages are conveyed onto the conveying surface from the input conveyor via one or more variable speed belts to adjust the rate and/or spacing of packages conveyed onto the conveying surface. A sorter controller system may be configured to control operations of the one or more variable speed belts to adjust the spacing and/or rate of packages conveyed onto the conveying surface. In some embodiments, a vision detection system is disposed near (e.g., on and/or above) the input conveyor, the variable speed belt(s), and/or an upstream portion of the conveying surface of the sorter system such that the vision detection system may generate outputs indicative of the packages being conveyed onto or disposed on the upstream portion of the conveying surface. The sorter controller system may control the operations of the one or more variable speed belts based upon the outputs of the vision detection system.

At step 306, an output is generated indicative of the identity of one or more packages being conveyed onto the conveying surface. As described above, the sorter controller system may determine identifying information related to a package based on an output of one or more sensors of the vision detection system, such as a sensed label or tag related to the package. The sorter controller system may assign a destination location, such as a destination chute, for the package based upon identifying information of the package, such as a destination zip code for the package.

At step 308, an output is generated indicative of the position, orientation, location, and/or size of one or more packages on the conveying surface. As described above, the sorter controller system may determine a current position, orientation, location, and/or size of the packages relative to the moving conveying surface and relative to the sorter system based on outputs of the vision detection system (e.g., from sensors of the vision detection system). The sorter controller system may generate an output of subsequent positions, orientation, location and/or size of the packages on the conveying surface after the packages are conveyed on the conveying surface, such as after belts of the carriages have been actuated to sort other packages. For example, the sorter controller system may generate an output indicative of the position of packages relative to the carriages (e.g., the belts) and/or other packages on the conveying surface, the orientation of the packages on the conveying surface (e.g., straight or rotated), the location of the packages on the conveying surface (e.g., toward the left or right of the sorter system), and/or the size of the packages (e.g., 2D or 3D dimensions; contour lines).

At step 310, one or more control signals are generated and transmitted to control the operation of the sorter system. As described above, the sorter controller system may generate one or more control signals (e.g., command outputs) which selectively actuates the belts of one or more carriages to control the position of one or more packages on the conveying surface. The control signals may actuate belts in a first (e.g., left) or a second (e.g., right) direction. The control signals may actuate the belts of one or more carriages to direct packages to the destination locations (e.g., destination chutes). In some embodiments, the sorter controller system is configured to generate one or more command signals to control the position and/or location of packages on the conveying surface, such as to separate packages disposed on the same carriage or to pre-position packages on the conveying surface to facilitate sorting the packages. In some embodiments, the sorter controller system is configured to generate one or more command signals to control the orientation of the packages, such as to align packages on the conveying surface and/or to reduce the number of carriages on which packages are disposed. In some embodiments, the sorter controller system is configured to generate one or more command signals to control the sorting and/or conveyance of packages, such as to reduce the actuation speed of belts for smaller and/or lighter packages. In some embodiments, the sorter controller system assigns a carriage section identifying tag or label and/or a carriage identifying tag or label to each of the command signals such that the command signals may be received by the desired carriage.

At step 312, the one or more command signals generated by the sorter controller system are transmitted along a control line of the sorter system such that command signals may be received by one or more carriages rotating on the tracks of the sorter system. The control line may be configured to wirelessly transmit control signals to one or more carriages as the carriages travel around the tracks of the sorter system. In some embodiments, the control line is a leaky coaxial which is configured to wirelessly transmit or radiate control signals along a length of the control line.

At step 314, one or more command signals are received at a master carriage. As discussed above, the master carriage is configured to wirelessly receive command signals generated by the sorter controller system and transmitted via the control line. The master carriage may have a carriage controller system with an antenna configured to receive command signals transmitted via the control line. The antenna may be disposed on master carriage and the control line may be disposed in the sorter system such that the antenna is disposed near the control line when the master carriage travels along the top portion of the tracks such that the antenna may receive command signals transmitted along the length of the control line. In some embodiments, the antenna is a near field antenna. In some embodiments, the antenna of each carriage controller system is configured to receive command signals with identifying tags or labels corresponding to the respective carriage section and/or to receive command signals with identifying tags or labels to the respective carriages in the carriage section. In some embodiments, the carriage controller system is configured to parse command signals which do not correspond to carriages within the carriage section (e.g., without identifying tags or labels corresponding to the carriage section and/or corresponding to carriages in the carriage section).

At step 316, one or more command signals are transmitted within a section of carriages to cause the belts of the carriages in the section to actuate. The carriage controller system of the master carriage may receive the command signals generated by the sorter controller system as input and output one or more command signals to drive controllers of carriages in the carriage section (e.g., inclusive of the master carriage). As discussed above, each carriage section comprises two or more carriages and the drive controller of each carriage in the carriage section is coupled with the carriage controller system of the master carriage such that the master carriage may control the operation of each belt of the carriages in the carriage section. In some embodiments, each carriage section comprises six carriages (inclusive of the master carriage). In some embodiments, the carriage controller of the carriage controller system is configured to selective transmit command signals to each drive controller corresponding to the command output, such as based upon the carriage identifying information. In some embodiments, the carriage controller of the carriage controller system is configured to generate command signals with assigned carriage identifying information to each of the drive controllers in the carriage section such that the drive controllers may actuate the respective belt based upon the command signals with the corresponding carriage identifying information.

At step 318, the belts of one or more carriages are actuated to move one or more packages to a desired position, location, and/or orientation. As described above, the drive controllers of carriages in the carriage section may receive command signals from the carriage controller system of the master carriage and cause the respective belt drive motor to actuate the respective belt to move packages to the desired position, location, and/or orientation. Based upon the actuation of one or more belts in the first and/or section directions, packages may be moved to the desired position, orientation, and/or location, such as to the destination chute. For example, belts may be actuated to align (e.g., rotate) packages on the conveying surface, to pre-position packages near the sides of the conveying surface, to adjust the spacing of packages on the conveying surface (e.g., minimize the number of carriages on which a package is disposed and/or to reduce the number of packages disposed on a single carriage), and/or to convey packages laterally off the sorter system (e.g., to the destination chute). Additionally, the belt drive controller may cause the belt motor to rotate the belt at varying speeds based upon the received command signals, such as to control the movement speed of packages laterally off the sorter system.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures-such as alternative materials, structures, configurations, methods, devices, and components, alternatives as to form, fit, and function, and so on-may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein.

Additionally, even though some features, concepts, or aspects of the disclosures may be described herein as being a preferred arrangement or method, such description is not intended to suggest that such feature is required or necessary unless expressly so stated. Still further, exemplary or representative values and ranges may be included to assist in understanding the present application, however, such values and ranges are not to be construed in a limiting sense and are intended to be critical values or ranges only if so expressly stated.

Moreover, while various aspects, features and concepts may be expressly identified herein as being inventive or forming part of a disclosure, such identification is not intended to be exclusive, but rather there may be inventive aspects, concepts, and features that are fully described herein without being expressly identified as such or as part of a specific disclosure, the disclosures instead being set forth in the appended claims. Descriptions of exemplary methods or processes are not limited to inclusion of all steps as being required in all cases, nor is the order that the steps are presented to be construed as required or necessary unless expressly so stated. The words used in the claims have their full ordinary meanings and are not limited in any way by the description of the embodiments in the specification.

1. A sorter system for sorting a package, the sorter system comprising:
a frame with frame sides extending from an upstream end to a downstream end;
a track disposed between the frame sides in a looped configuration between the upstream end to the downstream end;
a plurality of carriages disposed on the track, each carriage comprising;
a belt drive motor connected to a belt drive shaft;
a drive pulley;
first and second tensioning pulleys;
a belt disposed around the drive pulley, the first tensioning pulley, and the second tensioning pulley; and
a drive controller configured to control actuation of the belt via the belt drive motor;
a sorter controller system configured to generate control signals to selectively actuate one or more belt drive motors; and
a control line in data communication with the sorter controller system and extending between the frame sides from the upstream end to the downstream end;
wherein at least one of the carriages includes a carriage controller system configured to receive control signals from the control line and transmit control signals to the drive controllers of two or more drive controllers to actuate the respective belts.

2. The sorter system according to claim 1, further comprising a plurality of chutes disposed on each side of a conveying surface.

3. The sorter system according to claim 1, wherein the carriage controller system includes an antenna and a carriage controller.

4. The sorter system according to claim 3, wherein the antenna is a near field antenna.

5. The sorter system according to claim 1, wherein the control line is configured to wirelessly transmit control signals along a length of the control line.

6. The sorter system according to claim 5, wherein the control line is a leaky coaxial cable.

7. The sorter system according to claim 1, further comprising a vision detection system with at least one sensor configured to generate an output indicative of a package being conveyed onto a conveying surface of the sorter system.

8. The sorter system according to claim 7, wherein the sorter controller system is configured to generate command signals to cause the belt drive motors of one or more carriages to actuate to control at least one of a location, a position, and an orientation of the package on the conveying surface.

9. The sorter system according to claim 7, further comprising one or more variable speed belts disposed upstream of the track and configured to adjust at least one of a rate and a spacing of packages conveyed onto the conveying surface.

10. The sorter system according to claim 9, wherein the sorter controller system is configured to generate command signals to cause the one or more variable speed belts to operate at different speeds.

11. A sorter system for sorting a package, the sorter system comprising:
a frame with frame sides extending from an upstream end to a downstream end;
a track disposed between the frame sides in a looped configuration between the upstream end to the downstream end;
a plurality of carriages disposed on the track, each carriage comprising;
a belt drive motor connected to a belt drive shaft;
a drive pulley;
first and second tensioning pulleys;
a belt disposed around the drive pulley, the first tensioning pulley, and the second tensioning pulley; and
a drive controller configured to control actuation of the belt via the belt drive motor;
a sorter controller system configured to generate control signals to selectively actuate one or more belt drive motors; and
a power line extending between the frame sides from the upstream end to the downstream end and configured to transmit power into the sorter system;
wherein at least one of the carriages includes a power receiver configured to receive power from the power line and transmit power to the drive controller of two or more carriages.

12. The sorter system according to claim 11, further comprising a regulator disposed on one of the carriages and configured to receive power from the power receiver and transmits power to the drive controllers via a carriage power line.

13. The sorter system according to claim 12, wherein the regulator is configured to receive power at 480 V AC and transmit power at 48 V DC.

14. The sorter system according to claim 11, further comprising a carriage controller system disposed on one of the carriages configured to receive control signals from the sorter system controller and transmit control signals to the drive controllers of two or more carriages to actuate the respective belts.

15. The sorter system according to claim 14, further comprising a converter disposed on one of the carriages and configured to receive power from the carriage power line and provide power to the carriage controller system.

16. The sorter system according to claim 15, wherein the converter is configured to receive power at 48 V and transmit power at 24 V.

17. A carriage for use with a sorter system, the carriage comprising:
a frame with a top wall defining a top surface and extending between a first edge and a second edge, a first side wall, and a second side wall opposite the first side wall;
one or more wheels disposed near each of the first and second edges and configured to roll on a track of the sorter system;
a continuous belt disposed at least partially on the top surface between the first and second edges, the belt having an outside surface and an inside surface;
a belt drive motor configured to rotate a belt drive shaft;
a drive pulley coupled with the belt drive shaft via a drive connector and configured to actuate the belt, the drive pulley having a belt driving portion; and
at least two tensioning pulleys configured to keep the belt taught around the frame;
wherein the belt includes a projection portion extending radially inwardly from a middle of the inner surface of the belt and configured to engage with the belt driving portion.

18. The carriage according to claim 17, wherein the frame includes a longitudinal projection extending longitudinally from the second side walls such that the top surface extends beyond the second side wall.

19. The carriage according to claim 18, wherein the longitudinal projection has a length which minimizes a gap between the top surface of the carriage and a top surface of an adjacent carriage.

20. The carriage according to claim 17, further comprising a receiving portion extending into the first side wall and configured to at least partially receive a longitudinal projection of an adjacent carriage.

21. The carriage according to claim 17, wherein the carriage has a width between the first and second side walls of about 6 inches.

22. The carriage according to claim 17, wherein the projection portion covers about 5.5% of the inner surface of the belt.

23. The carriage according to claim 17, wherein the projection portion comprises a plurality of V-shaped ribs.

24. The carriage according to claim 17, wherein the belt drive motor, the belt drive shaft, the drive connector, and the drive pulley are disposed longitudinally between sides of the belt.

25. The carriage according to claim 17, wherein each of the tensioning pulleys includes a belt receiving portion configured to engage with the projection portion of the belt.

26. The carriage according to claim 17, wherein the top surface comprises at least one of extruded aluminum and a hard anodized coating and the inner side of the belt comprises a smooth fabric.
